(19) United States
(12) Patent Application Publication
(10) Pub. No.: US 2008/0261673 A1
(43) Pub. Date: Oct. 23, 2008

(54) DVD game architecture

(75) Inventors: Kurt Buecheler, Palo Alto, CA (US); Peter Sauers, San Mateo, CA (US); J. Derrick Banks, Ottawa (CA); Alexander G.M. Smith, Ottawa (CA)

Correspondence Address: SEED INTELLECTUAL PROPERTY LAW GROUP PLLC, 701 FIFTH AVE, SUITE 5400, SEATTLE, WA, 98104, US

(73) Assignee: Dugac Remote Systems, LLC

(21) Appl. No.: 12/006,084

(22) Filed: Dec. 27, 2007

Related U.S. Application Data
(63) Continuation of application No. 11/147,407, filed on Jun. 6, 2005, now abandoned.
Application No. 11/147,407 is a continuation-in-part of application No. 10/889,985, filed on Jul. 12, 2004, now abandoned.
(60) Provisional application No. 60/577,446, filed on Jun. 4, 2004.
(60) Provisional application No. 60/486,672, filed on Jul. 11, 2003.

(51) Int. Cl. A63F 9/24; A63F 13/00

(52) U.S. Cl. 463/9; 463/43; 463/23; 463/32; 463/35

(57) ABSTRACT

Methods and systems for creating, managing, and operating electronic games are provided. Example embodiments provide a DVD game environment (“DGE”) that includes game flow logic, interactive DVD game content, enhanced methods of scoring and play, automatic skill level adjustment, and an electronic game board. In one embodiment, the DGE comprises DVD game logic with scoring management, game and participant state information, video and audio game content, and an electronic game board. These components provide functionality that can be incorporated into a DVD game that presents challenges for entertainment, education, training, or testing purposes. The DVD games produced thereby can automatically provide challenges based upon participants' skill levels and automatically detect the correctness or incorrectness of a response in order to maintain an electronic game board.

### TECHNICAL FIELD

The present invention relates to methods and systems for creating, managing, and operating electronic games and, in particular, to methods and systems for creating, managing, and operating self contained, interactive DVD games.

### BACKGROUND

To date, Digital Video Disc or Digital Versatile Disc (“DVD”) technology has been used largely to play movies and to present other types of video content, oftentimes accompanied by audio. DVD technology was developed as an improvement over the sequential technologies previously available with Video Cassette Recorder technology, by providing an ability to access video segments on an “addressable” basis instead of sequentially, from the beginning of the media. However, to provide an optimal environment for the narrow purpose of playing videos such as movies, DVD technology imposes constraints on the format of DVD media used to store the content and on the processing and storage capacities of DVD players. The only functions that a DVD player is really meant to perform are to play videos (with or without audio), to present menus, which upon selection of an item, enable the video player to navigate to play a different video segment, and to support general playback control such as speed control, skip to next content segment, etc.

A DVD medium that stores such content is hereinafter referred to as a “DVD” and the machine or system used to play/present the DVD content referred to as a “player” or a “DVD player.” The term “video segment” or “video fragment” is used to refer to any portion of video content, including a whole or a portion of a video, a slide show, or a still video.

Given these limited functions, there are constraints placed by the DVD industry on the storage of content to reflect the target use of DVDs. More specifically, a certain number of video segment and audio tracks can be stored and organized in a particular hierarchical structure as defined by the DVD industry. Video fragments, corresponding audio, and menus, are typically arranged as “cells” which are grouped into “chapters” (also known as “programs” or “parts of title”) which are stored in a construct known as a “program chain” or PGC. PGCs are further grouped into “titles,” which are stored in a video title set or VTS. There are maximum numbers of each of these content types within each level of the stored DVD data, for example, there is a maximum of 99 video titles per single DVD, and, for use in older players, a maximum of 242 PGCs can be stored in a single title.

In addition to storage constraints, limited capability is provided to “program” what happens when a button is pressed on a remote control device (or a corresponding button on the DVD player) or before or after a video segment is presented. For example, an extremely small amount of memory is available through 16 general registers that can each hold 2 bytes (16 bits) of data for a total of 256 bits of variable data. The operations supported by DVD players are limited to mathematical manipulations and storage operations on values stored in these registers, which are presented to users as “opcodes,” much in the same way assembly language is presented for low level programming of computers. A maximum number of 128 operations (opcodes or commands) can be executed before and after a PGC (collection of chapters) is played and a maximum of 1 operation can be executed at the end of each cell within a chapter. Thus, any additional navigational control needs to be provided by “programming” the DVD player to execute these opcodes (as pre- and post-commands) before and after the content is displayed. Thus the DVD technology provides a very limited environment for interfacing to content stored on a DVD.

Standards for storing video and audio segments on DVD media and for the operations supported by DVD players are detailed in a commercially available document known as “The DVD Specification,” available from the DVD Format/Logo Licensing Corporation, Daimon Urbanist Bldg. 6F, 2-3-6 Shibadaimon, Minato-ku, Tokyo, 105-0012 JAPAN (or info@dvdfllc.co.jp). One problem that has arisen over time is that the various manufacturers of DVD players have not precisely adhered to the standards promoted by the Specification, which causes variation from DVD player to DVD player and renders it difficult to develop applications for DVD technology that are likely to work across the entire DVD platform. For example, to keep costs of DVD players down, various manufacturers have not implemented some of the features, or have implemented some of them incorrectly.

For these reasons, providing other types of applications for DVD technology has been impractical. In the entertainment arena, at most, manufacturers have used the presentation capabilities of DVD technology to enhance existing forms of entertainment. For example, several companies have provided DVDs with multimedia content to accompany board games, so that a video selection can be played in the same manner a game “card” is read from a deck of cards to generate content for a next play in the game. In such games, there is a physical game board upon which game participants keep track of their scores by moving their respective playing pieces as the game progresses. A next “play” is chosen typically by rolling a die and doing an action dictated by the result of the die roll—typically either an action that is determined by the position advanced to on the game board or an action indicated on a face of the die itself. When the action indicates that a video segment is to be played, a participant causes the DVD player to play a next video segment on the DVD and follows the instructions on the DVD or as understood within the context of the game. For example, in a Trivial Pursuit™ game, the game participant may advance a piece on the game board if the participant is able to identify a correct answer to a question posed by the video segment. The next “card” may be selected by playing another video segment. Thus, the games at most provide DVD-enhanced board games that use the DVD platform as a passive device.

Other uses for DVD technology have been similar to those provided using CD-ROMs, for example, as auxiliary examples or instructional aids to written material such as books.

### BRIEF SUMMARY

Embodiments of the present invention provide enhanced methods and systems for creating, managing, and operating DVD-based electronic games. Example embodiments provide a DVD game environment (“DGE”) that includes game flow logic, interactive DVD game content, enhanced methods of scoring and play such as “double-or-nothing” and “auto-leveling” support, and an electronic game board, which enable game developers and other game producers to author games that operate on a DVD player without need for an auxiliary physical game board or other auxiliary components.

In one example embodiment, the DVD Game Environment supports several functional components that works together to produce DVD games. For example, at an abstract level, the DGE comprises DVD game logic with scoring management, game and participant state information, video and audio game content, and an electronic game board. The DGE implements instructions (commands to the DVD player) that work in conjunction with the menu and game content and the specified use of the memory registers within the player to provide the functions of the DVD Game environment.

According to one approach, an electronic game board is provided that automatically tracks game participant's responses to presented challenges and notifies the participants of the current status of the current participant. The electronic game board may implement a virtual path to a final location, and/or may reflect a numeric score or other representation of a score.

According to another approach, the DVD game stores a plurality of different types of challenges. These challenges may take the form of any one or more of a multiple choice challenge, an open response challenge, a true/false challenge, an anagram, a wormhole, a black hole, a circling cursor challenge, or a side scroller challenge. These challenges may have a time-related component or a movement-related component, or may present a visual puzzle. Challenges may have more than one outcome. The outcome may depend upon a knowledge element, a time element, or a physical skill element.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a snapshot of an example display screen of a challenge presented by a DVD game produced using an example DVD Game Environment.

FIG. 2 is an example block diagram of components of an example DVD Game Environment.

FIGS. 3A-3F are snapshots an example integrated electronic game board provided by an example DVD Game Environment.

FIG. 4 is an example block diagram of the game and player state information maintained by a DVD Game Environment while operating a DVD Game.

FIGS. 5A-5C are an example flow diagram of the DVD game flow and scoring logic provided by an example DVD Game Environment.

FIG. 6 is an example snapshot of an initial menu for determining whether to setup options or to start the game.

FIG. 7 is an example flow diagram of a process for setting up the game participants according to an example DVD Game Environment

FIG. 8 is an example snapshot of a menu for determining whether to play in team or individual mode.

FIG. 9 is an example snapshot of a menu for determining the number of game participants.

FIG. 10 is an example snapshot of a menu for determining a color for a selected game participant.

FIG. 11 is an example snapshot of a menu for determined a challenge difficulty level for a selected game participant.

FIG. 12 is an example snapshot of a menu for determining game options.

FIG. 13 is an example snapshot of a menu for turning on and off an automatic leveling feature.

FIG. 14 is an example snapshot of a menu for setting an optional time limit for the current DVD game session.

FIGS. 15A-15B is an example sequence of snapshots illustrating a multiple choice type of game challenge.

FIGS. 16A-16B is an example sequence of snapshots illustrating an open response type of game challenge.

FIGS. 17A-17C is an example sequence of snapshots illustrating a true/false type of game challenge.

FIGS. 18A-18D is an example sequence of snapshots illustrating an anagram type of game challenge.

FIGS. 19A-19F is an example sequence of snapshots illustrating a side scrollers type of game challenge.

FIGS. 20A-20C is an example sequence of snapshots illustrating a circling cursors type of game challenge.

FIGS. 21A-21H is an example sequence of snapshots illustrating a black hole type of game challenge.

FIGS. 22A-22I is an example sequence of snapshots illustrating a wormhole (tunneling) type of game challenge.

FIGS. 23A-23C are example snapshots illustrating challenge result feedback options.

FIG. 24 is an example snapshot of a video segment portion of a Factoid presented by an example DVD game.

FIGS. 25A-25C is a sequence of example snapshots of a Fate Card presented by an example DVD game.

FIG. 26 is an example block diagram of a DVD system for practicing embodiments of a DVD Game environment.

FIG. 27 is an example block diagram of layout of instructions and content on a DVD for practicing embodiments of a DVD Game Environment.

FIG. 28 is an example block diagram of a layout in the general registers for implementing the game and player state information.

FIG. 29 is an example block diagram of the dynamic adjustment of skill levels for a participant based upon the participant's responses to game challenges over time.

FIG. 30 is a block diagram illustrating an example organization and layout of challenges used by an example DVD game.

FIG. 31 is an example flow diagram of a series of steps executed by a DVD game for automatically determining a next challenge.

FIG. 32 is an example flow diagram of a series of steps executed by a DVD game for adjusting a candidate challenge based upon checking a history queue for prior presentation.

### DETAILED DESCRIPTION

Embodiments of the present invention provide enhanced methods and systems for creating, managing, and operating DVD-based electronic games. Example embodiments provide a DVD game environment (“DGE”) that includes game flow logic, interactive DVD game content, enhanced methods of scoring and play such as “double-or-nothing” and “auto-leveling” support, and an electronic game board, which enable game developers and other game producers to author games that operate on a DVD player without need for an auxiliary physical game board or other auxiliary components. Thus, the DGE enables the production of a new genre of electronic games that operate as self-contained “DVD games.” DVD games use the DVD player as an active system that implements game logic and scoring as opposed to DVD-enabled board games that use the DVD player as a passive auxiliary component that presents content from a DVD similar to a deck of cards. The techniques incorporated by the DGE implement an elegant and well-orchestrated balance between the need to record history information, such as a participant's status information and tracking presented challenges to avoid repeats, and the need to store sufficient content to make the DVD game interesting for prolonged and continued use. These techniques push use of the DVD platform to overcome the obstacles inherent in the use of DVD and DVD-like technology.

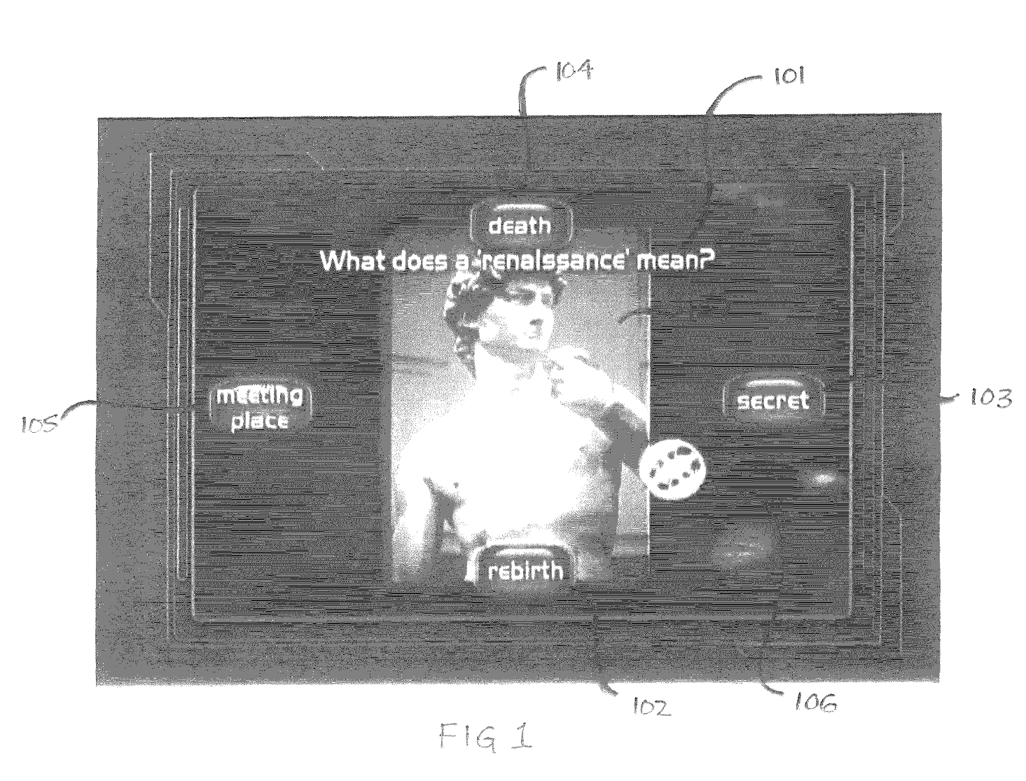

FIG. 1 is a snapshot of an example display screen of a challenge presented by a DVD game produced using an example DVD Game Environment. The particular challenge shown in FIG. 1 is a snapshot of a “circling cursor” question type, which is part of an example embodiment DVD game called “Time Troopers™.” A circling cursor challenge adds complexity to an otherwise typical multiple choice challenge by requiring a game participant to apply timing skills as well as physical skills and knowledge to select a correct answer from among several possible answers in a predetermined amount of time. Multiple outcomes are possible even if a correct answer is chosen depending upon the length of time taken to respond to the challenge. For example, in one embodiment, the participant may advance an additional position for responding to the question in a very short amount of time, for example 10 seconds. In FIG. 1, a question 101 is presented as part of a video segment (also known as a “video clip”) in the middle of the screen. The question typically is also presented as part of an audio track in conjunction with the displayed question 101; however, there may be implementations where audio is not presented. The example challenge shows four possible answers 102-105 surrounding a picture 107 that is used to illustrate the topic of the question 101. A cursor 106 is shown in its movement from possible answer 102 to answer 103. As the cursor 106 circles through the answers 102-105, the game participant selects a response by pressing a selection button (typically the “ENTER” button or an equivalent defined by the environment of the particular DVD player) when the cursor 106 coincides with the answer 102-105 that the participant believes is correct. If the participant selects the correct answer (in this example possible answer 102), then the DVD game automatically increases the participant's score by advancing the participant to the next position on the electronic game board. The DVD game then advances game play to the next player and presents a new challenge.

Although the techniques of a DVD Game Environment are generally applicable to any type of electronic game that can be stored on a DVD and operated by the DVD player without the use of an external game board or other external scoring mechanism, the phrase “game,” “challenge,” “puzzle,” “question,” etc. is used generally to imply any type of scenario that can be presented to elicit responses that can be scored and/or represented by a change on an electronic game board. In addition, one skilled in the art will recognize that although the examples described herein often refer to an educational game, one skilled in the art will recognize that the techniques of the present invention can also be used in other environments that would benefit from automated scoring or an electronic score board, such as presenting challenges for certification purposes, testing, etc. In addition, although described in terms of current DVD platform technology, one skilled in the art will appreciate that the concepts and techniques described herein are applicable to future platforms of both DVD and DVD-like technology and other technologies that may present similar obstacles for interactively viewing multimedia content.

Also, although certain terms are used primarily herein, one skilled in the art will recognize that other terms could be used interchangeably to yield equivalent embodiments and examples. For example, it is well-known that equivalent terms in the multi-media content arena and in other similar fields could be substituted for such terms as “video,” “audio,” “clip,” “segment,” “portion,” etc. Specifically, the term “video clip” can be used interchangeably with the terms “video segment,” “video,” etc. Also video may refer to any type of visual content, whether a “still frame,” slide show of stills, animation, or other moving visual content. Likewise, the term “audio track” can be used interchangeably with “audio segment,” “audio clip,” etc. Also, generally, when a video clip is referred to, an associated audio track may also be available. Also, the phrase “to present” (and its variations) are used to convey an operation appropriate to the content being presented. For example, when audio is presented it is generally played (to be heard), although accessibility-friendly systems may provide other means for presenting audio. Similarly, when video is presented it is generally displayed, although in some system Braille may be used, or an audio interface used to describe the video. In addition, terms may have alternate spellings which may or may not be explicitly mentioned, and one skilled in the art will recognize that all such variations of terms are intended to be included, whether or not mentioned explicitly herein.

Example embodiments described herein provide applications, tools, data structures and other support to implement a DVD Game Environment to be used for producing DVD games. One skilled in the art will recognize that other embodiments of the methods and systems of the present invention may be used for other purposes, including interactive DVD content for training, testing, or educational purposes or other purposes apart from entertainment. In the following description, numerous specific details are set forth, such as data formats and code sequences, etc., in order to provide a thorough understanding of the techniques of the methods and systems of the present invention. One skilled in the art will recognize, however, that the present invention also can be practiced without some of the specific details described herein, or with other specific details, such as changes with respect to the ordering of the code flow or additional steps. Also, other steps could be implemented for each routine, and in different orders, and in different routines, yet still achieve the functions of the DGE.

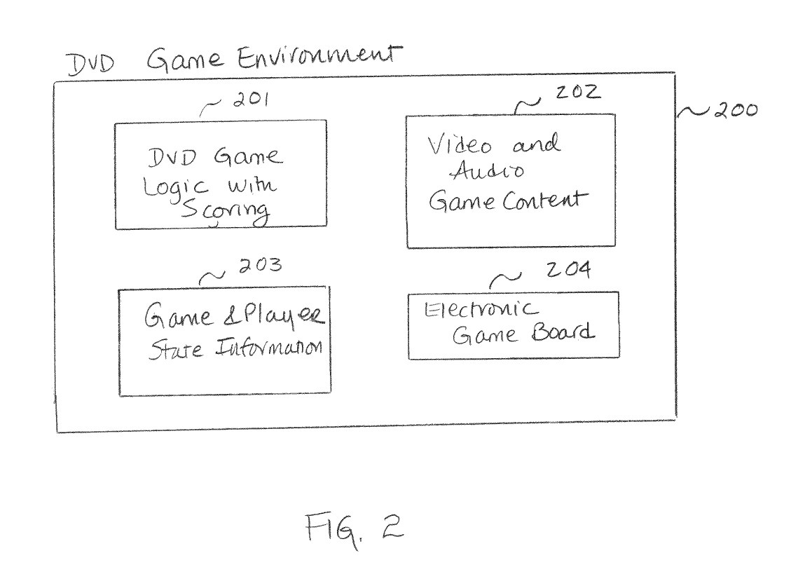

FIG. 2 is an example block diagram of the functionality provided by an example DVD Game Environment to produce DVD games. At an abstract level, the DGE comprises DVD game logic with scoring management 201, game and participant state information 203, video and audio game content 202, and an electronic game board 204. The DGE does not implement these capabilities as physical components per se, but rather the instructions (commands to the DVD player) combined with the menu and game content and the specified use of the memory registers within the player together cooperate to provide the functions of the DVD Game environment. One skilled in the art will recognize that as further enhancements are made to the DVD platform, it is possible that some, many, or all of the functionality described herein to support DVD games may be incorporated into the DVD players themselves and not require the complexities of the example embodiment described herein. In addition, these components may be implemented eventually in software or hardware or a combination of both.

As represented by logic and scoring management 201, the DGE provides all of the logic, flow, and scoring functions needed to produce a DVD game with interactive game challenges, such as multiple choice questions, true-false question, word puzzles, timed-response questions, action-oriented questions (questions in which a response selection is made in concert with some part of the challenge is moving), and other types of questions and puzzles. Each DVD game may vary in its content, i.e., the specific multimedia content presented, however the basic game flow logic provided by the DGE can be used to operate any such DVD game. New types of challenges can be integrated into the DGE by programming the instructions (PGCs) that implement the new type of challenge to store the detected result of the challenge in a memory location that has been reserved for returning results and to then navigate to the appropriate automated scoring components (as implemented by linking to other PGCs) that advance the participant when appropriate and cause game play to proceed to the next participant.

The DGE also implements an electronic game board 204 along with techniques for scoring challenges that are integrated into the electronic game board 204. Specifically, the DGE tracks for each participant a current score based upon the participant's answers to challenges (e.g., questions) which, in many instances, are determined by the DVD game automatically. When it becomes a participant's next turn, an appropriate video segment (with potentially an associated audio track) is presented to notify the participant of the participant's current score and/or position on the board. In an example embodiment, the electronic game board 204 implements a virtual board presentation with a “spoke” (a path of tiles) for each participant. In one embodiment, each spoke represents an individual participant's path towards an end goal. In conjunction with a participant's turn (before or after), the DGE presents the appropriate portion of the virtual board that corresponds to that participant's current score. For example, in one embodiment, the virtual board appears to rotate to present the portion of the board that corresponds to the participant. In one embodiment, the other spokes of the other participants are visually suggested in the background to give context without specific scoring and/or positional information for the other participants.

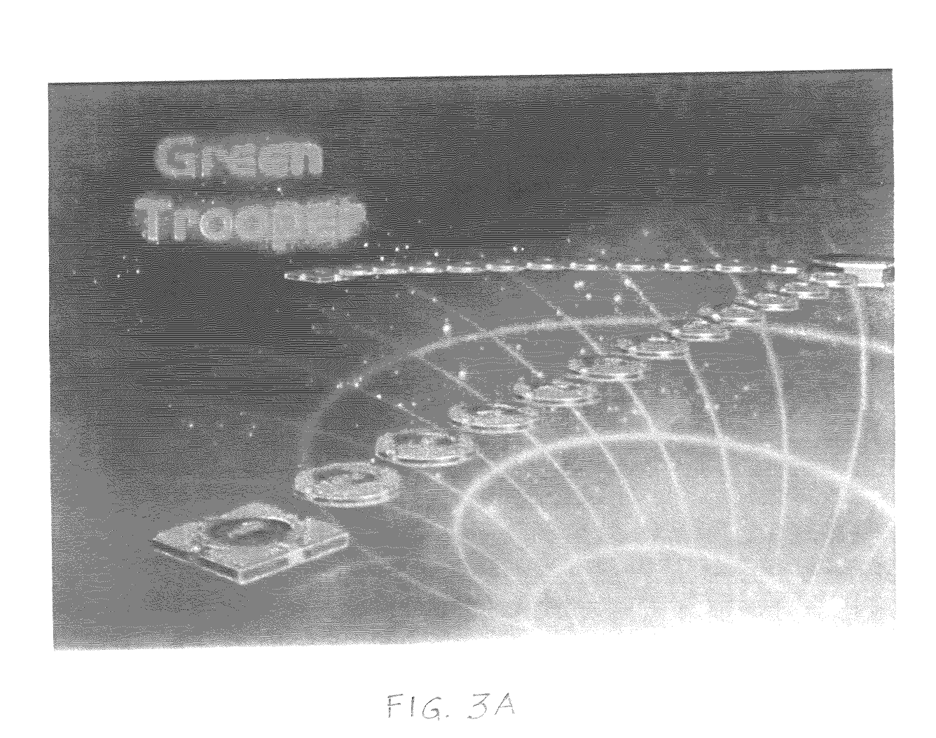

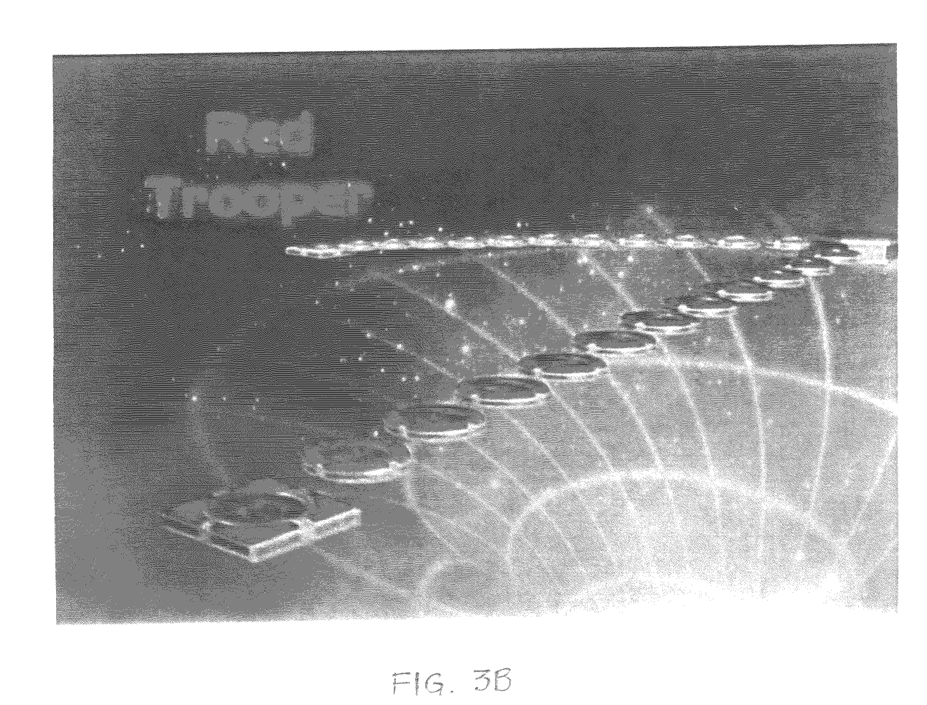

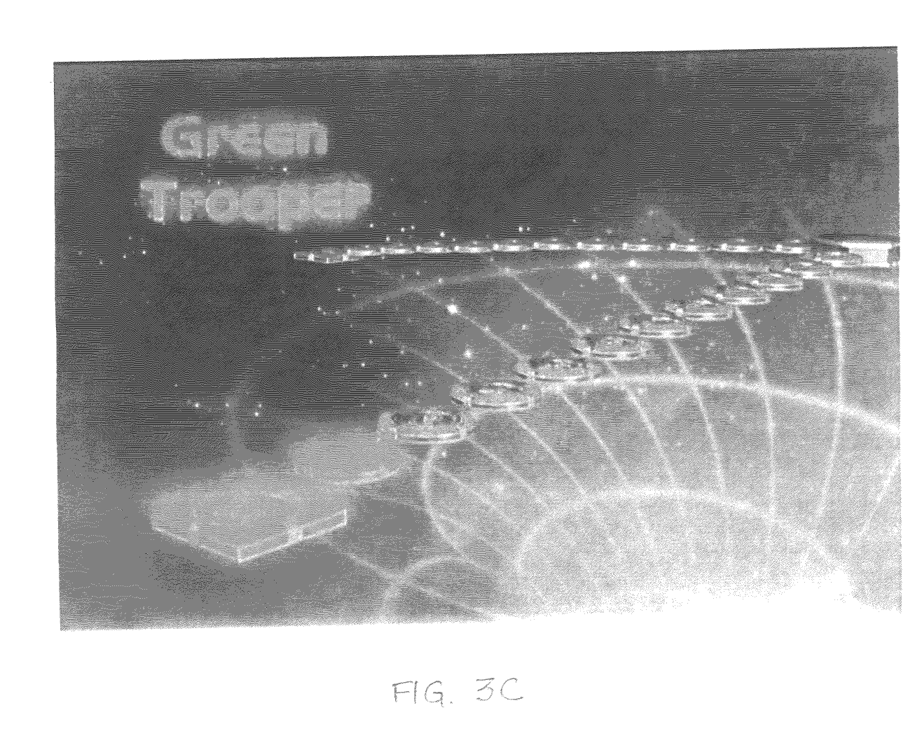

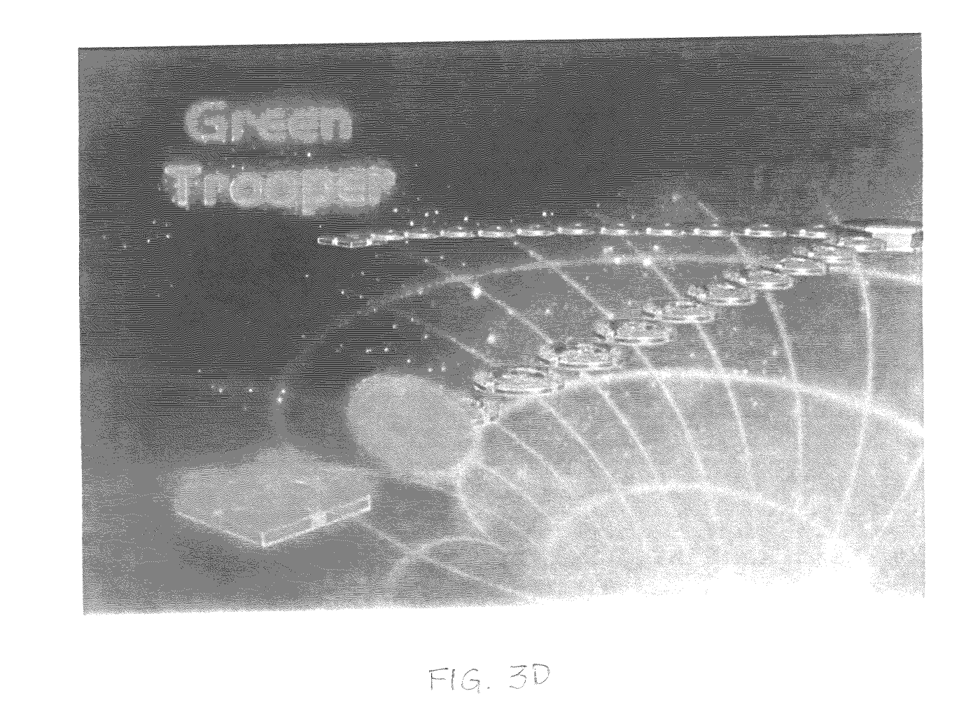

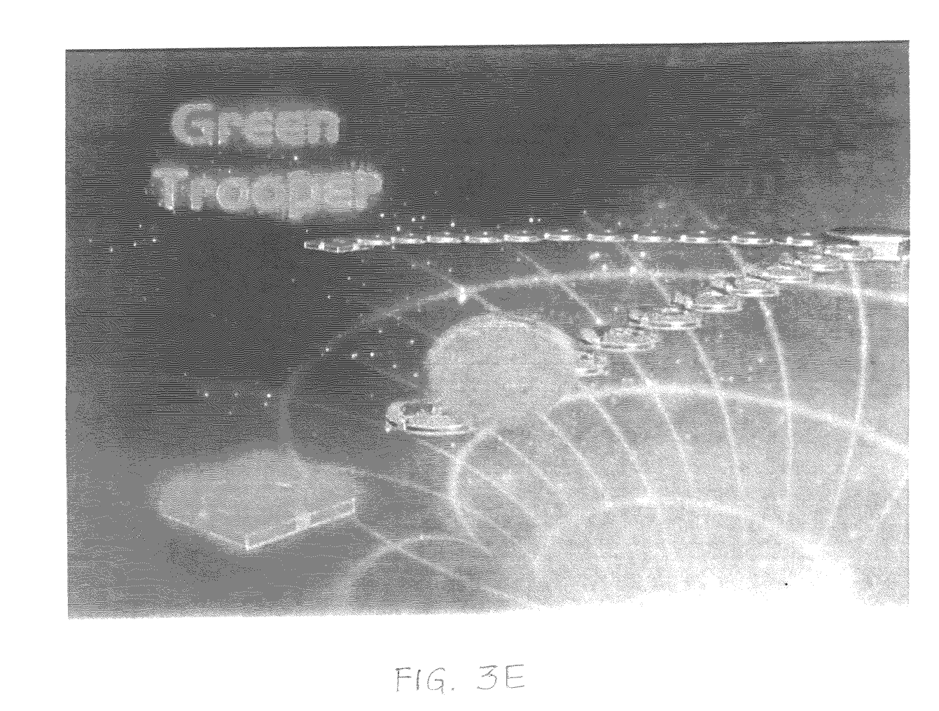

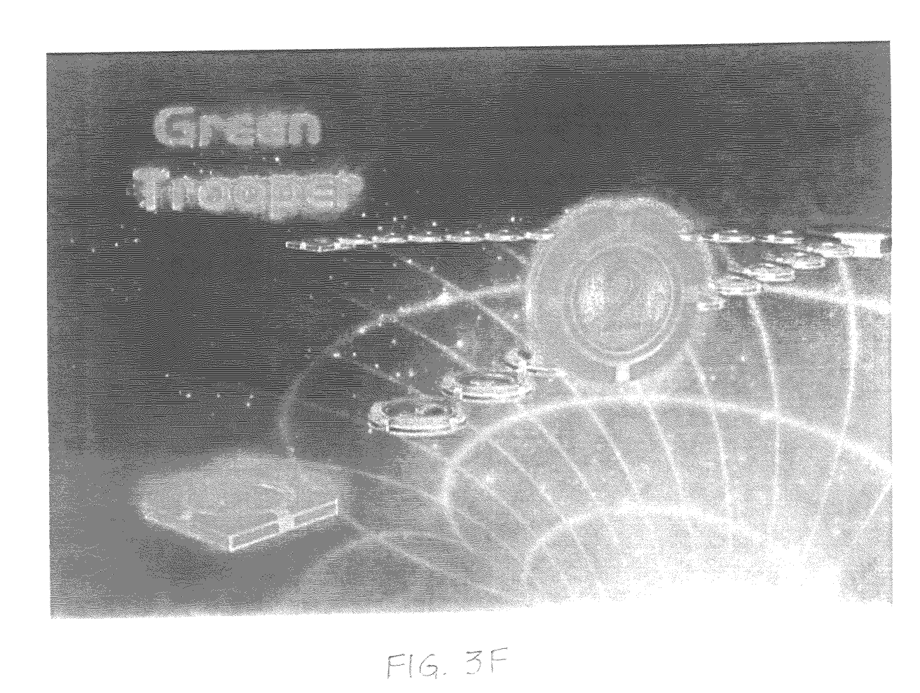

FIGS. 3A-3F are snapshots an example integrated electronic game board provided by an example DVD Game Environment. FIG. 3A shows the virtual board from a first participant's perspective (the Green Trooper) before the participant has successfully responded to a challenge or before the participant has take a turn. FIG. 3B shows the virtual board from a second participant's perspective (the Red Trooper) with the same score (nothing). FIGS. 3C-3F illustrate snapshots of a score animation from one board position (tile) to another on the virtual game board. Specifically, the Green Trooper's board position is shown moving from tile “1” to tile “2” in animated form. As a participant's score changes, a score animation is presented to reflect a corresponding positional change on the game board.

One skilled in the art will recognize that the virtual board is just one of many examples of shapes and animations possible to reflect movement on a game board and/or an absolute or relative score of the participants. One should note, however, that the more storage capacity consumed by representing the scoreboard the less room available on a DVD for storing challenge (game) content. The example shown requires storage only for a score/positional animation that corresponds to each board position for each color (thus 48 animations for 4 participants using a board of 12 positions). One way to advantageously minimize the storage requirements is to not simultaneously display the current score of the other players. Also, one should note that color represents one way to differentiate the participants. Different shapes of the elements of each participants path or other means for visual differentiation could also be incorporated and appropriate animations stored.

The DGE supports several models for automatically managing the competitive play and/or adjusting the score of the game participants. As a preliminary matter, an initial skill level is determined for each game participant. The DGE uses the skill level of a participant to assist in the determination of appropriate challenges for that particular participant. In one embodiment, the DGE provides a set of menus that allow a participant to select an initial skill level (e.g., easier, medium, and harder). In another embodiment, the DGE automatically determines an appropriate skill level based upon answers to questions pertaining to an age or experience metric.

Once a skill level is associated with a game participant, it may remain constant for the remainder of the game or be modified dynamically by the DGE based upon game performance. Such dynamic adjustment may be performed over a period of time (such as based upon elapsed time), after each question, or based upon some other determination. In an example embodiment, a game participant indicates a desire for dynamic skill adjustment by setting the “auto-leveler” feature in one of the setup menus. In auto-leveling mode, the DGE determines each next challenge based upon a current skill level of a participant. Thus, as a participant's performance improves, the challenges presented become more difficult—automatically—as determined by the DVD game. This feature is particularly useful when a DVD game is played between participants whose skills are very different, such as a parent and child, and allows the participants to play together in a way that each are individually challenged.

After each participant responds to a question, the DGE determines whether the answer was correct, and, if so, causes the participant's score to increase. With standard play, the score increases by one “unit” and the electronic game board is updated accordingly to reflect the participant in a next position. The DGE also supports a scoring feature called “double-or-nothing.” When a double-or-nothing challenge is available, a participant's skill level is temporarily boosted to a higher skill level, and a correct answer to a corresponding challenge results in doubling the advancement (e.g., moving 2 positions instead of 1).

As shown in FIG. 2, the DGE supports manipulation of video and audio content 202, which is stored on a DVD and subsequently operated on by the DVD player according to instructions (code) that control the DVD player to present content or to navigate to other content. One embodiment of the DGE supports several interactive game components that implement different types of game challenges, including:

Multiple Choice

Open Response

True/False (is this “For Real?” or “No Way!”)

Anagrams (timed)

Side Scrollers

Circling cursors

Black Holes

Wormholes

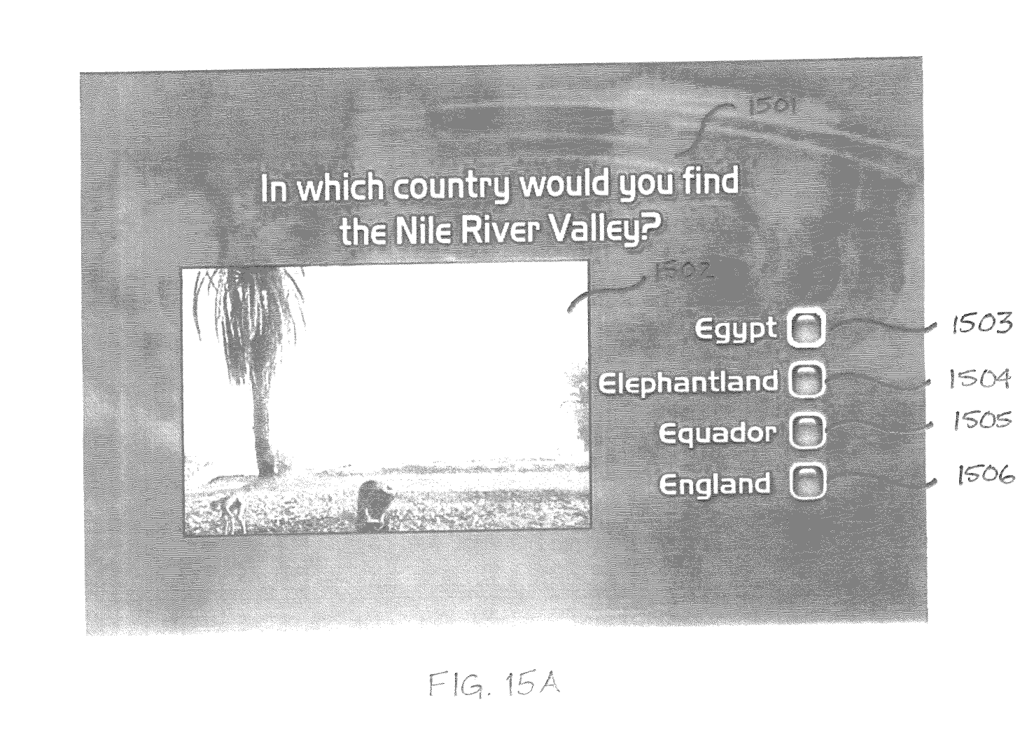

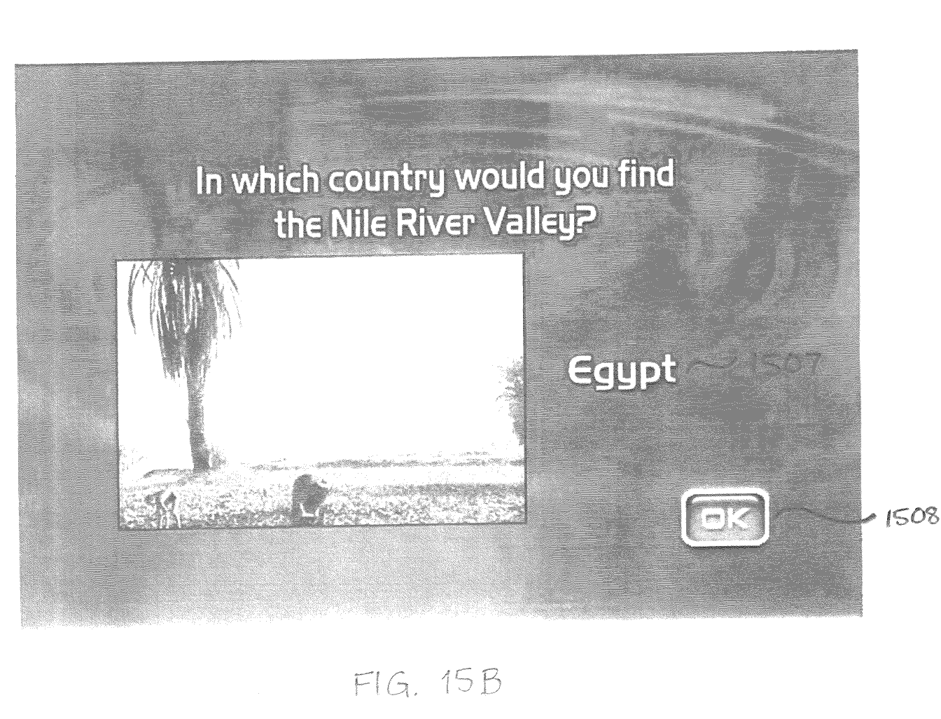

Each of these challenge types and examples of them are described in more detail below in reference to FIGS. 15A-22I. One skilled in the art will recognize that many other types and variations of such challenges (e.g., puzzles and questions) can be formulated with appropriate content, including combining the various timing and movement techniques with a variety of types of challenges.

In order to provide automated scoring and determination of challenges and to operate the electronic game board, the DGE maintains game and participant state information 203. For example, a history of the challenges already presented is stored in the state information 203 to avoid presenting challenges that have already been seen in a current DVD game session. (Note that a session may span multiple uses of the DVD in the DVD player, as some DVD players allow a game to continue where it last left off.) In addition, game state such as whose turn it is and the a skill level and current score of each participant is also maintained in the state information 203.

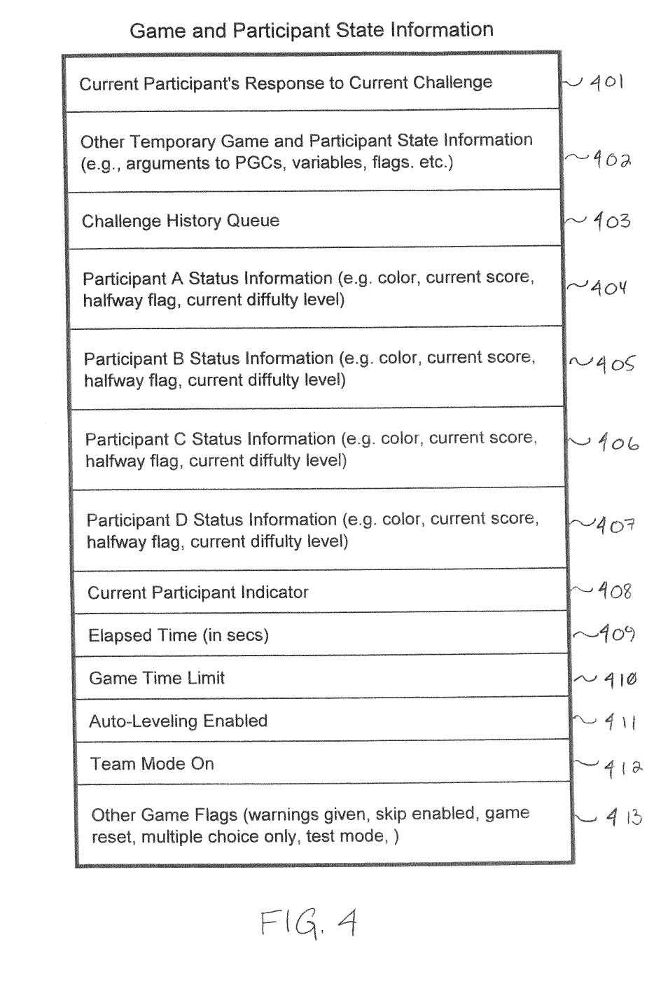

FIG. 4 is an example block diagram of the game and player state information maintained by a DVD Game Environment while operating a DVD Game. In the example illustrated, the DGE stores the current participant's response to the current challenge in field 401; other temporary game and participant information in field 402; a history (ring or queue) of challenges already presented in field 403; each participant's state information in fields 404-407, including a “color” representing the participant on the electronic game board, the participant's current score, skill level, and other information; an indicator of the current participant in field 408; elapsed time in the game in field 409; a game time limit if selected as an option in field 410; a toggle for auto-leveling mode 411; a toggle for team mode 412; and other game state flags in field 413. One skilled in the art will recognize that the data shown are examples and that different information or other information may also be maintained.

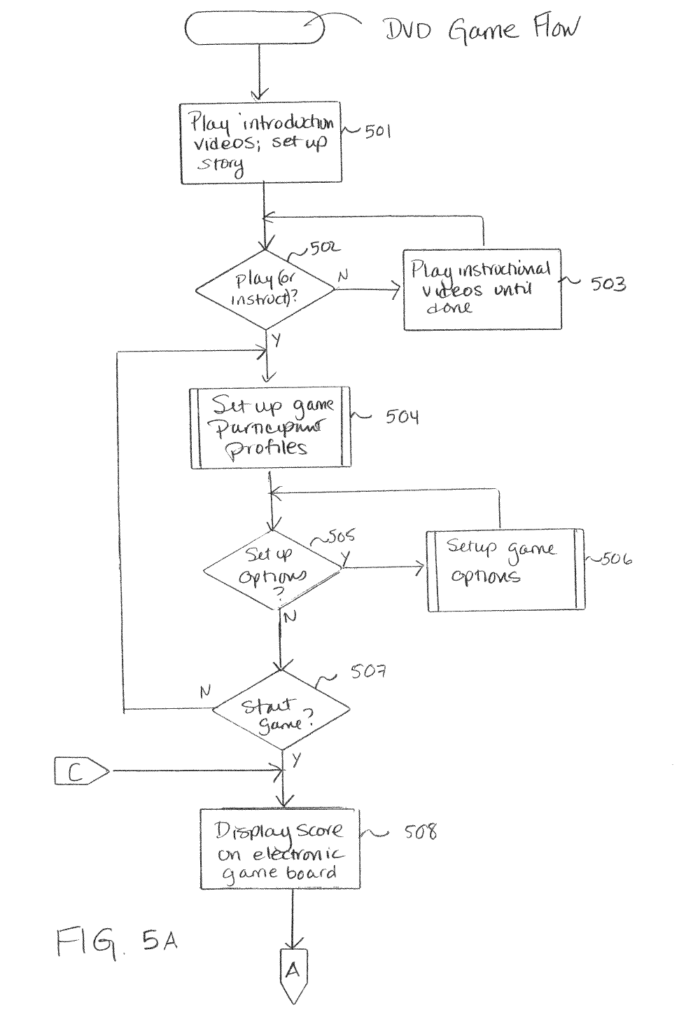

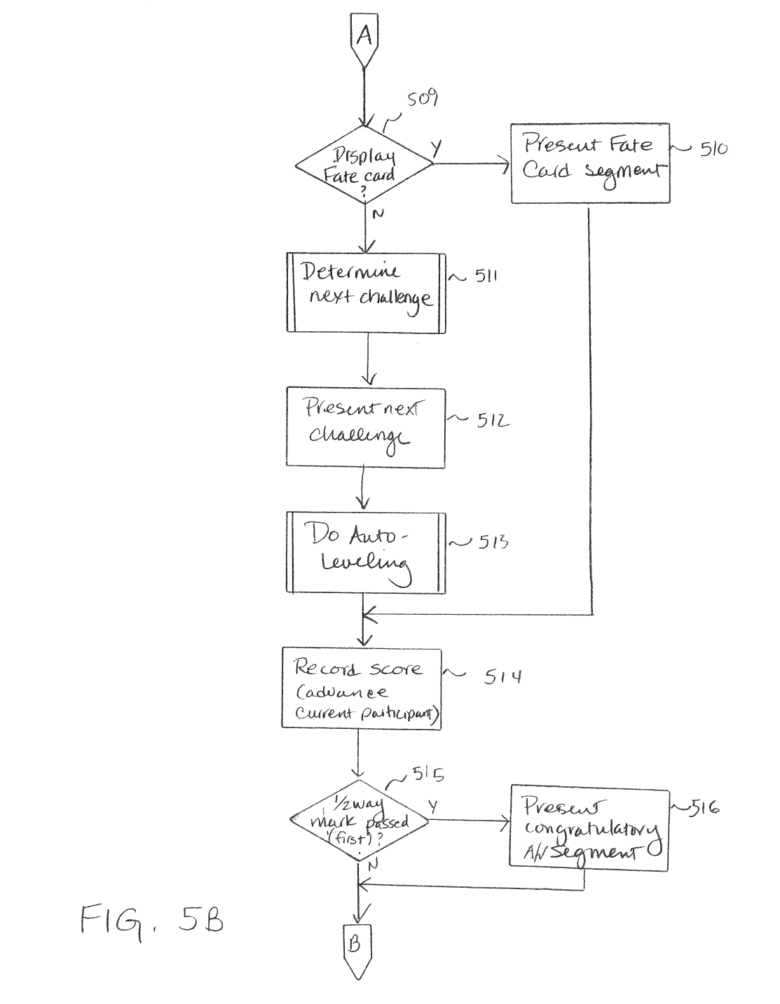

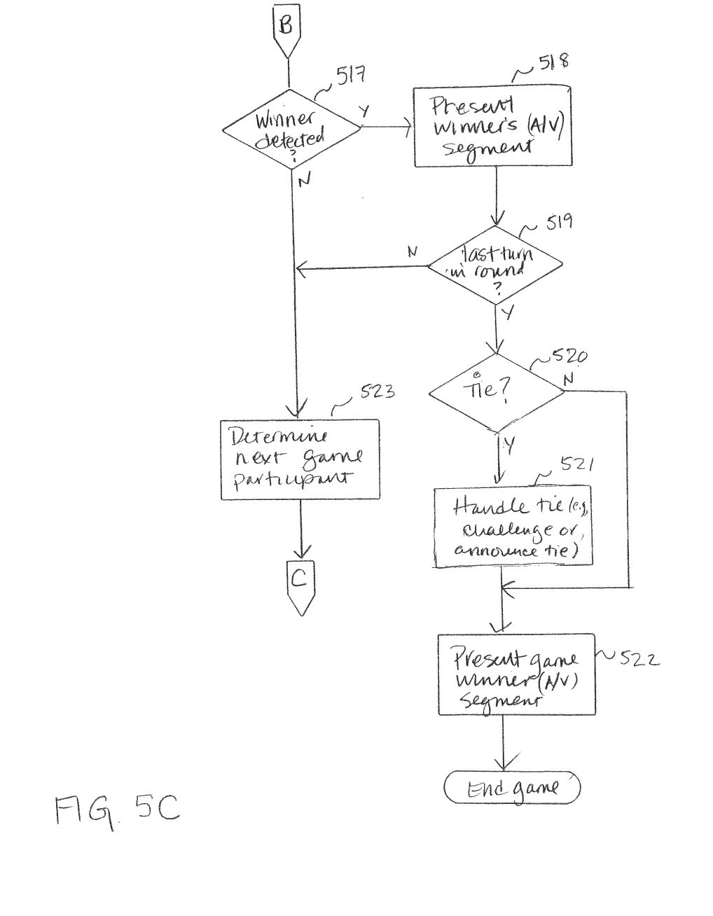

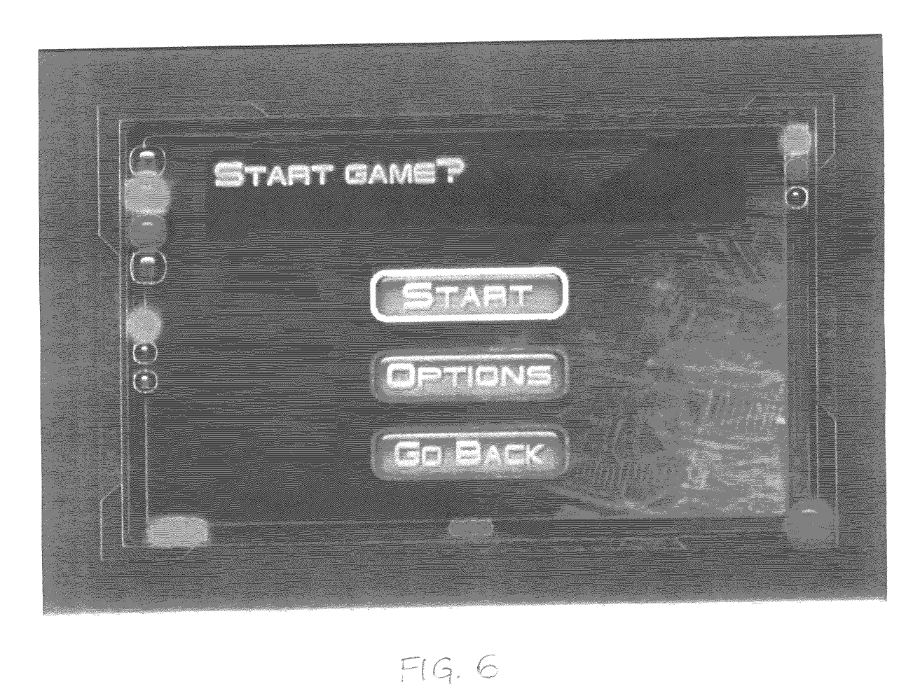

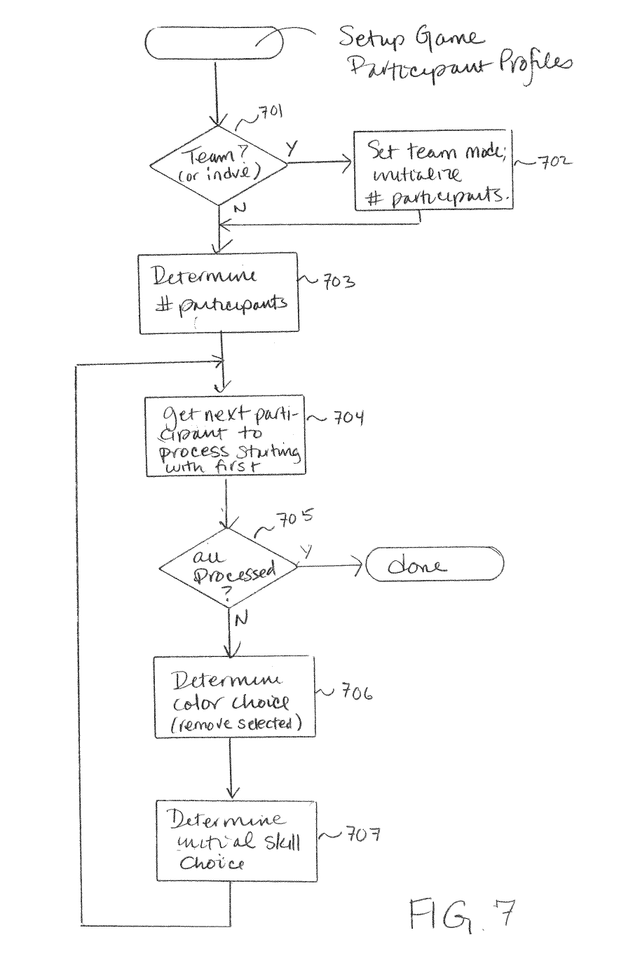

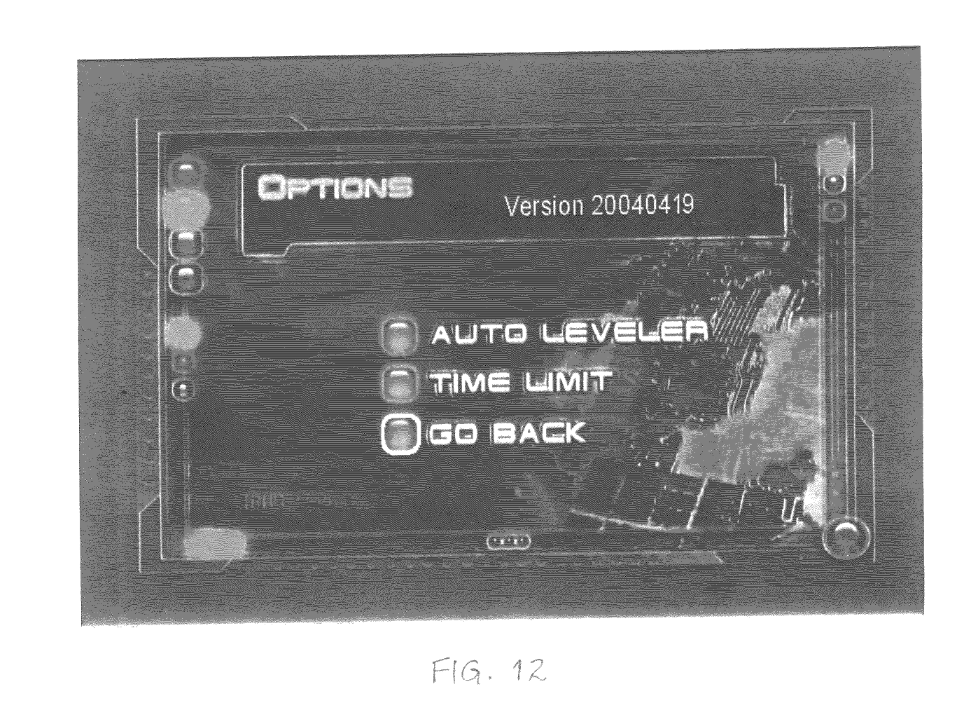

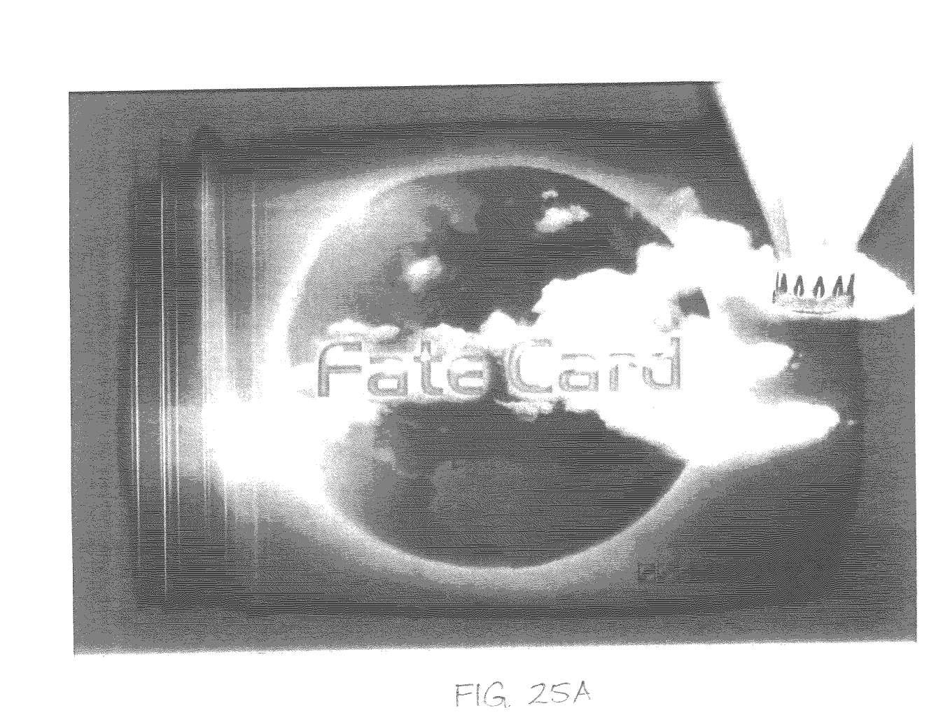

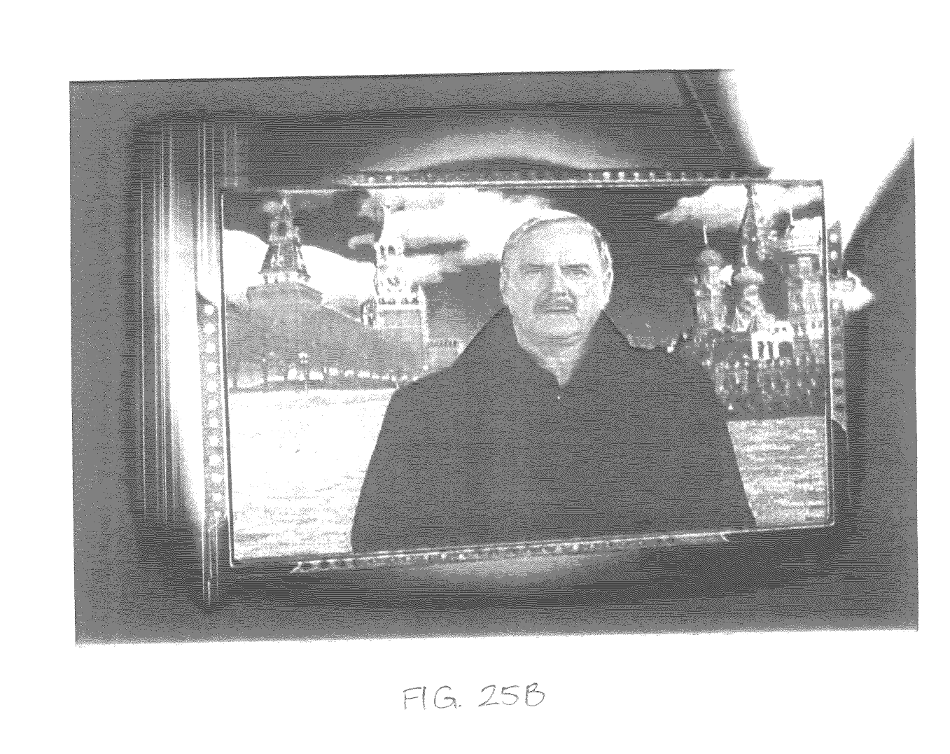

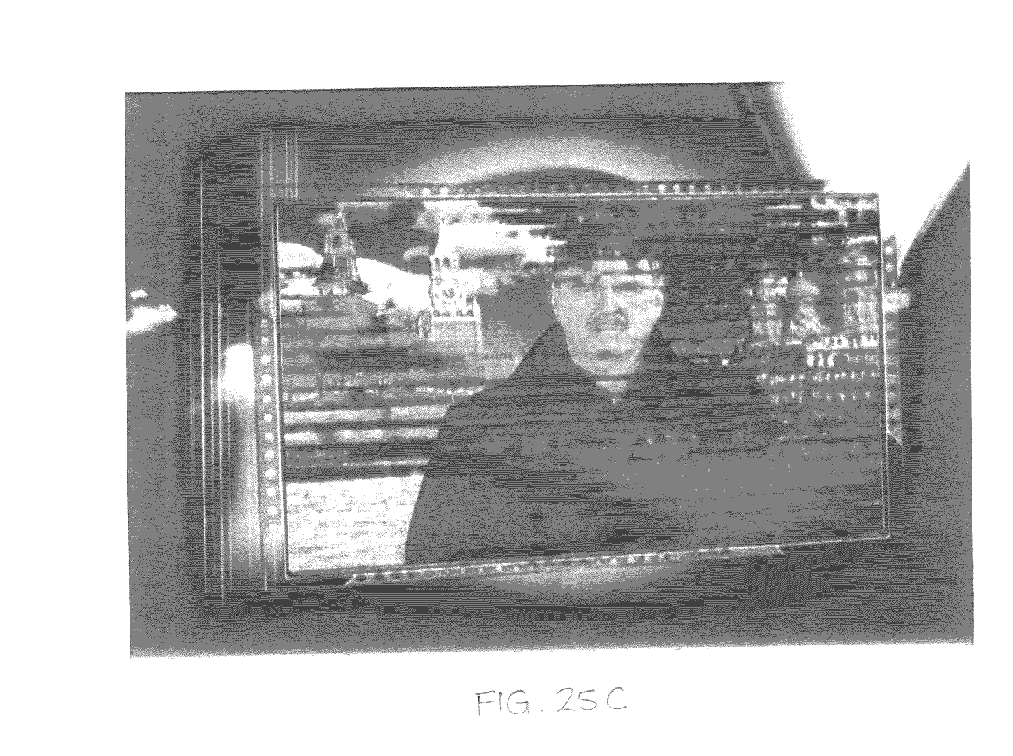

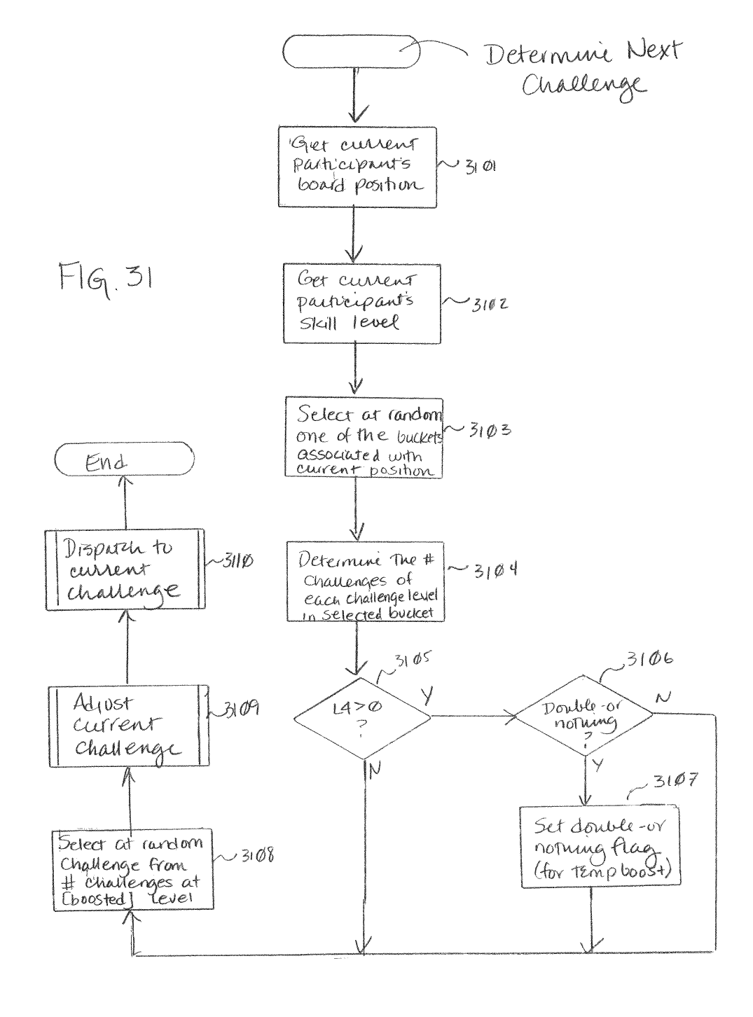

The DGE provides DVD game logic with scoring management 201 to support the various types of challenges, to manage the game flow between participants, and to implement the electronic game board 204. FIGS. 5A-5C are an example flow diagram of the DVD game flow and scoring logic provided by an example DVD Game Environment. In step 501, the DVD game plays introductory videos and sets up the background story for the DVD game. In step 502, the game presents a menu to determine whether the participants want to play the game or obtain further instruction, and when the participant chooses “Play,” proceeds to step 504, otherwise continues in step 503. In step 503, the game plays one or more instructional videos until the participants indicate that they wish to proceed with play. In step 504, the game plays a series of videos and menus to set up the profiles for the game participants and then continues when done in step 505. Note the step 504 is shown in as a “subroutine” or “procedure” for ease of discussion, but “step” 504 is really implemented as a series of other commands (steps) that are executed in the same execution environment. (The DVD platform doesn't yet support a notion of separate functions or procedures with their own execution environment—it is more like assembler with storage and “goto” operations.) This convention will be used throughout, although one skilled in the art will understand that one or more steps may be grouped as separate program chains and navigated to through standard DVD programming techniques.) The additional steps that correspond to step 504 are discussed further below with reference to FIG. 7. The game then presents a menu (steps 505 and 507) that allows participants to set up game options through an options menu in step 506 or to start the game in step 508. FIG. 6 is an example snapshot of an initial menu for determining whether to setup options or to start the game. In step 506, game options can be set, for example whether auto-leveling mode is on and a possible time limit for the game. Example display screens that correspond to these options are described below with reference to FIGS. 12-14. One of items on the menu shown in steps 505 and 507 is to return to step 504 to re-set up the participant profiles. When, in step 507 “Start” is selecting, then game flow continues in step 508. In step 508, after determining a first participant, the DVD game displays the score (position) of the current participant on the electronic game board. In step 509, the game determines by random selection whether to display a Fate Card or a next challenge. If so, then the game presents a randomly selected Fate Card segment in step 510. A Fate card is a special video (potentially accompanied by audio), chosen at random, that determines whether to increase or decrease the current participant's score and hence the participant's position on the game board. An example Fate Card is shown with reference to FIGS. 25A-25C. When the Fate Card finishes presenting, then the DVD game continues to record the resultant score in step 514. In step 511, the DVD game determines the next challenge to present to the current participant. One technique for implementing this series of steps is described below with reference to FIG. 31. One skilled in the art will recognize that there are many ways to select a next challenge and any of them could be incorporated in a DVD game. In step 512, the game presents the determined next challenge which may involve any type of game content, including one or more video segments, audio tracks, menus, etc. In step 513, the DVD game executes a series of steps to perform auto-leveling if this mode has been set (e.g., using the options menu). Auto-leveling, as described elsewhere, dynamically adjusts the skill level of the participant based upon the participants responses to challenges. Thus, since a Fate Card potentially changes a participant's score without involvement from the participant, it is unnecessary to perform auto-leveling after execution of a Fate Card. In step 514, the DVD game records the current score of the current participant (and other status information that is maintained at the end of a turn). In step 515, the game determines whether the current score reflects advancing to the halfway mark on the virtual game board and, if so, presents a congratulatory media segment in step 516 and continues in step 517. Note that the “halfway” feature and other types of game feedback are optional and, in some embodiments, may be turned off. In step 517, the game determines whether the advancement of the current participant has made the participant a winner of the game (there may be more than one if the game allows a round to be completed even with a winner), and if so continues in step 518, otherwise continues in step 523. In step 518, the game presents a winner's appropriate congratulatory media segment. In step 519, the game determines whether there remain other participants to play out the current round, and, if so, continues in step 523 to advance to the next participant, otherwise continues in step 520. In step 520, the game determines whether there is a tie (e.g., more than one participant with the same score), and, if so, continues in step 521 to present whatever type of tie breaker is indicated by the game and determines a single winner. In some embodiments, tie breakers are not supported and the game finishes by announcing the tie or offers another game. Step 522 is implemented in those embodiments that support tie breakers. If there is no tie (and once a single winner is detected), in step 522 the game presents one or more media segments to indicate the overall winner of the game and that the game is over. In step 523, the game determines the next participant's turn and proceeds back to step 508 to indicate the current participant's score and turn. One skilled in the art will recognize that FIGS. 5A-5C present one model of DVD game flow and that many variations exist for treating turns, winning, etc. In addition, DVD games that add challenge types may alter this basic game flow.

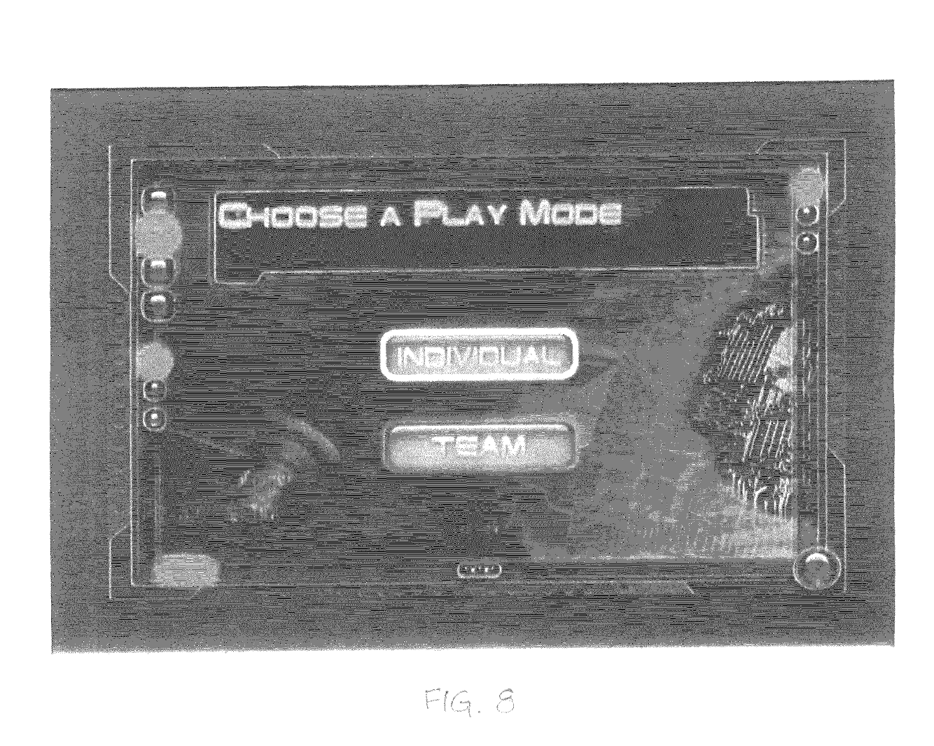

As mentioned in step 504 of FIG. 5, the game participants set up individual profiles prior to playing a DVD game. FIG. 7 is an example flow diagram of a process for setting up the game participants according to an example DVD Game Environment. In step 701, the DVD game first determines whether playing as a team or as an individual is desired. If team mode is desired, then in step 702, the game sets a flag to indicate team mode and initializes other variables so that menus are presented appropriately. Team mode allows multiple individuals to contribute answers to challenges and thus to a single score. FIG. 8 is an example snapshot of a menu for determining whether to play in team or individual mode.

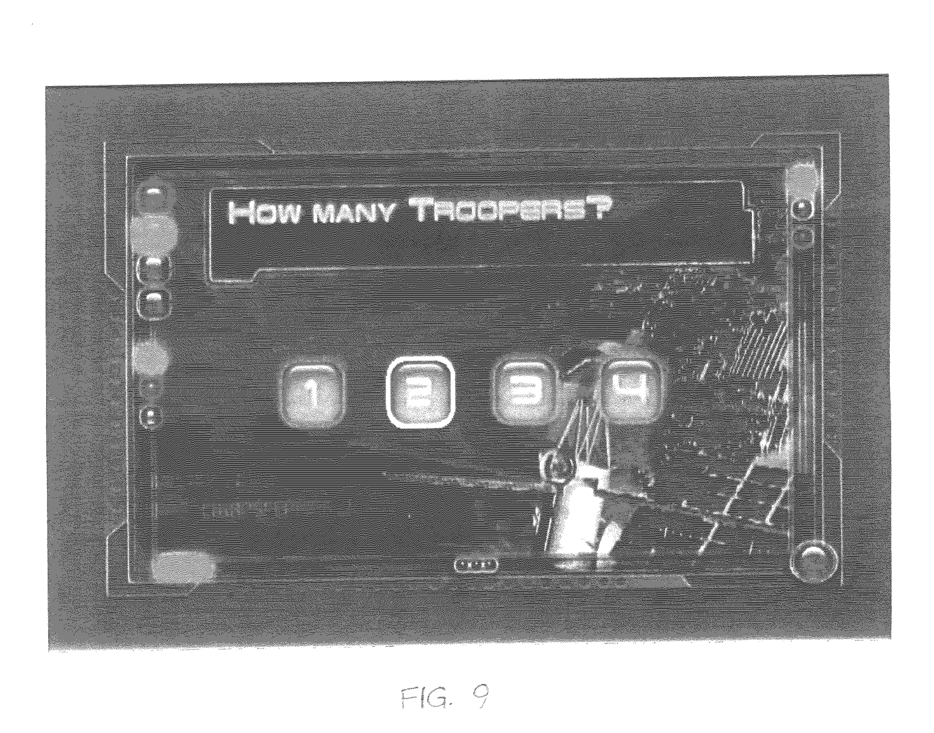

In step 703, the DVD game presents a menu to determine the number of participants that will play the game. In one embodiment, this number is between 1 and 4, although other ranges are contemplated—of course a tradeoff is made as to usage of DVD memory for content versus state information and the electronic game board. FIG. 9 is an example snapshot of a menu for determining the number of game participants. Note that in team mode, this menu preferably omits “1” from the list as 2 or more participants constitute a team.

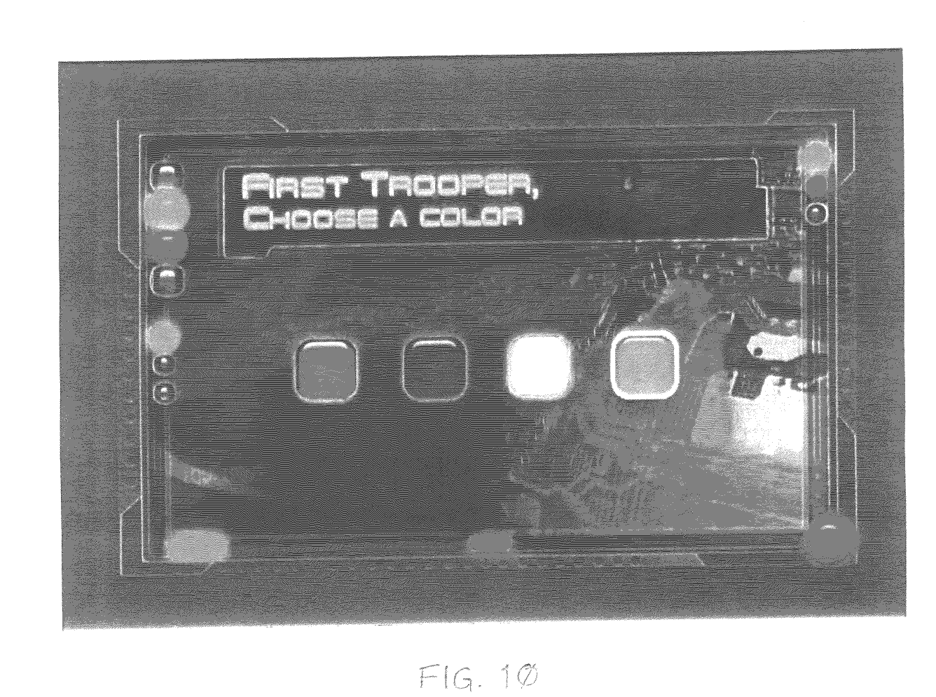

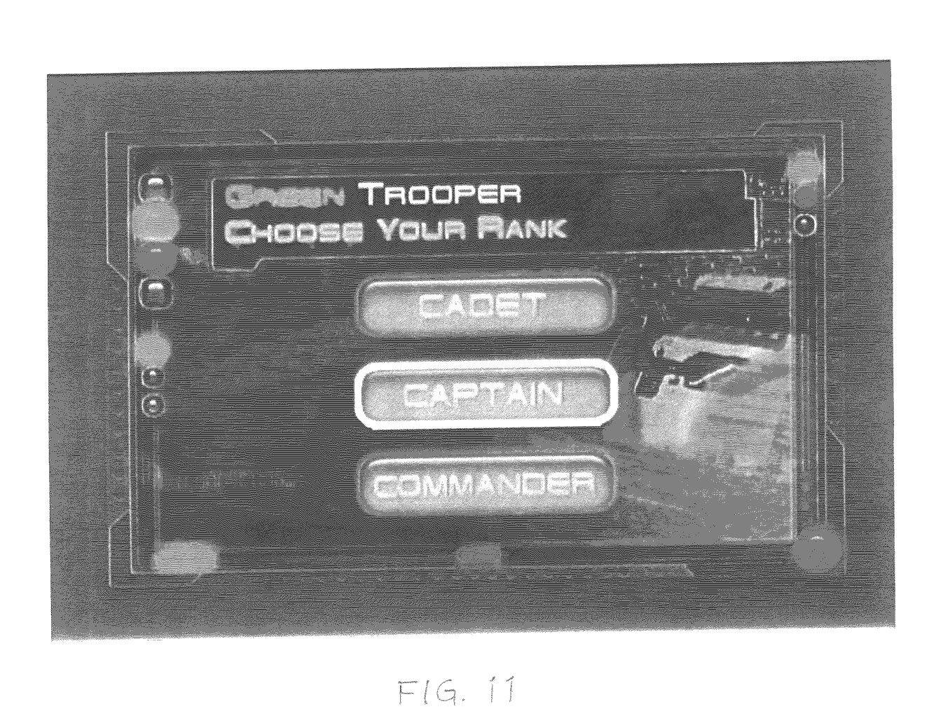

In steps 704-707, the DVD game performs a loop for each participant allowing the participant to choose a representative color (or other participant indicator) to be used for the electronic game board and a skill level for determining challenges. Specifically, in step 704, the game gets the next participant (by number) to process. In step 705, the game determines whether all have been processed, and, if so, is done with this set of steps, otherwise continues in step 706. In step 706, the game presents a set of possible color choices left, determines a selected color for the current participant from a menu, and removes the selected color from the possible choices for the next participant. FIG. 10 is an example snapshot of a menu for determining a color for a selected game participant. In step 707, the game determines an initial skill choice (challenge difficulty level) for the currently processed participant, and returns to the beginning of the loop in step 704. FIG. 11 is an example snapshot of a menu for determined a challenge difficulty level for a selected game participant. In this example embodiment, three levels, easy, medium, and hard, are available and correspond to “Cadet,” “Captain,” and “Commander.” One skilled in the art will recognize that different numbers of skills may be provided using the techniques described herein and that they may be mapped to various other categories.

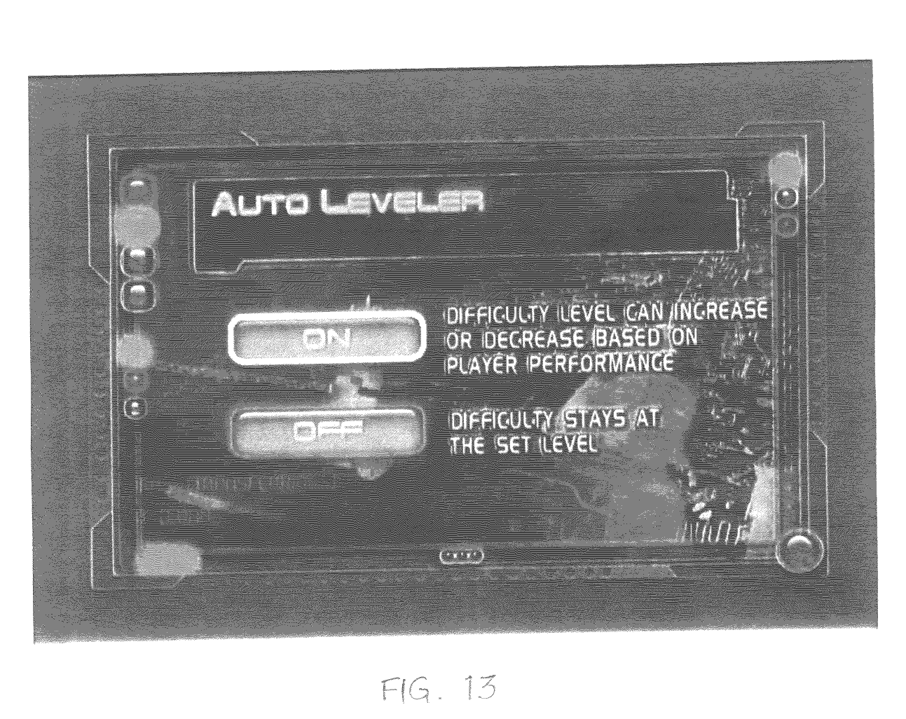

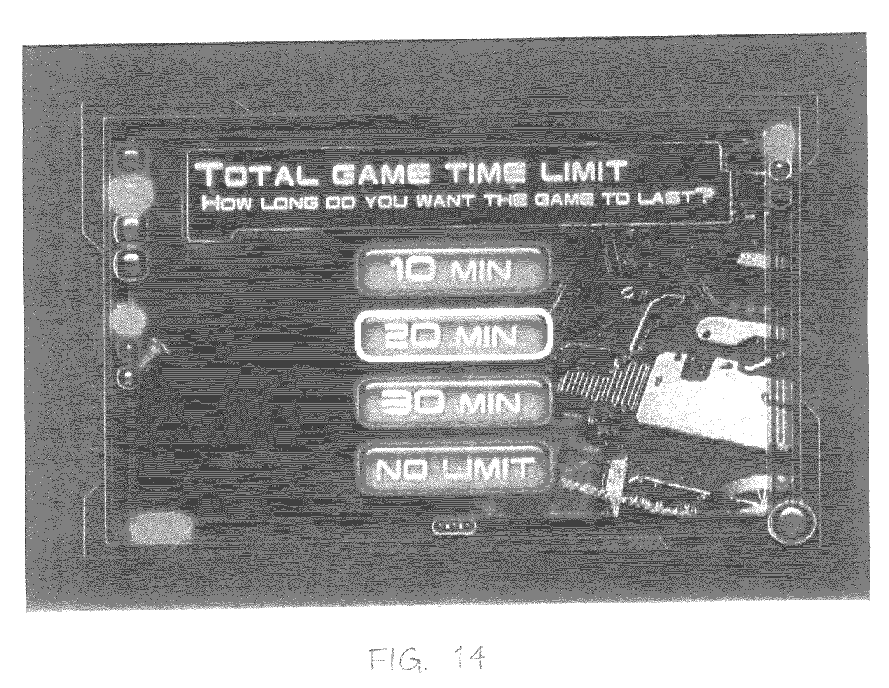

As described in steps 505-507, the DVD game allows participants to setup game options prior to operating a DVD game session. FIG. 12 is an example snapshot of a menu for determining game options. The example shown provides options for setting and unsetting an Auto-Leveler™ feature and game time limits, although other options could be provided. FIG. 13 is an example snapshot of a menu for turning on and off the automatic leveling feature. Turning the feature on, allows the DVD game to automatically adjust the difficulty level of the challenges presented. FIG. 14 is an example snapshot of a menu for setting an optional time limit for the current DVD game session. In the example shown, options are available for a 10-minute, 20-minute, 30-minute, or unlimited game time; however, additional time periods or different time periods could be supported.

As mentioned, various different types of challenges are supported by an example DGE, although others could be easily integrated. FIGS. 15A-22I are sequences of snapshots of various types of challenges that can be presented by an DVD game using the example DVD Game Environment. The challenges illustrated are exemplary of the type of challenges that can be operated by a DVD game. In many cases, these challenges have multiple outcomes which may depend upon both skill and strategy. Although there are eight types of challenges, these types may not be available in any one instance to do difficulties in supporting timing functions on various DVD players. One skilled in the art will recognize that enhancements may be made to the various types of challenges, for example, adding different timing aspects or movement aspects to an underlying challenge, yet still achieve the purposes described herein. Also, the term “challenge” is used to refer to any type of puzzle or question or task.

FIGS. 15A-15B is an example sequence of snapshots illustrating a multiple choice type of game challenge. In FIG. 15A, a question 1501 is presented with an associated picture 1502 illustrating the topic of the question. Optionally, an audio track is played along with presentation of the question 1501. Possible answers 1503-1506 are shown in some portion of the video display. A participant selects one of the possible answers by using a navigation button to highlight the desired choice and a selection button (e.g., ENTER button or DVD player equivalent) to indicate an answer. FIG. 15B shows a selection of an answer 1507 and allows the participant to press an “OK” button 1508 to end the video segment more expeditiously. (The DVD game will detect whether the answer is correct based upon the selection, not upon pressing the “OK” button 1508.)

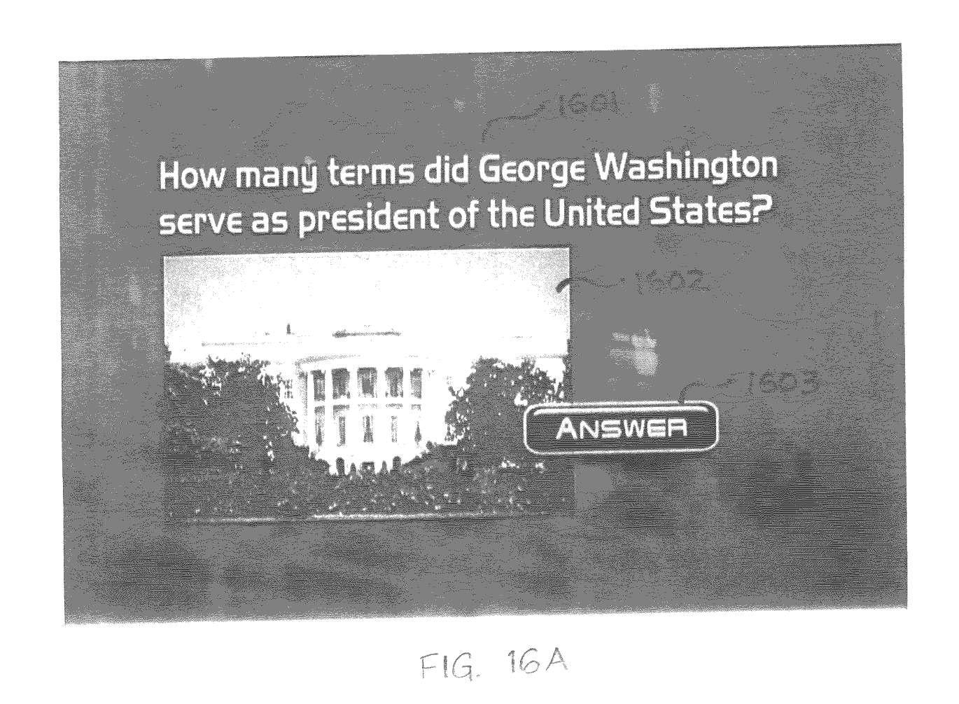

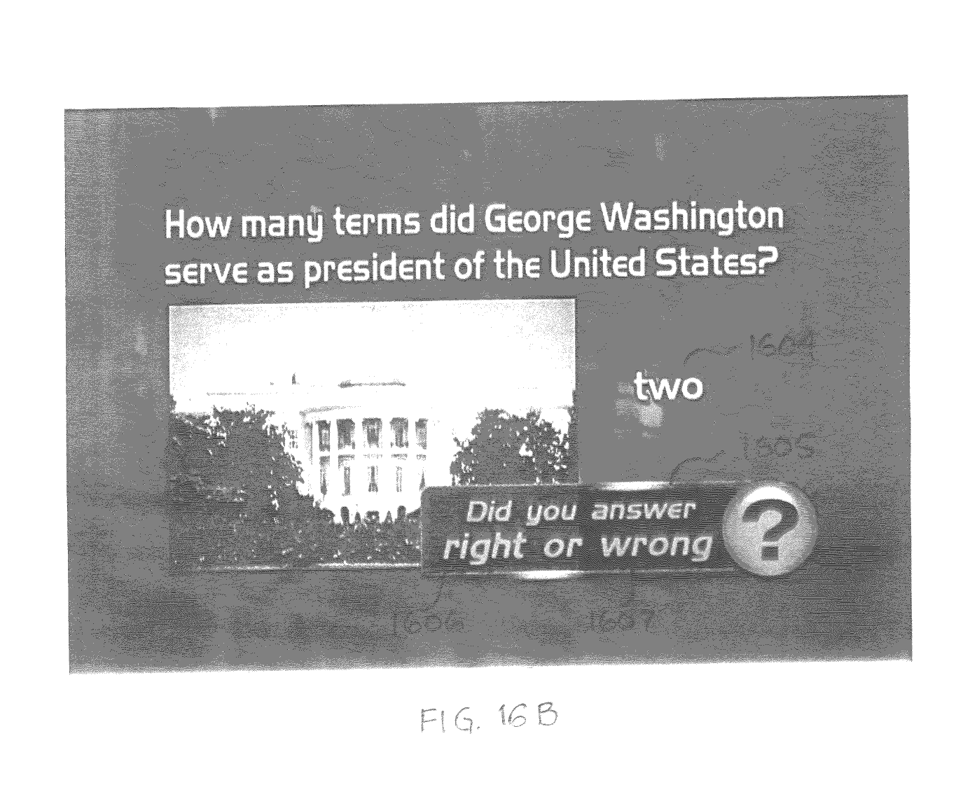

FIGS. 16A-16B is an example sequence of snapshots illustrating an open response type of game challenge. In this type of challenge the DVD doesn't automatically detect the correct answer, but receives indication from the participant of whether the answer is correct. Specifically, in FIG. 16A, a question 1601 is presented with an associated picture 1602 illustrating the topic of the question. Optionally, an audio track is played along with presentation of the question 1601. When the current participant presses the “Answer” button 1603, the DVD game detects that the challenge was answered and then presents a video segment to receive an indication of whether the participant answered correctly. FIG. 16B is a snapshot of a video segment used by the DVD game to detect a right or wrong answer. In addition to the question 1601 and the topic picture 1602, the correct answer 1604 is displayed. Also, the game presents a question 1605 (“Did you answer Right or Wrong?”) so that the participant can indicate whether the participant answered the challenge correctly. The DVD game then adjusts the score accordingly.

Note that the question 1605 is presented as a menu with two buttons “Right” 1606 and “Wrong” 1607 due to current limitations of the DVD platform. As other means are developed in an enhanced DVD platform to obtain user input, one skilled in the art will recognize that the challenges presented herein can be modified accordingly to accommodate the new techniques. The examples below that describe other example DVD game challenges may similarly incorporate menus and buttons as a means of obtaining input, and it is to be understood that all of these examples can be enhanced accordingly yet still achieve the purposes of the present invention.

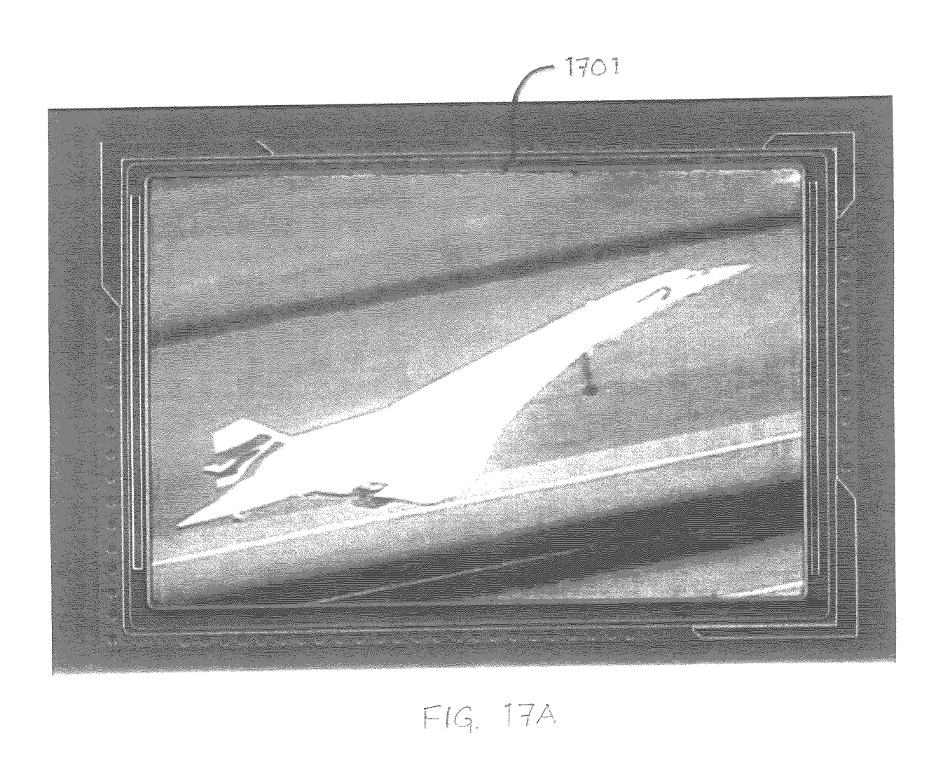

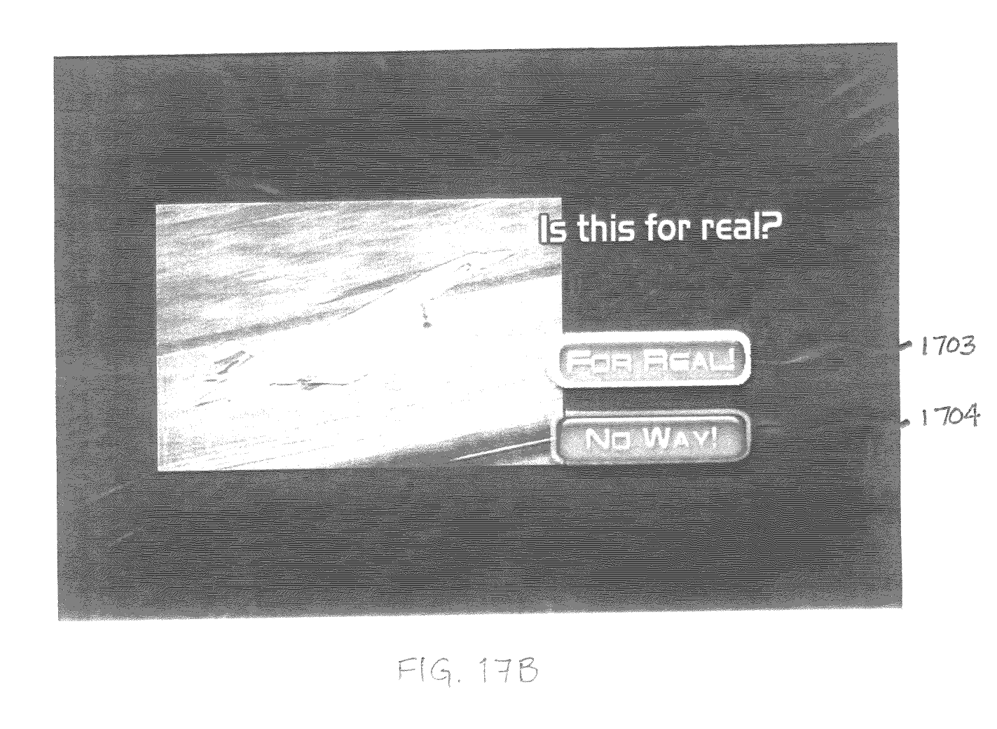

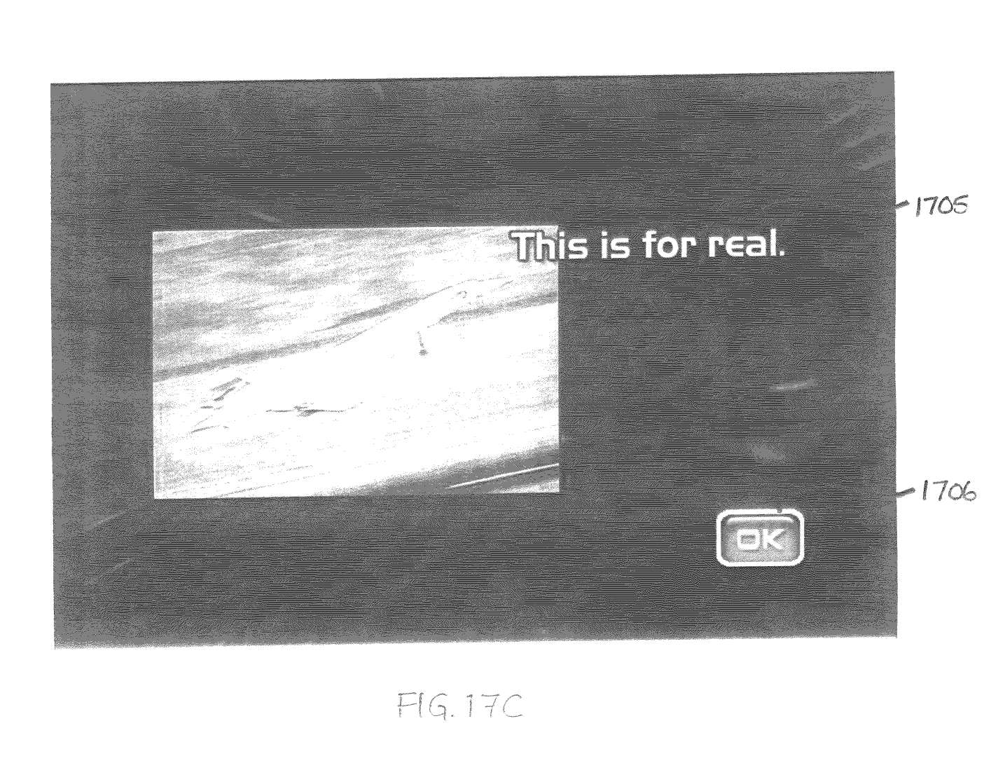

FIGS. 17A-17C is an example sequence of snapshots illustrating a true/false type of game challenge. In this particular example, an audio track is played and asserts a statement related to the video segment shown in picture 1701. In FIG. 17B, he participant is then queried as to whether the assertion is true or false, as seen in the question 1702 “Is this for real? (which is concurrently queried by a corresponding audio track). The DVD game presents a menu with two buttons “For Real!” 1703 and “No Way!” 1704, from which the participant chooses the correct answer. In FIG. 17C, the correct answer 1705 is displayed, and the game detects whether the participant successfully responded and adjusts the score accordingly. As in other challenges, pressing an “OK” button 1706 allows the participant to end the video segment more expeditiously.

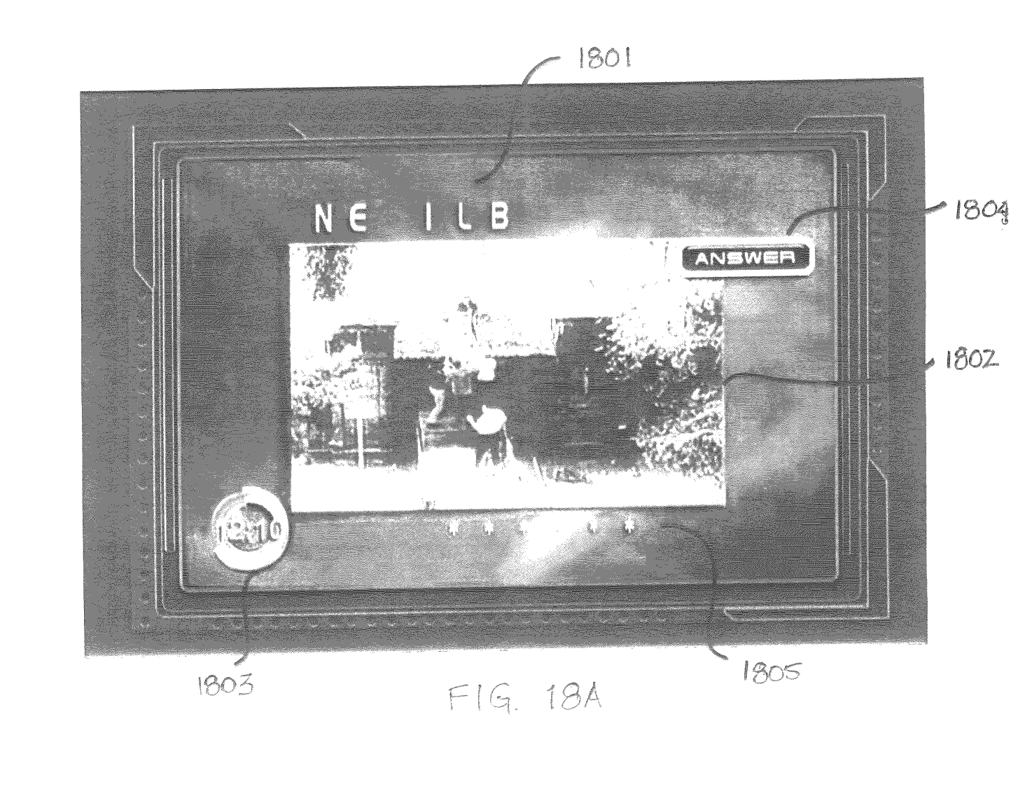

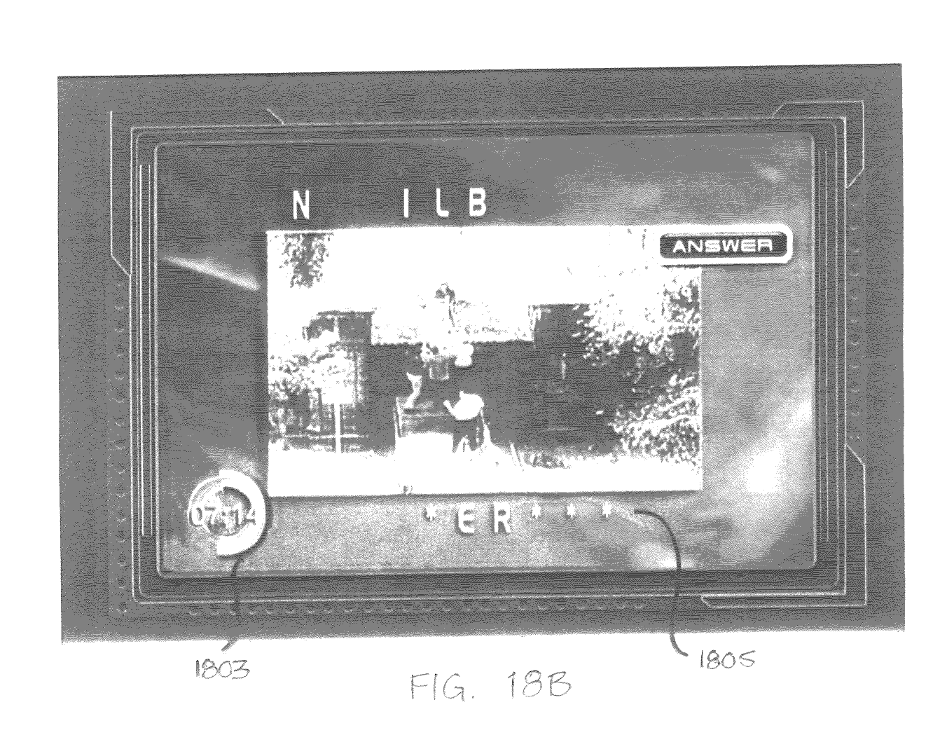

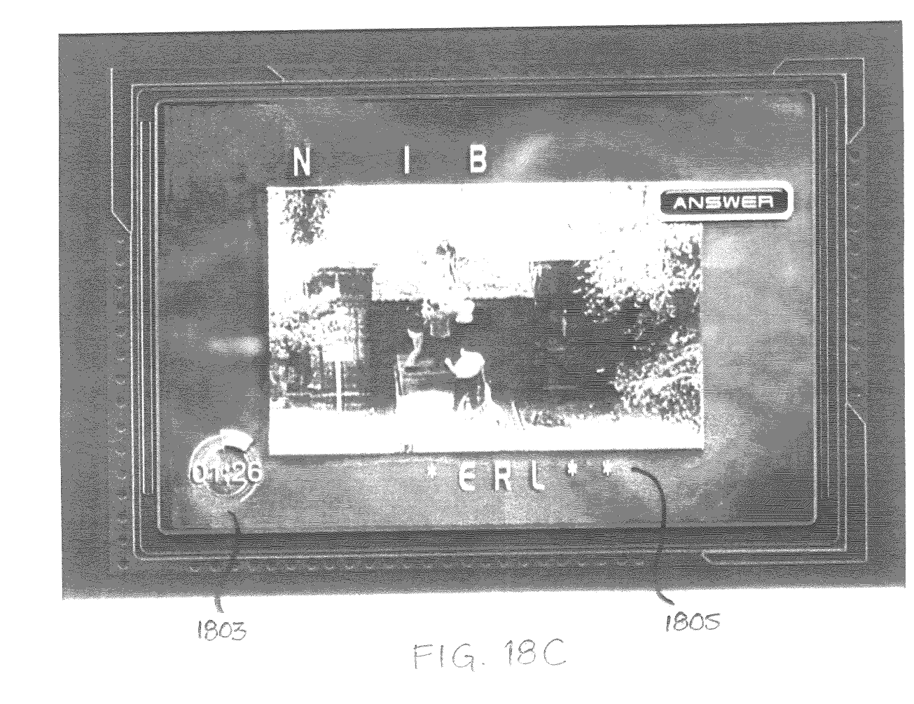

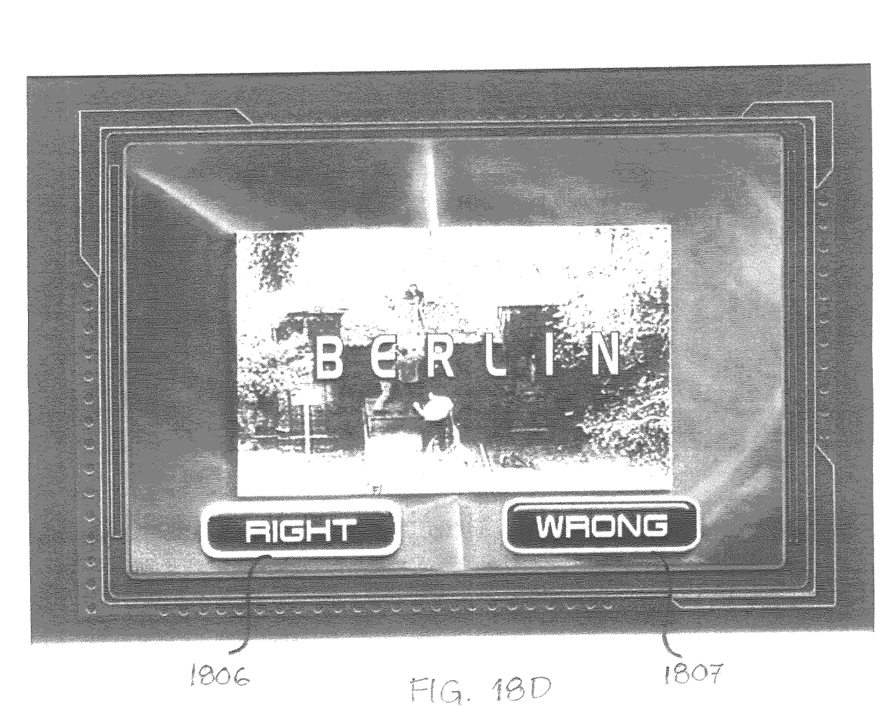

FIGS. 18A-18C is an example sequence of snapshots illustrating an anagram type of game challenge. The object of this challenge is for a participant to determine the correct word(s) by unscrambling a series of letters or words or numbers (a puzzle) in an allotted amount of time (for example, 20 seconds) before the puzzle solves itself. The participant selects an “Answer” button to indicate that the puzzle is solved. In some embodiments, the score varies with the time period taken to respond to the challenge. In FIG. 18A, an anagram 1801 (a scrambled word puzzle) is displayed in one portion of a video segment with an associated picture 1802 illustrating the topic of the anagram 1801, while the letters or words slowly drop into the unscrambled answer 1805 over the period of time indicated by timer 1803. FIGS. 18B and 18C illustrate the anagram partially solved, with the unscrambled answer 1805 becoming more filled in as the timer 1803 decreases. When the current participant presses the “Answer” button 1804 before the time on timer 1803 elapses, the DVD game detects that the challenge was answered within the allotted time and then presents a video segment to receive an indication from the participant of whether the participant answered correctly. FIG. 18D is a snapshot of a video segment used by the DVD game to detect a right or wrong answer. The correct unscrambled answer 1805 is displayed along with a menu with two buttons, a “Right” button 1806 and a “Wrong” button 1807 so that the participant can indicate whether the participant answered the challenge correctly. The DVD game then adjusts the score accordingly.

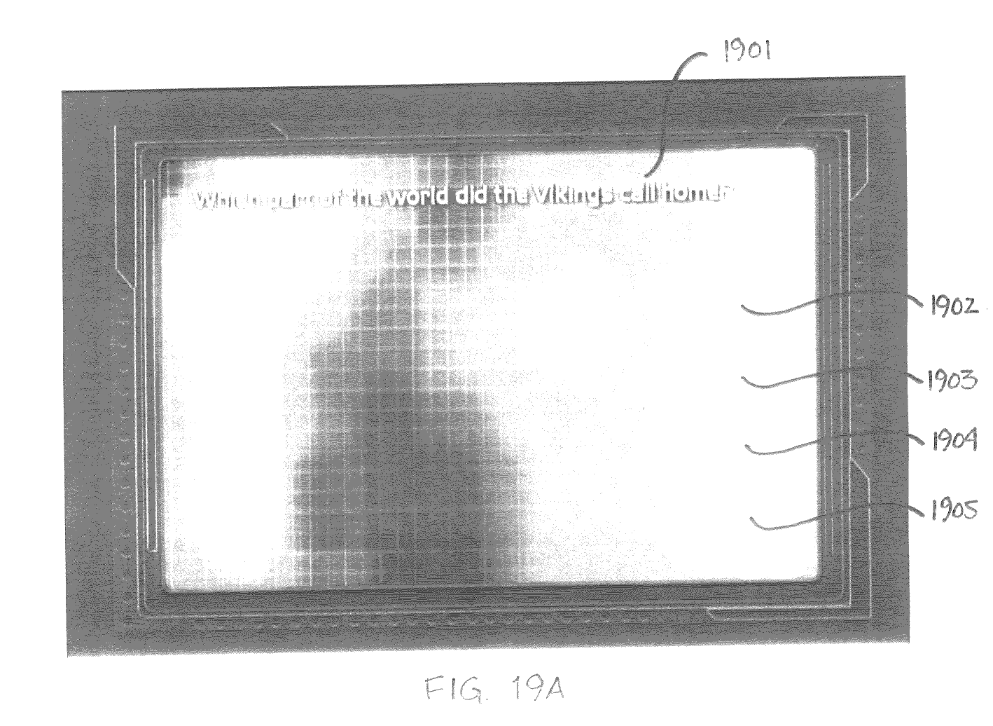

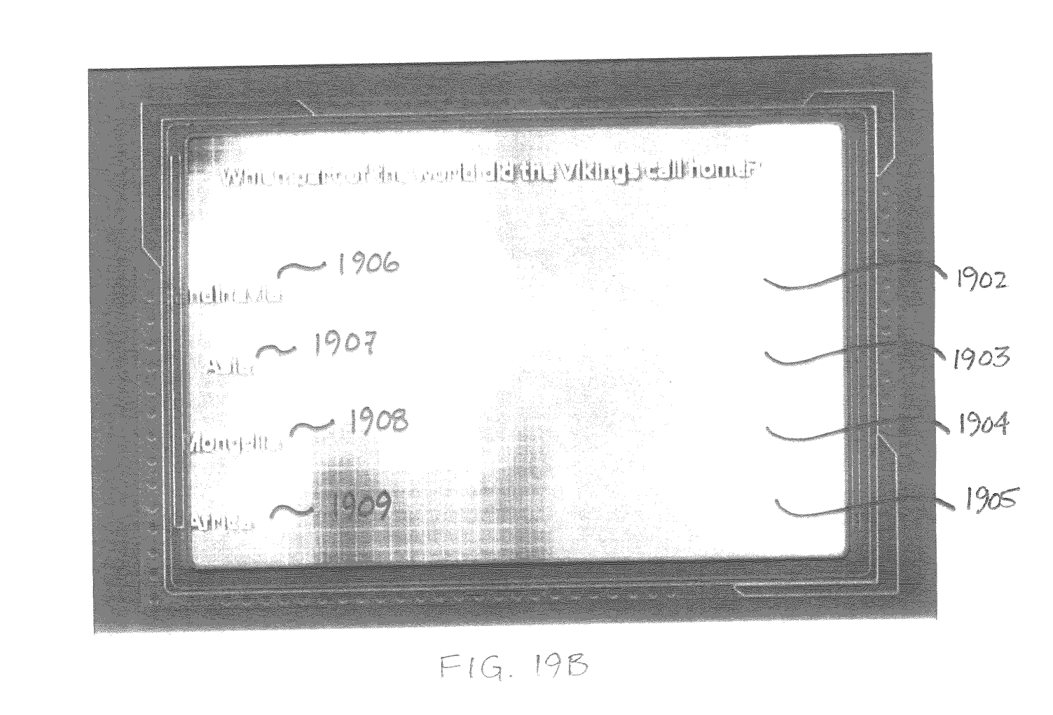

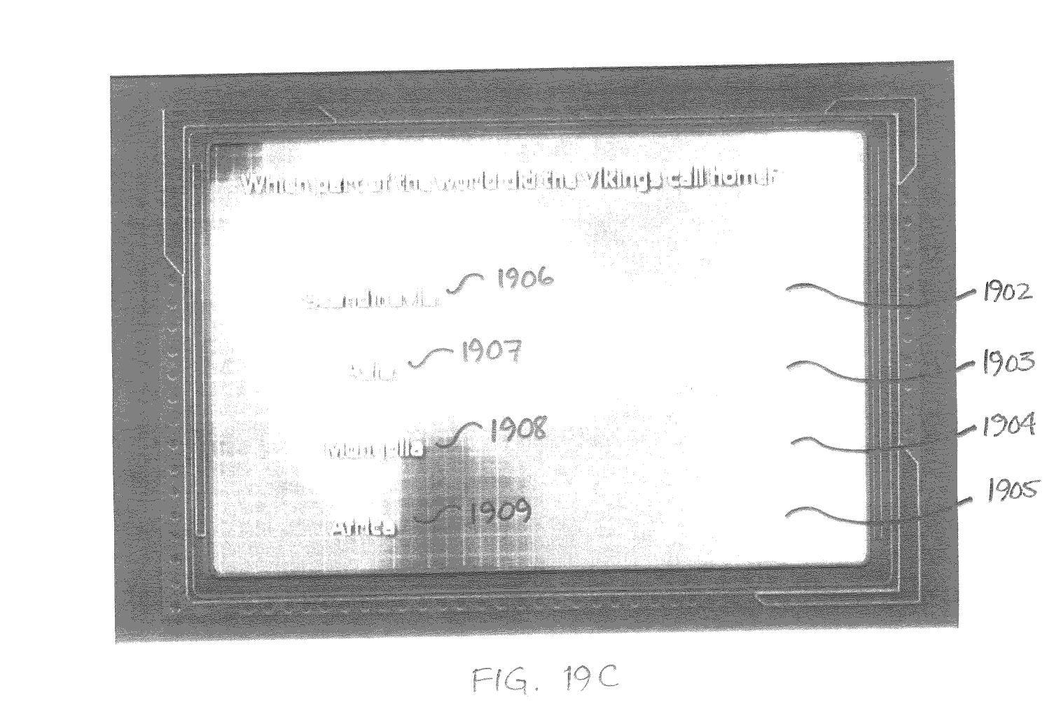

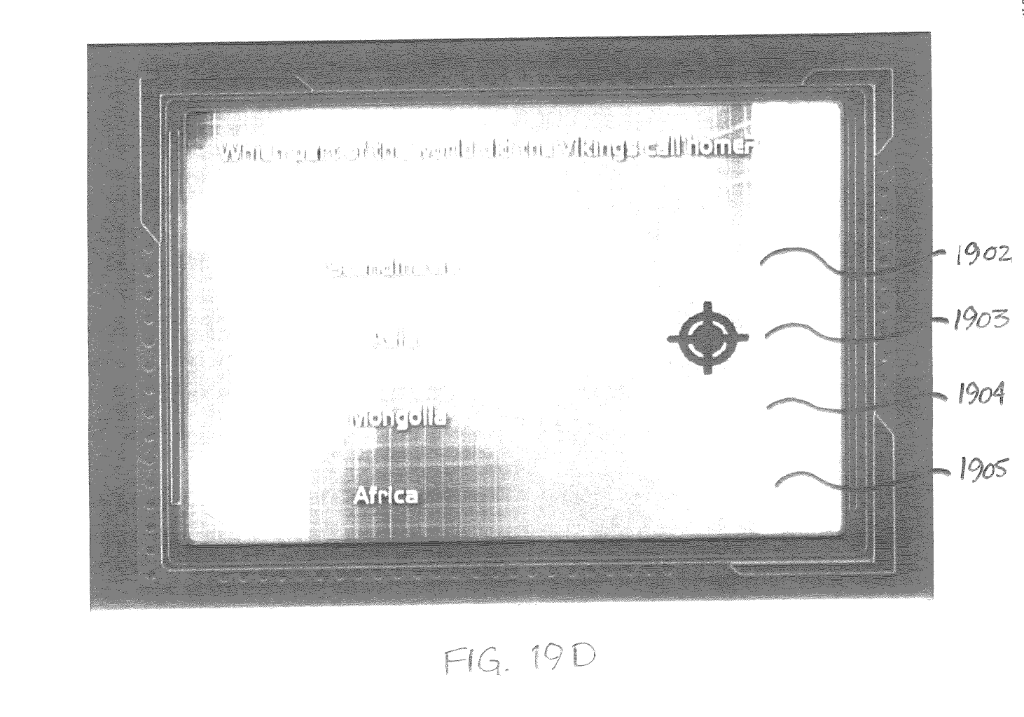

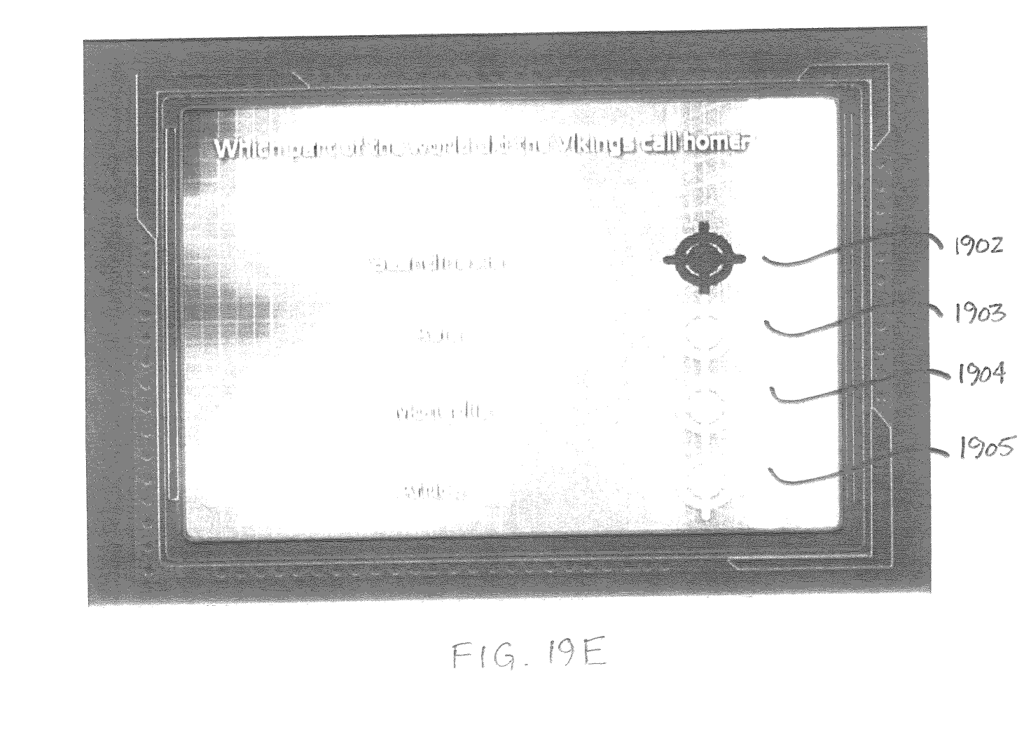

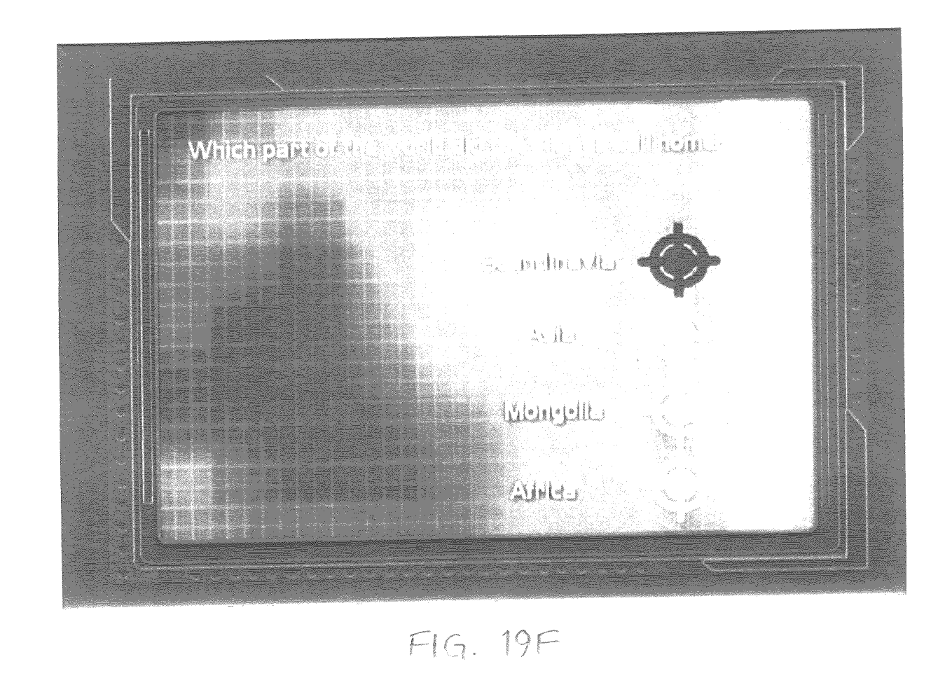

FIGS. 19A-19F is an example sequence of snapshots illustrating a “side scrollers” type of game challenge. This challenge is a timed version of a multiple choice challenge and includes animation. A predetermined number (for example, four or five) answers to a question scroll onto the display area from one side, and a participant must select a row that corresponds to the correct answer before the answers scroll into the row indicators. One skilled in the art will recognize that other variations of “scroller” challenges are possible, including ones in which the answers are animated differently, scroll in from another area of the screen, at different speeds, and similar variations, and included ones in which column indicators are selected instead of row indicators. FIG. 19A illustrates an initial setup of a “side scroller” challenge, in which a question 1901 is presented as a video along with (optionally) an audio track that reads the question. A menu containing one or more answer indicators, buttons 1902-1905, in this case row indicators, align one side of the display area. FIGS. 19B-19C illustrate an animation that shows the potential answers 1906-1909 scrolling in from the side of the display area towards the answer indicators 1902-1905. In FIG. 19D, the participant has moved a highlight to an answer indicator button 1903, which corresponds to the answer “Asia.” The participant can move the highlight to a different potential answer button, for example, answer indicator button 1902, using the navigation keys (or DVD player equivalent) as shown in FIG. 19E. When the participant selects the desired answer (for example, by pressing the Selection key) as shown in FIG. 19F, the DVD game automatically detects whether the challenge was answered correctly and adjusts the score accordingly.

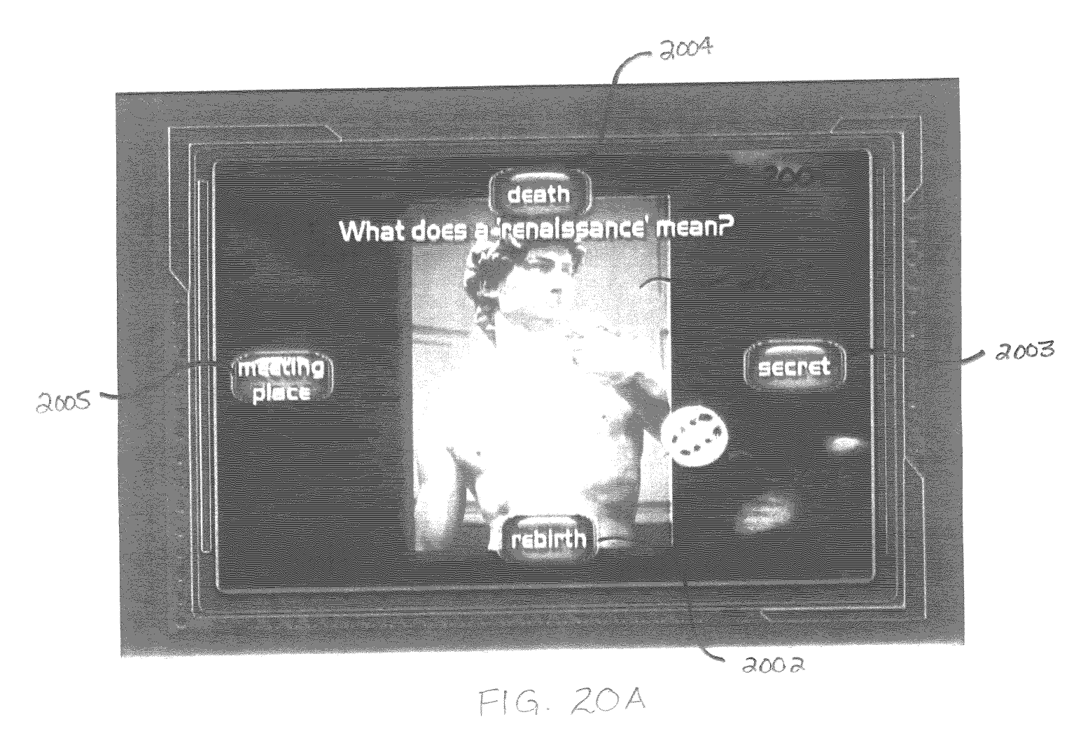

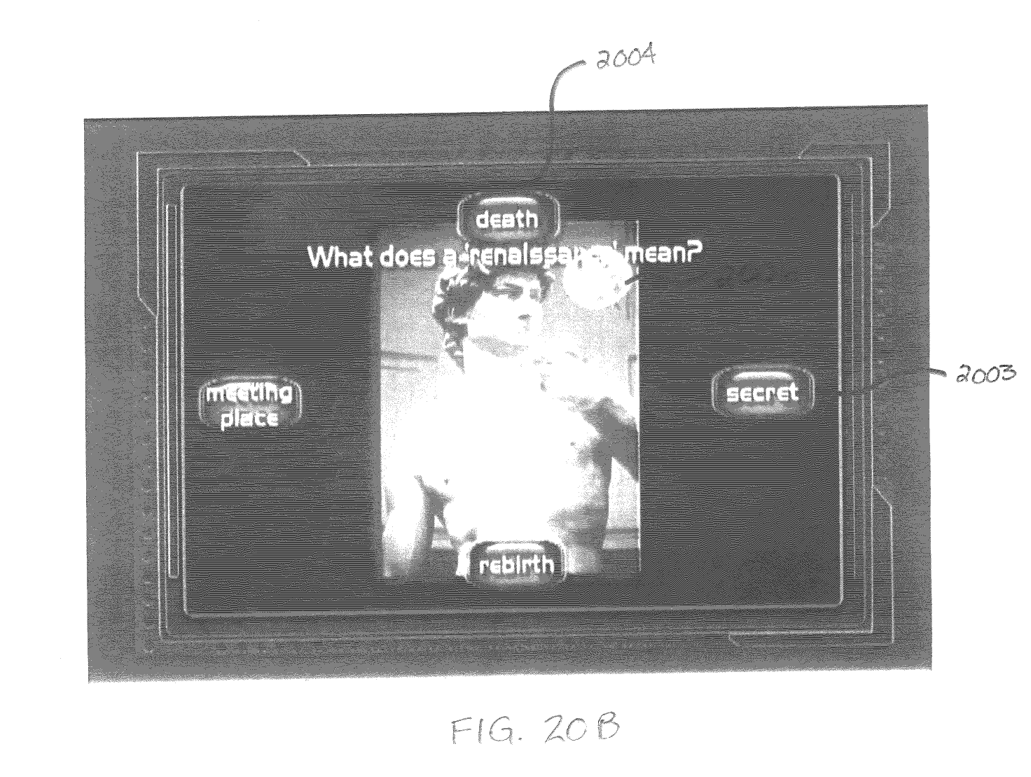

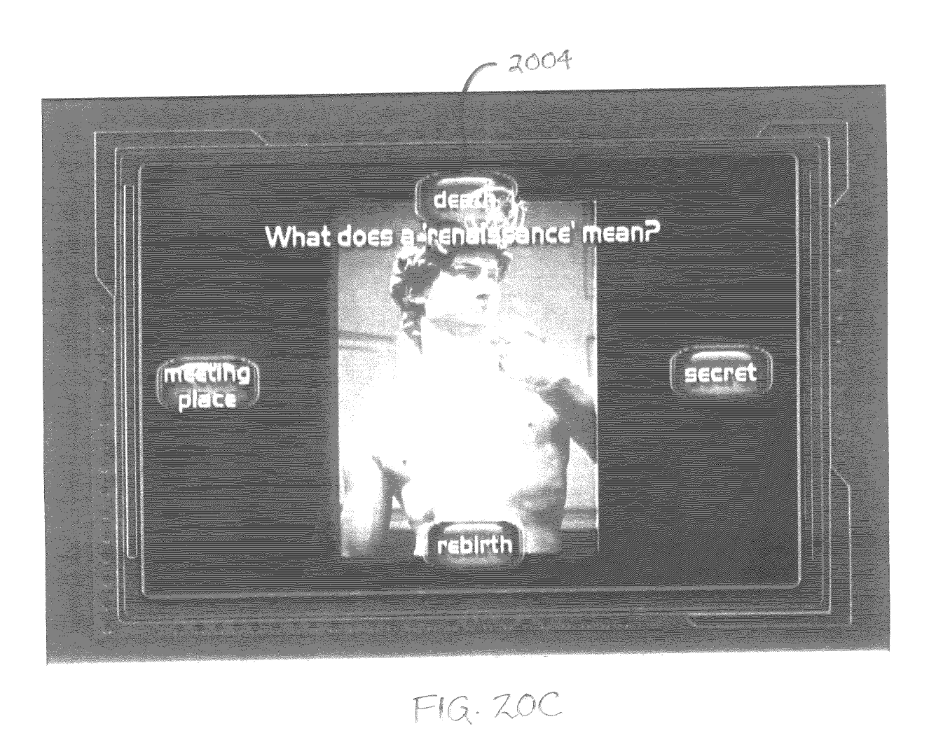

FIGS. 20A-20C is an example sequence of snapshots illustrating a circling cursors type of game challenge. A snapshot from this challenge was presented also as FIG. 1. The object of a circling cursors challenge is to select the correct answer at the (approximate) same time a moving cursor passes over the correct answer. In FIG. 20A, as described earlier, a question 2001 is presented as part of a video segment (also known as a “video clip”) in the middle of the screen, which is optionally accompanied by an audio track. The game displays a menu in which four possible answers (buttons) 2002-2005 surround a picture 2007 that is used to illustrate the topic of the question 2001. A cursor 2006 is shown in its movement from possible answer 2002 to answer 2003. In FIG. 20B, the cursor 2006 is shown moving from possible answer 2003 to 2004 and coinciding with (incorrect) possible answer 2004 in FIG. 20C. As the cursor 2006 circles through the answers 2002-2005, the game participant selects a response by pressing a selection button (typically the “ENTER” button or DVD player equivalent) when the cursor 2006 coincides with the answer 2002-2005 that the participant believes is correct. When the participant selects the correct answer (in this example possible answer 2002), then the DVD game automatically detects whether the challenge was answered correctly and adjusts the score accordingly.

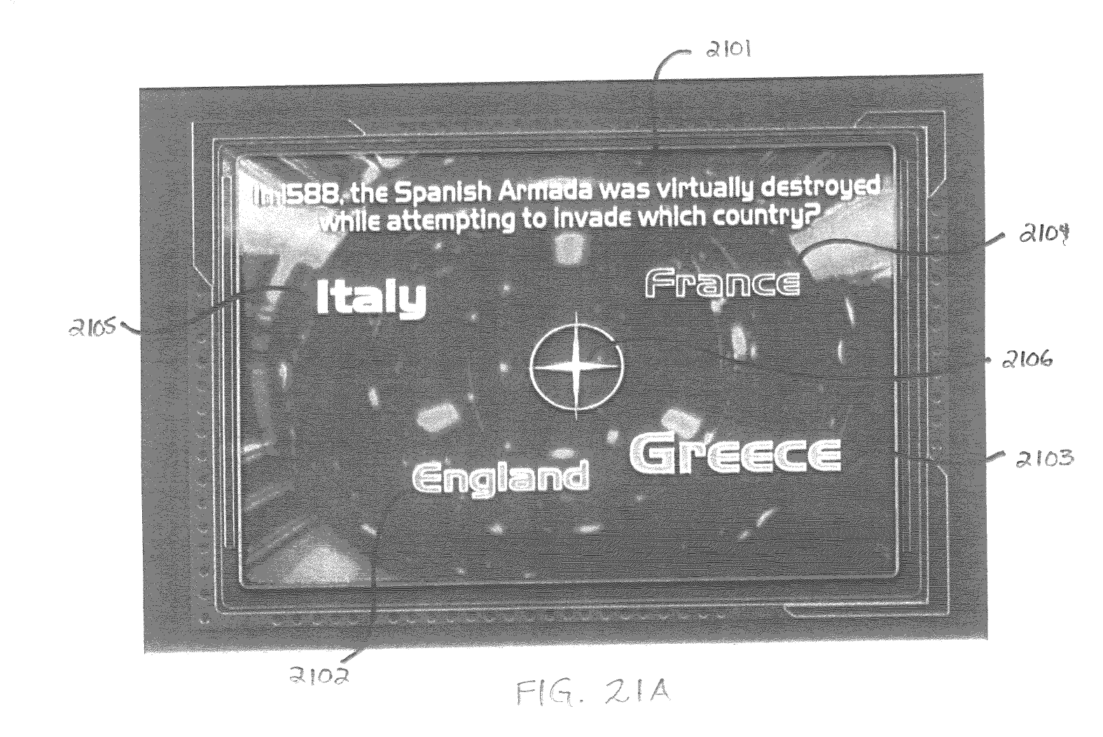

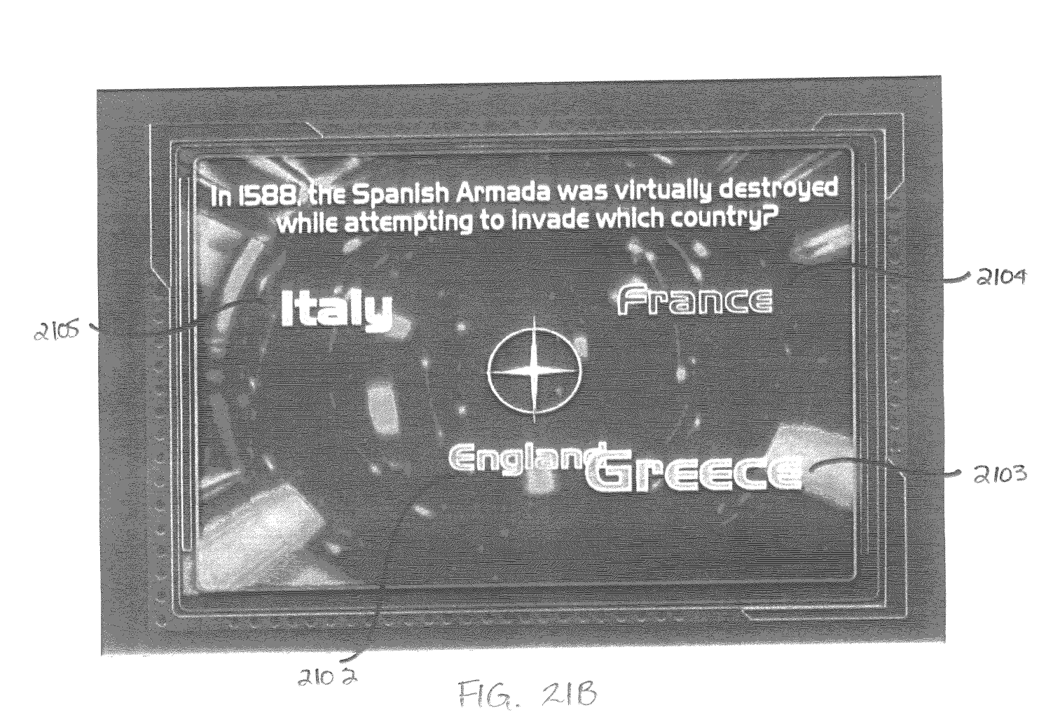

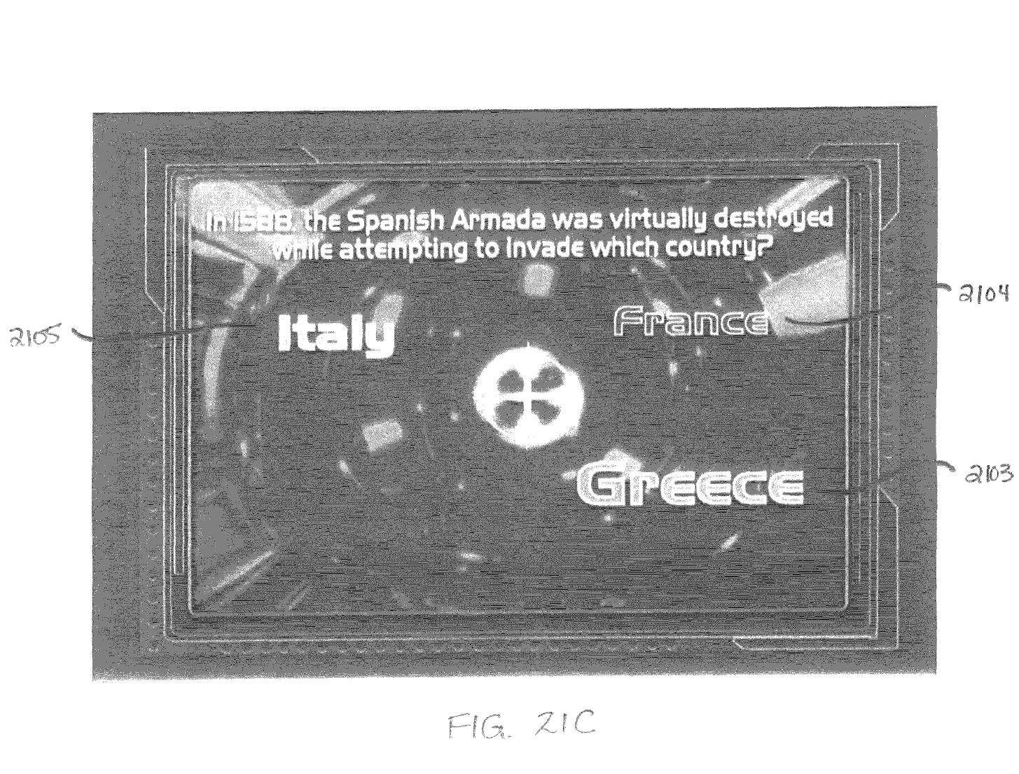

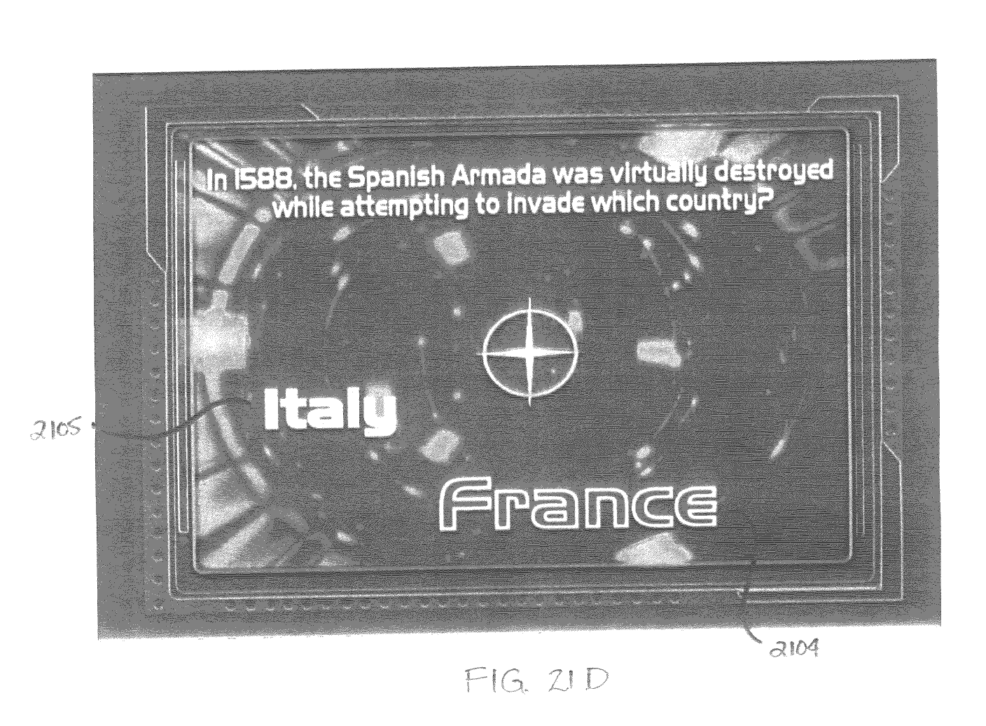

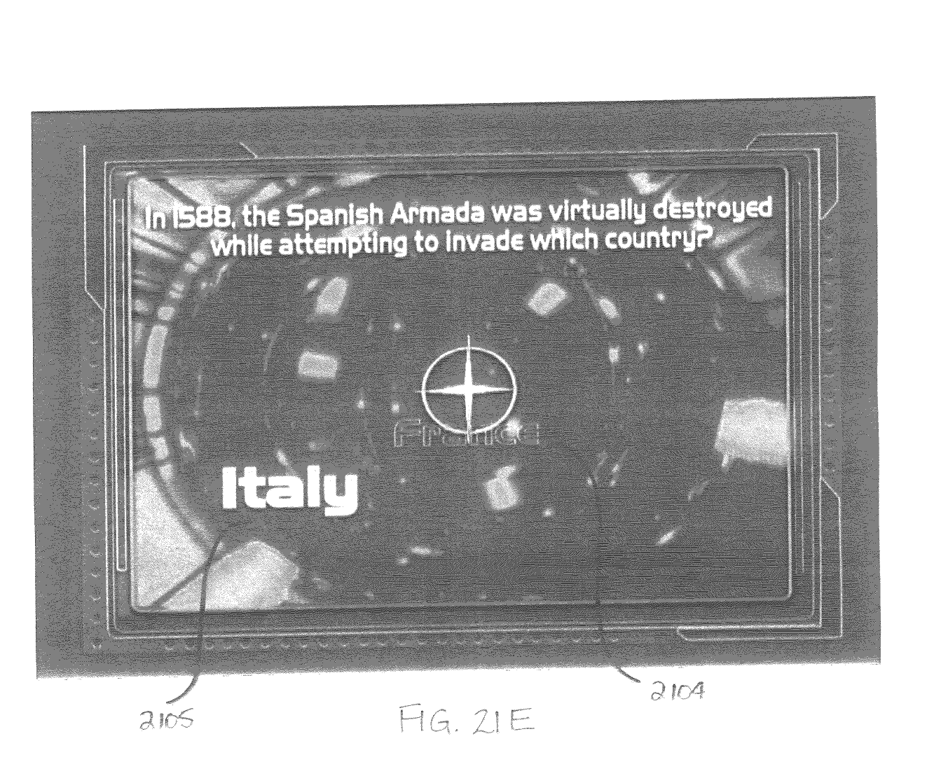

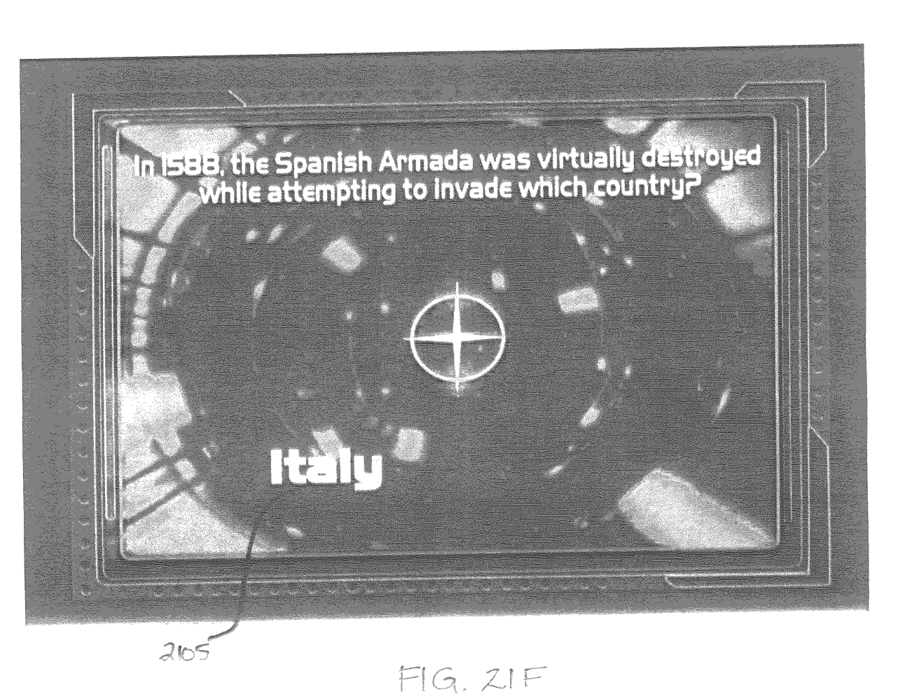

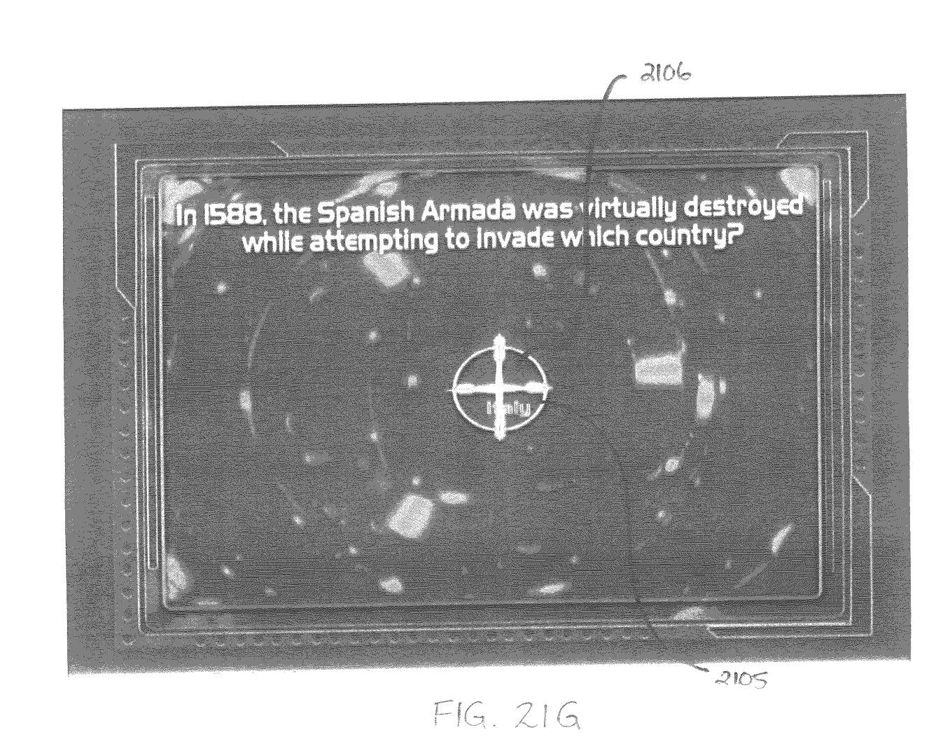

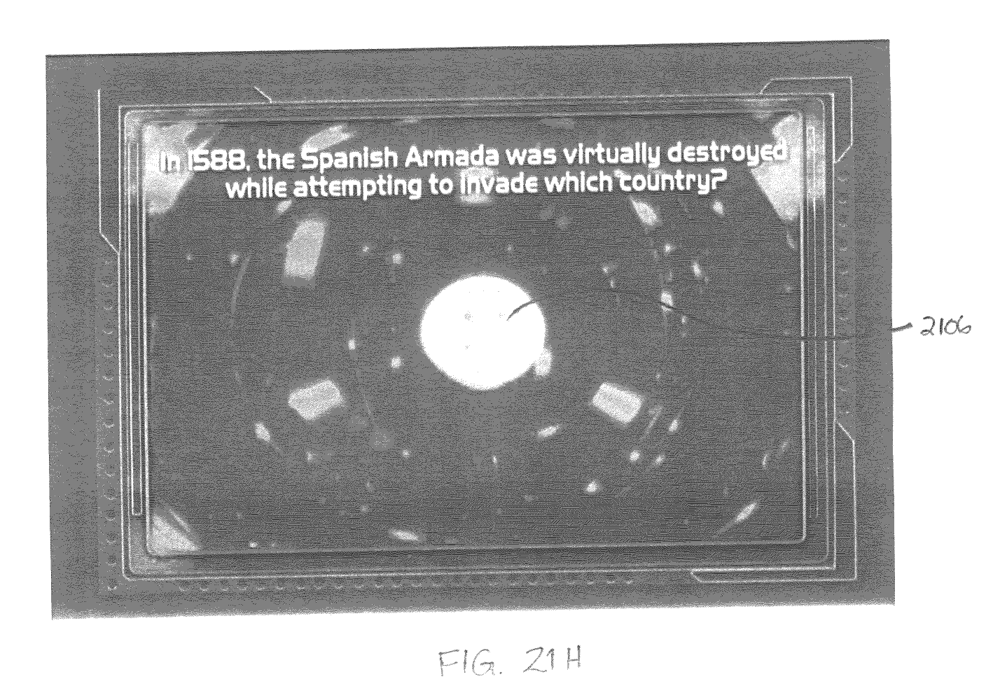

FIGS. 21A-21H is an example sequence of snapshots illustrating a black hole type of game challenge. The object of a black hole challenge is to select the correct answer to a challenge as the answer passes through a highlighted target (into the black hole). FIG. 21A illustrates a beginning video of a black hole challenge which presents a question 2101, optionally accompanied by an audio track. A series of possible answers 2102-2105 move around on the display area, as shown in FIGS. 21A-21B, before they are “consumed” by a black hole marked by a target cursor 2106. Each answer eventually moves towards the target cursor 2106 as shown in FIGS. 21A-21G and, thus, the participant must select the correct answer before it disappears. FIGS. 21C-21D shows the animation after answers 2102 and 2103, respectively, have been consumed. FIG. 21E shows the animation in the process of consuming answer 2104. FIG. 21F shows the animation after answer 2104 has been consumed. FIG. 21G shows the animation in the process of consuming the last possible answer 2105 and FIG. 21H shows the target cursor 2106 highlighted as needed in order for the participant to time selection of an answer. Upon selection of an answer (or in other embodiments after all of the answers have been consumed), the DVD game automatically determines whether the participant selected the correct answer and adjusts the score accordingly.

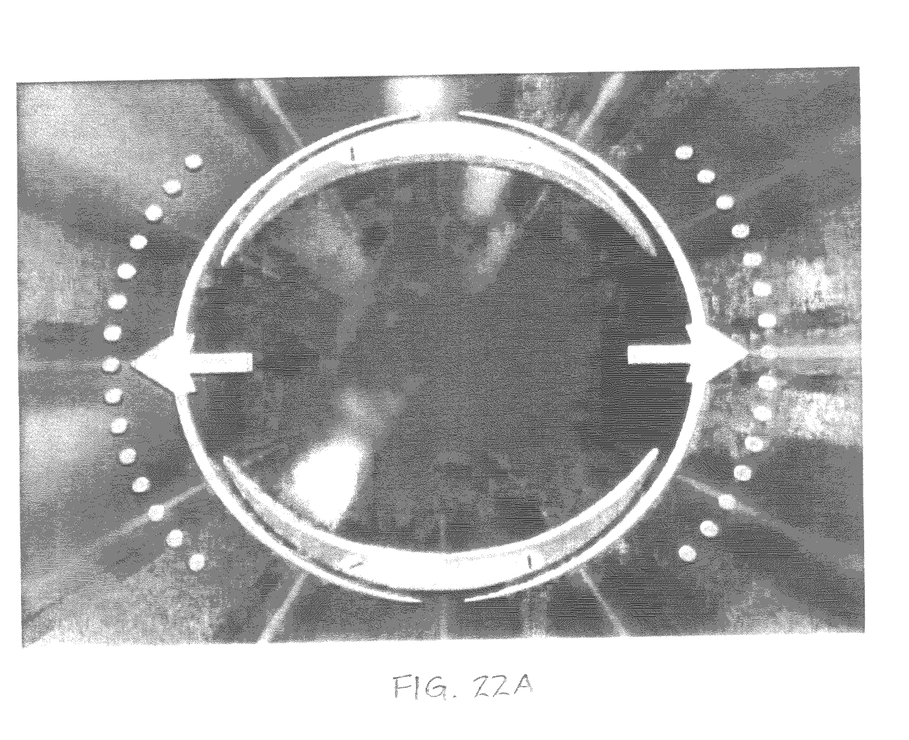

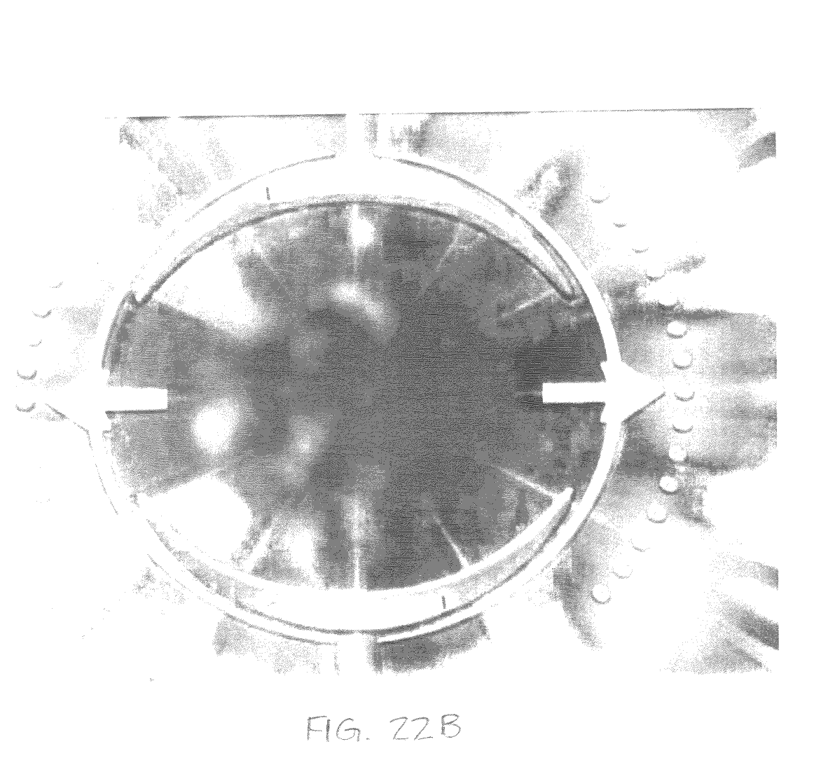

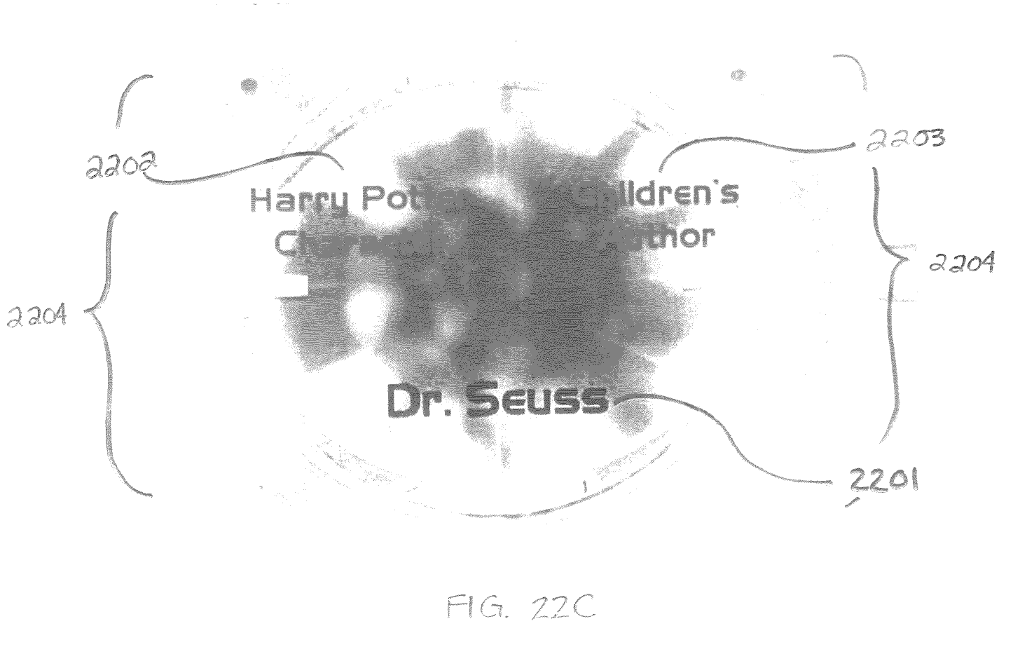

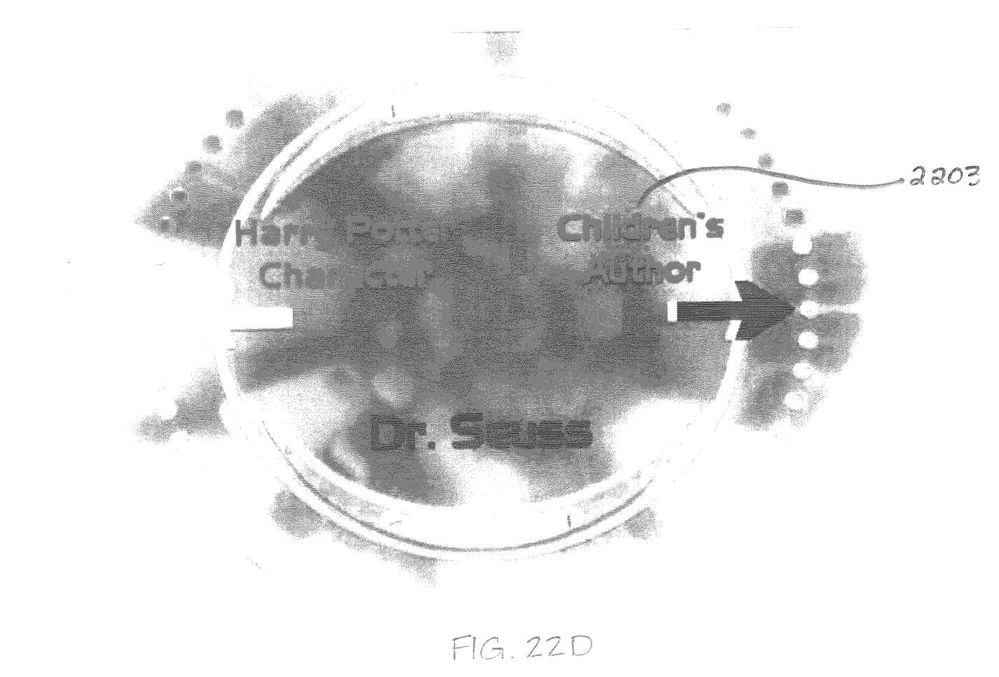

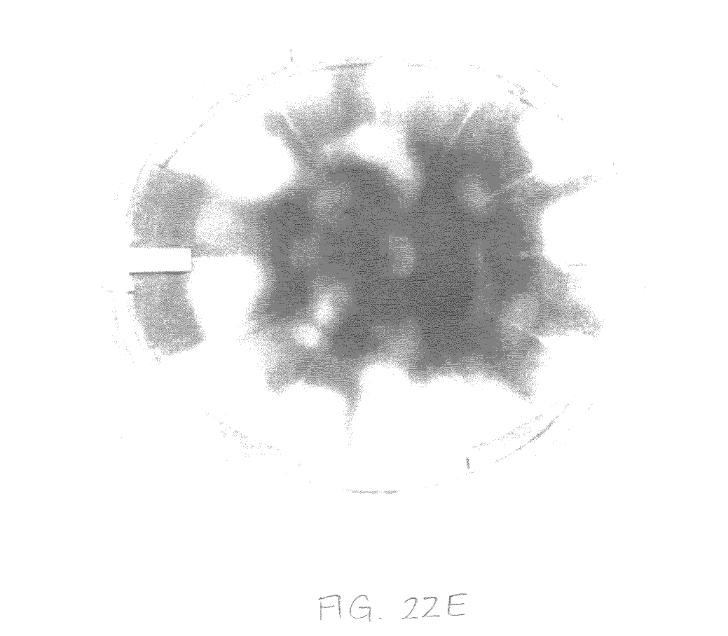

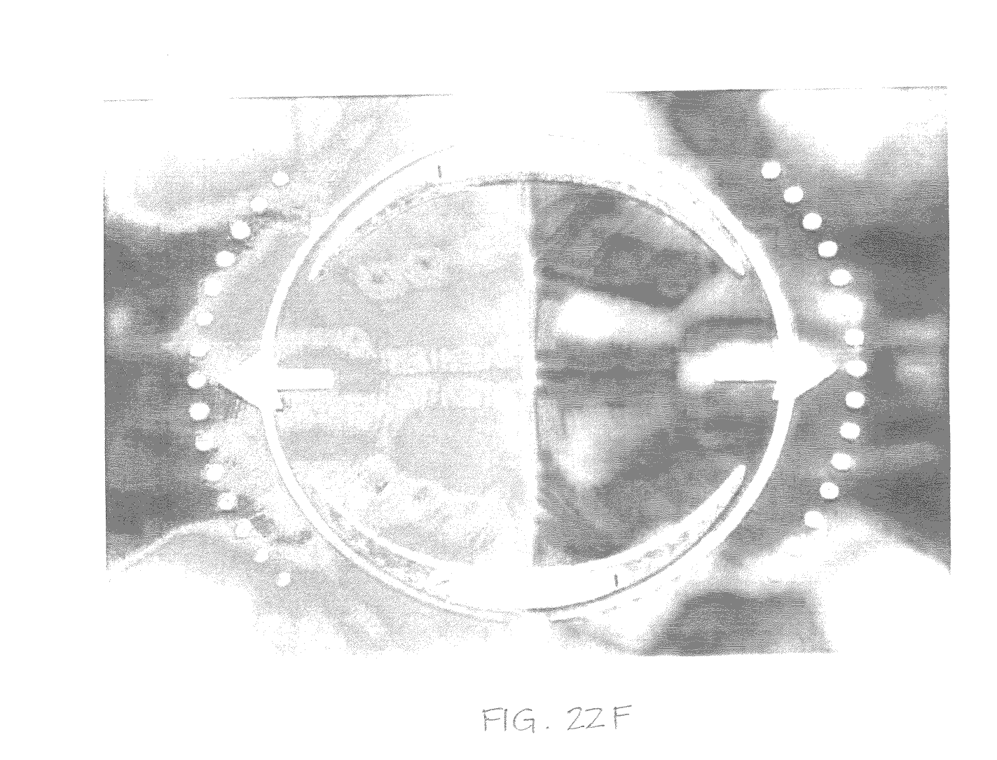

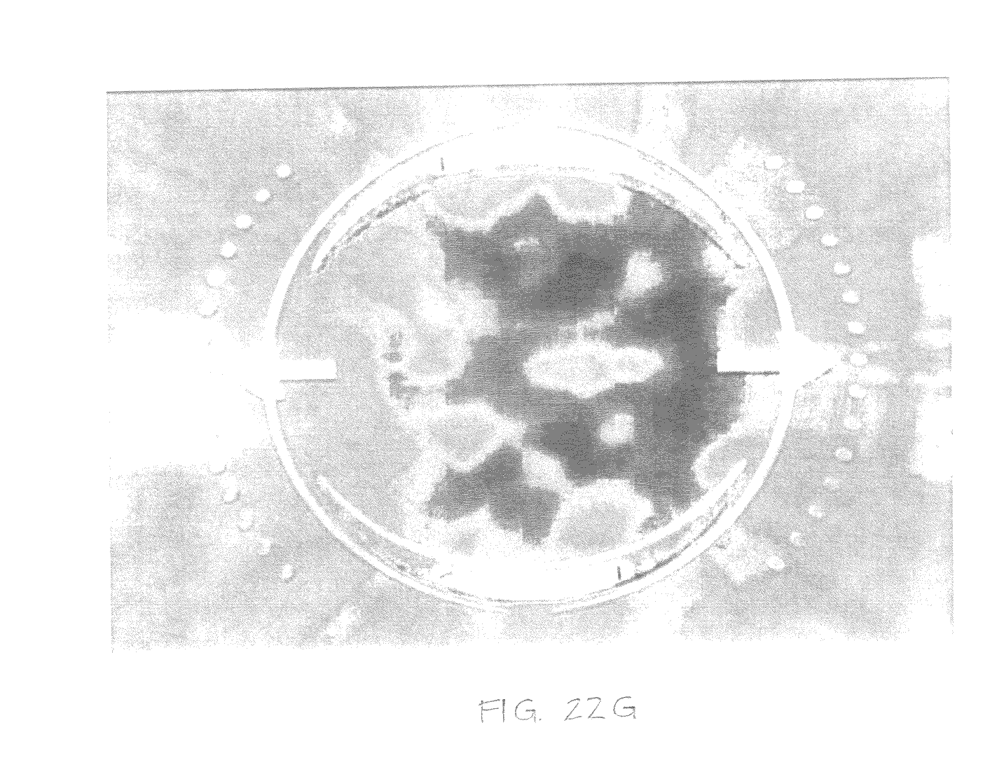

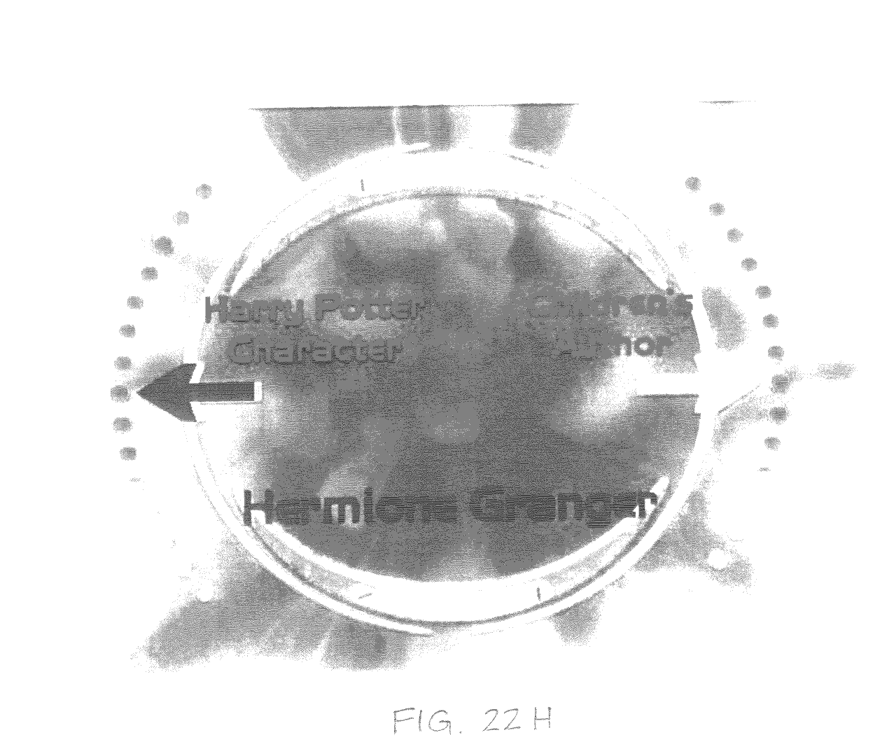

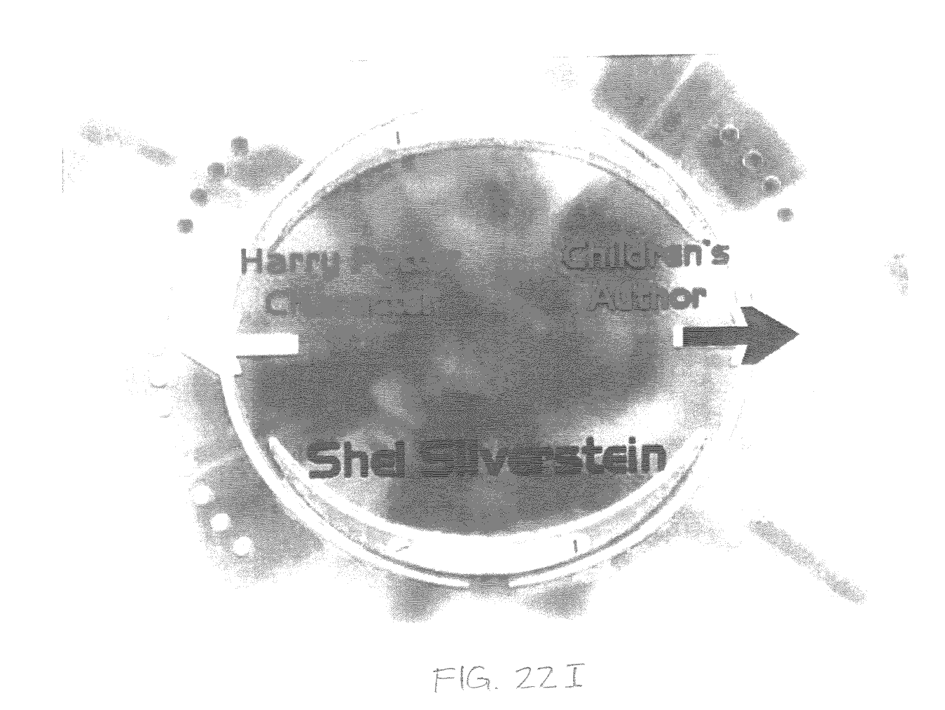

FIGS. 22A-22I is an example sequence of snapshots illustrating a wormhole (tunneling) type of game challenge. In one embodiment, this challenge comprises multiple sub-challenges the results of which together indicate a score. For example, in the example demonstrated in FIGS. 22A-22I, there are three sub-challenges to be completed. In one example DVD game, a different score is designated for the number of questions answered correctly. For example, answering 3 out of 3 correctly advances the participant's score by 2; answering 2 out of 3 correctly advances the participant's score by 1; answering 1 out of 3 correctly leaves the score unchanged; and answering 0 out of 3 moves the participant's score back by 1. Other options and combinations of outcomes are of course possible. Each sub-challenge is a timed challenge which requires the participant to select one of two answer choices before a time limit expires. Typically, the participant is asked to categorize a person, place, or thing into one of the two categories to achieve a correct response (although other variations of challenges are also suitable). According to the animation shown in FIGS. 22A-22C, the participant initially starts out in tunnel which changes colors as the topic 2201 and possible answers 2202 and 2203 (e.g., the two category choices) are presented. In FIG. 22C, the topic 2201 to be categorized is presented as text, and optionally a corresponding question posed via an audio track, and a timer is started. The elapsing time is indicated via a sequential highlighting of the indicators 2204. The possible answers 2202 and 2203 are implemented as menu buttons and the participant needs to select one of these buttons before the indicators 2204 finish highlighting, indicating that the available time has elapsed. FIG. 22D illustrates the result of the participant selecting the answer 2203 (correctly) prior to the timer expiring. The progression shown in FIGS. 22E-22I indicates the result of completing the sub-challenge. The DVD game first shows a junction of the correct and incorrect tunnels (green and red, respectively) to indicate that the game will progress down one of the tunnels and then proceeds down the appropriate tunnel. If the sub-challenge is answered correctly, then the animation video proceeds through a green “tunnel” as shown in FIG. 22G. If the sub-challenge is answered incorrectly, then the animation video proceeds through a red “tunnel” (not shown). FIGS. 22H and 22I illustrate two additional sub-challenges to complete the wormhole challenge.

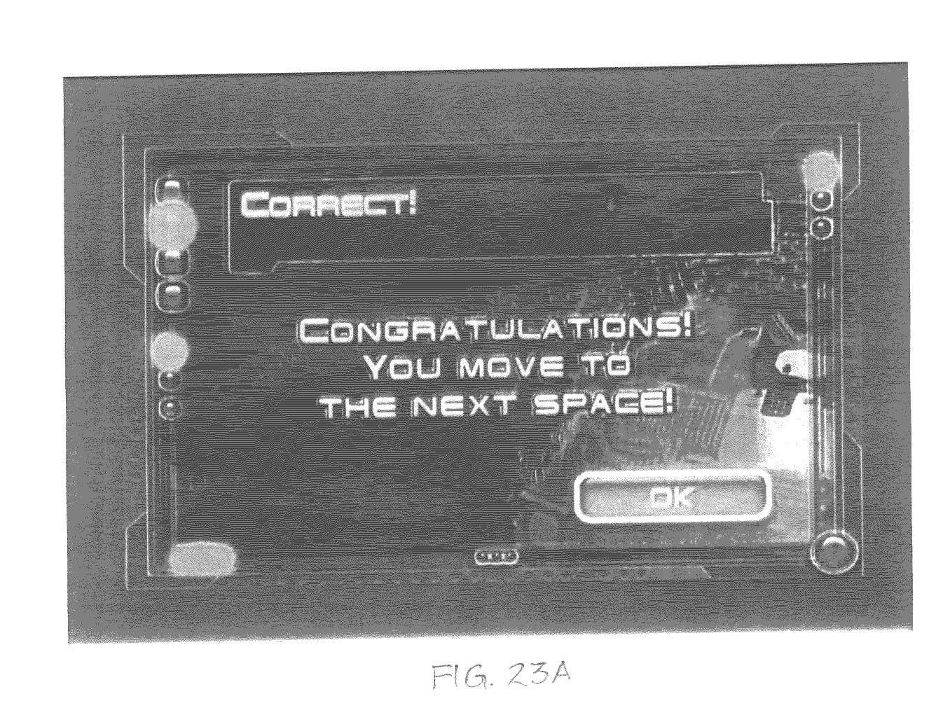

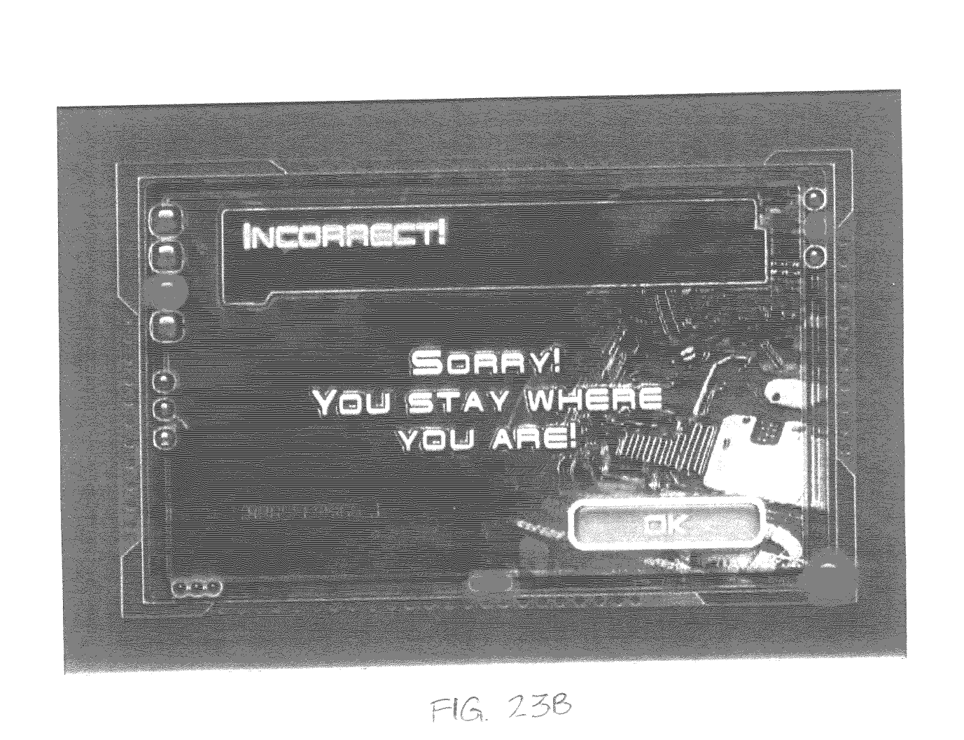

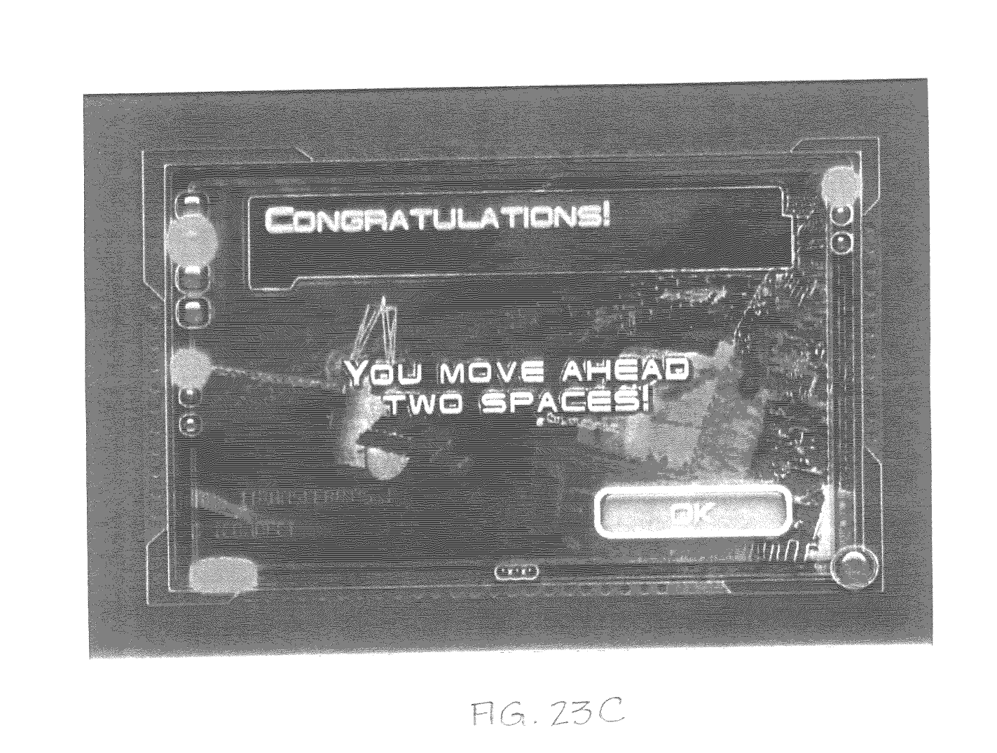

FIGS. 23A-23C are example snapshots illustrating challenge result feedback options. The exemplified videos are typically displayed in response to the DVD game detected whether a challenge was answered correctly or not and as part of a Fate Card result as described below with reference to FIGS. 25A-25D. FIG. 23A is an example snapshot of a video presented when a challenge was answered correctly. FIG. 23B is an example snapshot of a video presented when a challenge was answered incorrectly. FIG. 23C is an example snapshot of a video presented when a challenge was answered correctly and the score is enhanced, such as by answering all the sub-challenges of a wormhole challenge.

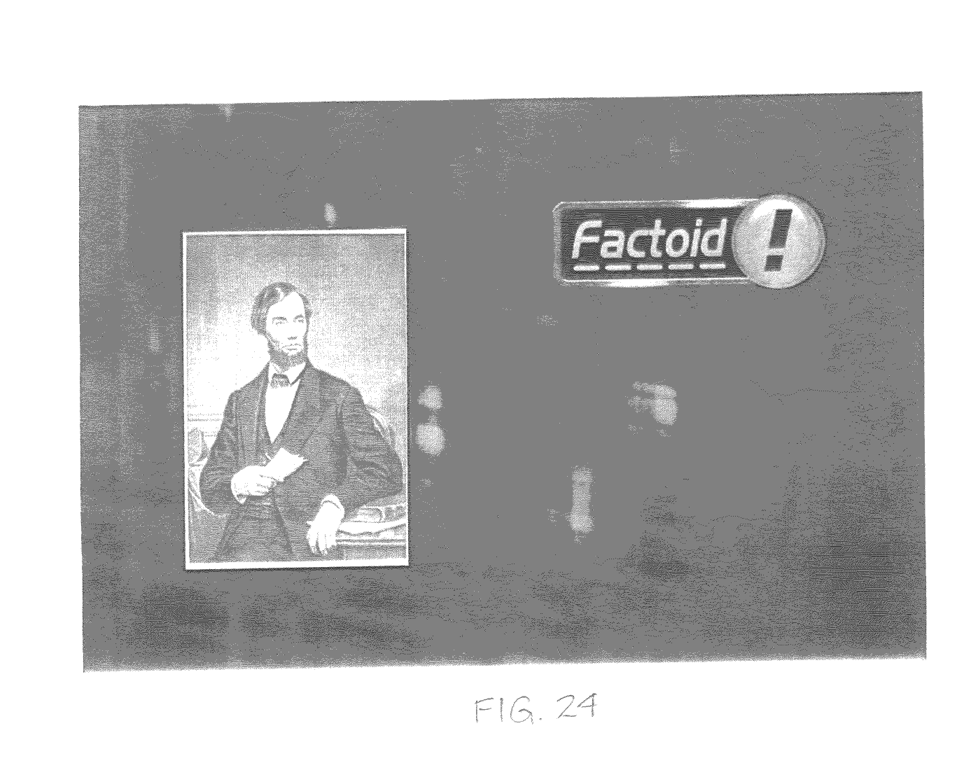

In addition to the challenges described above, the DGE supports Factoids, which are additional video and optionally audio segment information used to enhance the information conveyed in a challenge. For example, supplemental information may be used to contemporize the subject matter of a challenge. FIG. 24 is an example snapshot of a video segment portion of a Factoid presented by an example DVD game.

The DGE also supports randomized advancement and movement backwards through multimedia Fate Cards. Fate Cards present a specialty character of the storyline informing the current participant of a change to the participant's score due to some (externally controlled) event. Fate Cards are presented at random and in one embodiment have a 1:8 chance of begin presented. FIGS. 25A-25C are a sequence of example snapshots of a Fate Card presented by an example DVD game. FIG. 25A signals the presentation of a Fate Card. FIG. 25B shows a story character coming into play to deliver the “fate” message. FIG. 25C shows the story character disappearing.

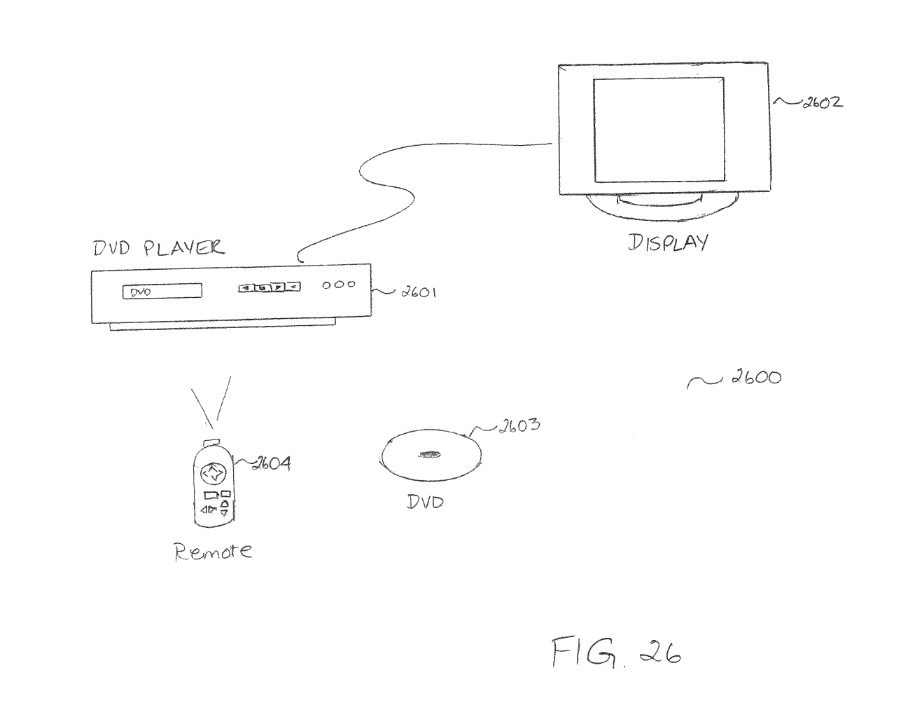

FIG. 26 is an example block diagram of a DVD system for practicing embodiments of a DVD Game environment. The DVD system 2600 comprises a DVD player 2601 connected directly or indirectly to a display device 2602. In some embodiments, the DVD player 2601 may be optionally controlled by a remote control device 2604 or by controls resident or otherwise associated with the DVD player 2601. A DVD game, along with instructions for controlling the DVD player to present content and to navigate to other content, are stored on a DVD 2603 and played on DVD player 2601.

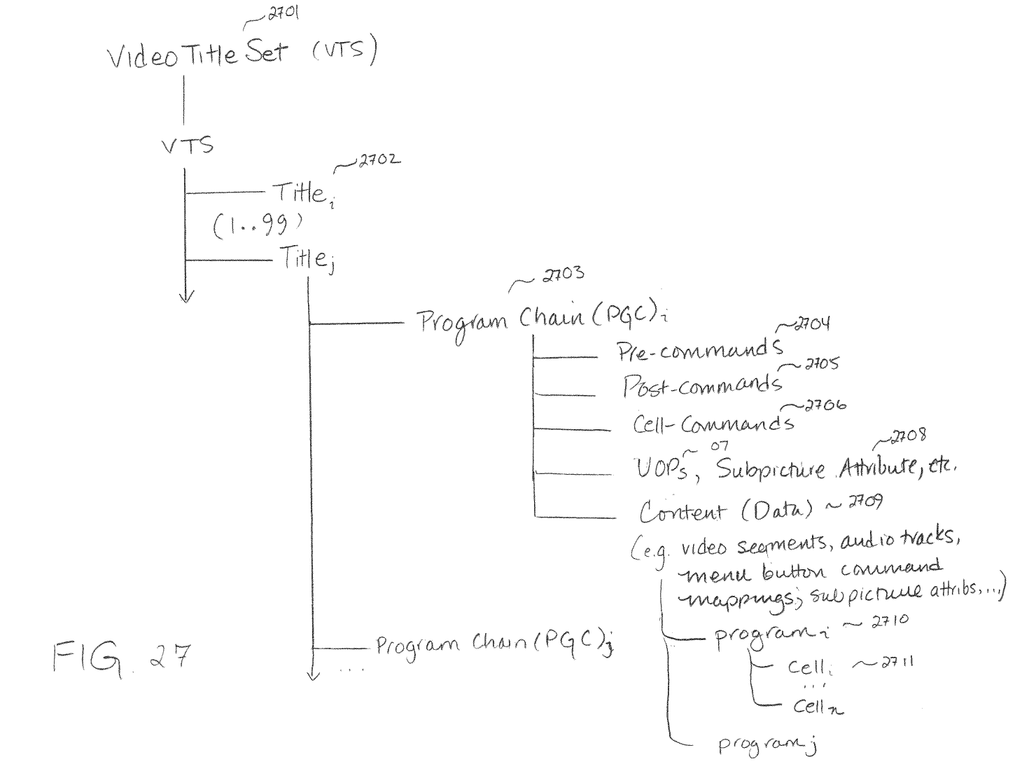

FIG. 27 is an example block diagram of the layout of instructions and content on a DVD for practicing embodiments of a DVD Game Environment. FIG. 27 represents an abstraction of what can be physically laid out on a DVD medium, for example, DVD 2603. On a DVD, one can store 1-99 video titles, so there are fewer or equal number of video title sets (VTSs) 2701 that contain the titles. Within each VTS 2701, there are one or more Titles 2702 (for a total of 99 over the entire DVD), reflecting a grouping of the content and instructions, similar to file organization in a hierarchical file system. Within each Title 2702, there are one or more Program Chains 2703 (PGCs), which store the instructions (DVD player commands), definitions, and the actual content. Within each Program Chain 2703, there are one or more programs 2710 (also referred to as “Chapters” or “Parts of Title”), which refer to one or more cells 2711 of content and related definitions, such as menu button command mappings and button highlights (subpicture attributes). For example, each PGC 2703 can hold a certain number of pre-commands 2704, which are executed prior to presenting the content 2709 stored in a PGC and a certain number of post-commands 2705, which are executed after presenting the content 2709 stored in that PGC. Typically, navigation commands (like scoring) that need to be executed after presenting a challenge are stored in the post-commands 2705. In addition, each PGC 2703 can hold cell-commands 2706, which are executed after each grouping of content that is stored as a “cell.” Note that a portion of a video and/or corresponding audio portion and subpictures can be stored in a cell and several cells can be referenced within a program, hence referenced within a PGC. Each cell specifies which cell command is to be executed when its presentation is complete (hence at a cell boundary). Also, each PGC 2703 can define the user operation supported (UOPs) 2707 and other subpicture attributes 2708.

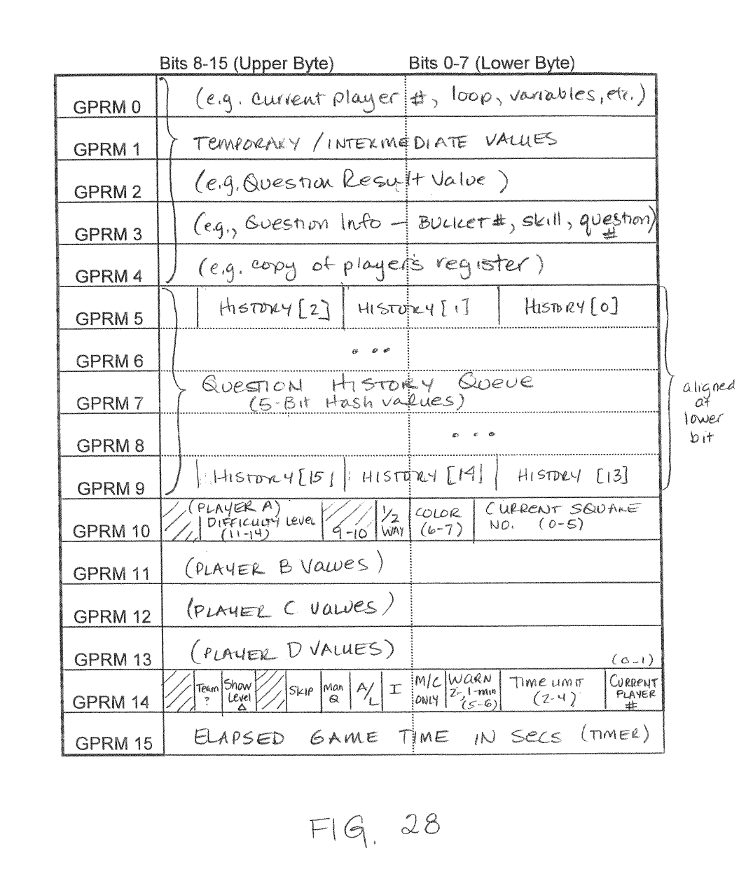

FIG. 28 is an example block diagram of a layout in the general registers for implementing the game and player state information. One skilled in the art will recognize that FIG. 28 provides an example of one of many different organizations of memory and particular content that can be used to accomplish the techniques of the present invention, and that other organization and other content can equivalently achieve the same functionality. In the example shown, each general register is 16 bits, and, although these registers can be thought of as distinct, they can also be treated as general memory and contiguous within a register. In FIG. 28, registers GPRM 0-4 are generally used for temporary and intermediate values or parameters for the “routines” implemented by the PGCs. For example, the current result to a challenge is typically stored in these locations, as well as the current participant number and information regarding a particular question.

Registers GPRM 5-9 are used for the history queue. The history queue is a representation of the challenges that have already been presented in an effort to avoid presenting a challenge twice in the same game session. Note, however, that the DGE provides a skip mechanism that can be enabled to allow a game participant to skip over a current challenge. In one embodiment, the history queue is implemented as a ring of hash values that correspond to one or more challenges. Thus, the history queue doesn't guarantee that a challenge won't be repeated—it reduces the chance that a challenge will be seen twice. As new challenges are added to the history, the oldest fall out of the queue and can be again presented. One reason for storing hash values is to reduce the amount of storage needed to represent (index) whether a challenge has already been presented. Due to the memory limitations of the DVD platform, if one were to store an absolute index to each challenge seen, memory would quickly become consumed in trade for challenge content. One skilled in the art will recognize, however, that different trade-offs may be made yet still accomplish the advantages of using a history mechanism.

In the embodiment illustrated, the history queue contains 15 5-bit hash values, which are aligned at the lower bit of each of GPRM 5-9 to avoid known DVD player problems with using the high order bit. Although not likely to happen often with the hash function chosen, each 5-bit hash value may correspond to more than one challenge. Thus, if two challenges hash to the same value and one of the challenges has already been seen, then the second challenge will not be selected by the DVD game during the current game session. One hash function that has been used successfully with the history queue is:

((Sqr*3)+(Qu*7)+(Lvl*5))mod 32 (1)

where “Sqr” is the current position (score) of the current participant; “Qu” is the current number of the question (challenge); and “Lvl” is the index of the current difficulty level of the current game participant; and “mod” represents the modulo operator. Equation one presumes that the questions (challenges) are grouped into 32 groups (represented by 5 bits), of which 15 are potentially stored recently seen. Some testing was performed to insure that Equation 1 scattered the questions more or less evenly between the 32 hash bins, even if there are less than 32 challenges available for selection at a particular board position (or score).

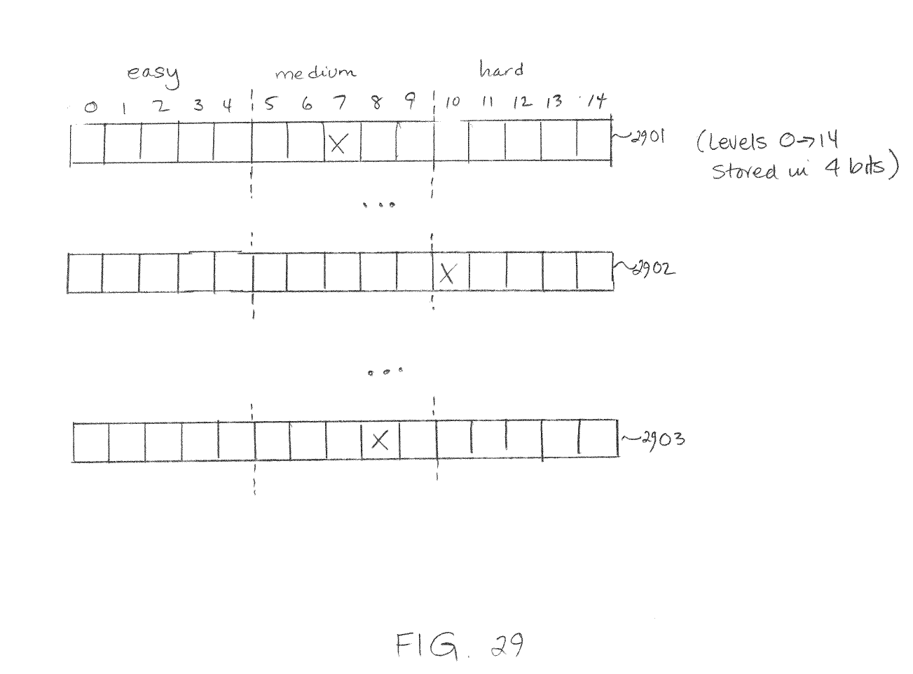

Registers GPRM 10-13 are used to store attributes and values associated with each game participant. In particular, for each game participant, the DVD game stores an indication of the participant's current position on the electronic game board (or other representation or indication of a current score and/or position); a color or other indicator unique to the participant; a flag indicating that a halfway message has already been presented to the participant; and an indication of the participant's current skill level. An explanation of one embodiment of the skill levels and how they are stored is described further with respect to FIG. 29.

Registers GPRM 14 is used to store game attributes and values. For example, in one embodiment, the DVD game stores an indication of the current participant (whose turn it is). In addition, the DVD game stores a time limit for the game session if one was set, for example, using the Options menu described with reference to FIG. 14, and flags to indicate what time warning messages have already been presented to prevent duplicate warnings. The DVD game also stores whether the game is in a simplified mode (e.g., a multiple-choice challenge only mode) where timing is not part of the presented challenges and a simple button selection is the action desired. Other flags are also stored in GPRM 14, including whether the game has been initialized (a new session); whether auto-leveling mode is on; whether challenges are selected manually (good especially for testing purposes); whether change to the skill level of a participant is presented; and whether the game is being played in team or individual mode.

Register GPRM 15 is used to store the elapsed game time in seconds.

FIG. 29 is an example block diagram of the dynamic adjustment of skill levels for a participant based upon the participant's responses to game challenges over time. This adjustment is available when the auto leveling feature is turned on for a game session, for example, as described with reference to FIG. 13. FIG. 29 shows an abstraction of the skill levels available along a continuum 2901-2903. As implemented in one embodiment, the skill levels range from 0-14, which correspond to three possible groupings of challenge levels: easy, medium, and hard. As shown, skill levels 0-4 are mapped to easy challenges; skill levels 5-9 are mapped to medium challenges; and skill levels 10-14 are mapped to hard challenges. This continuum can be represented in 4 bits of memory and thus a 4-bit value is stored in the general registers for each participant to indicate the participant's current skill level (e.g., see FIG. 28). Note that these mappings and the number of skill levels are modifiable, and that more skill levels are possible based upon what memory tradeoffs are desired. For example, to implement a “hidden” super-easy challenge level, less than 5 skill levels need to be mapped to the other three challenge levels if it is desired to still represent the entire skill level continuum in 4 bits. Alternatively, more bits can be used to represent the continuum thus enabling the same or more skill levels to be mapped to these challenge levels.

When auto-leveling is enabled, a participant's skill level increases for each detected correct answer and decreases for each detected incorrect answer. That way, when the detected correct answers exceed the detected incorrect answers by more than the number of skill levels per challenge level (here, 5 levels), the challenges become more difficult. This adjustment intends to even out the level of play between participants as the game progresses. Skill continuum 2901 shows an initial skill level for a game participant. By convention, this initial level is set to a middle value within the challenge level that was initially indicated by the participant when the participant set up participant parameters, for example, using the menu described with reference to FIG. 11. In this example, the easy challenge level corresponds to “Cadet;” the medium challenge level to “Captain,” and the hard challenge level to “Commander.” Skill continuum 2902 shows an adjustment of the participant's skill level increased by 3 levels from the initial skill level shown in skill continuum 2901. Similarly, skill continuum 2903 shows an adjustment of the participant's skill level decreased by 2 levels from the prior adjustment in continuum 2902.

One skilled in the art will recognize that there exist other techniques for implementing automatic adjustment of the skill levels, such as varying the number of skill levels jumped for each challenge, making non-linear adjustments for time-in-the game, etc., and such variances are contemplated for use with the auto-leveling feature. For example, the DVD game may implement a scheme for the auto-leveling feature that automatically increases a participant's challenge level when 3 challenges have been answered correctly and automatically decreases the participant's challenge level when 2 challenges have been answered incorrectly. To implement this tactic, the DVD game sets the skill level index (0-14) at an appropriate position accordingly and/or changes the number of bits per challenge level accordingly. For some schemes, the DVD game may cause the index to jump non-linearly when a new challenge level is set.

As described with reference to FIGS. 5A-5C and other figures above, one of the functions of a DGE, and hence the DVD games produced thereby, is to automatically determine a next challenge to present to the participant whose turn it is (the current participant). The DVD game determines a potential next challenge based upon a modified random selection technique that takes advantage of and utilizes the organization (groupings) of challenges. Specifically, challenges are grouped and associated with positions (and/or scores) on the electronic game board. Also, the challenges are categorized into a level a priori according to the skill and knowledge required to respond.

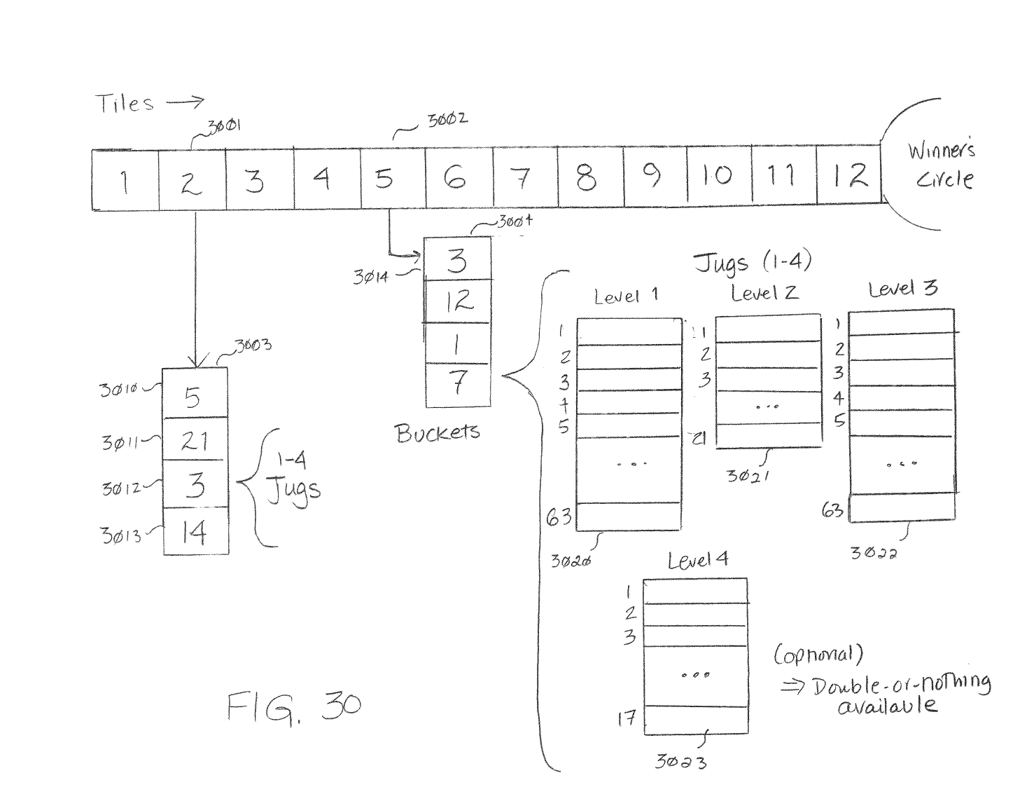

FIG. 30 is a block diagram illustrating an example organization and layout of challenges used by an example DVD game. In FIG. 30, each board position, for example tiles 3001 labeled “2” and 3002 labeled “5,” is associated with 4 groups of challenges termed “buckets.” For example, tile 3001 is associated with a list 3003 of 4 buckets of challenges 3010-3013. Each of buckets 3010-3013 has an associated identifier (e.g., “5,” “21,” “3,” and “14”) that identifies 1-4 further groupings, termed “jugs,” of challenges. Each jug, for example jugs 3020-3023, identifies 1-63 challenges, and, in one embodiment, a jug is present in a bucket for each challenge level. Thus, as shown, jug 3020 corresponds to the “easy” level (level 1); jug 3021 corresponds to the “medium” level (level 2); and jug 3022 corresponds to the “hard” level (level 3). Jug 3023 corresponds to a “special” level (level 4) which is used for executing a double-or-nothing enhanced turn. Specifically, if a jug corresponding to level 4 exists for a particular board position (or score), then the DVD game knows to offer a chance for the participant to engage in a double-or-nothing enhancement. Note that the same bucket may be associated with more than one board position, (for example, buckets 3012 and 3014 show the same bucket associate with positions 3001 and 3002 respectively), but that preferably each challenge is uniquely assigned to a jug.

The determination of which buckets are associated with each board position is made based upon heuristics and trial and error. Different associations can be used to create a game that performs in a particular way or addresses particular topics in a particular sequence. For example, a history game may wish to present topics in date order so that challenges associated with the modern era appear earlier than challenges associated with ancient times. Such an arrangement would presumably generate more challenge further along in the game assuming older history is less well known to the participants than recent history. One skilled in the art will recognize that many variations and arrangements are possible. In addition, one skilled in the art will recognize that the number of challenges per jug, number of jugs per bucket, and number of buckets per board position (score) can also be modified and may be constrained by limitations of the DVD platform.

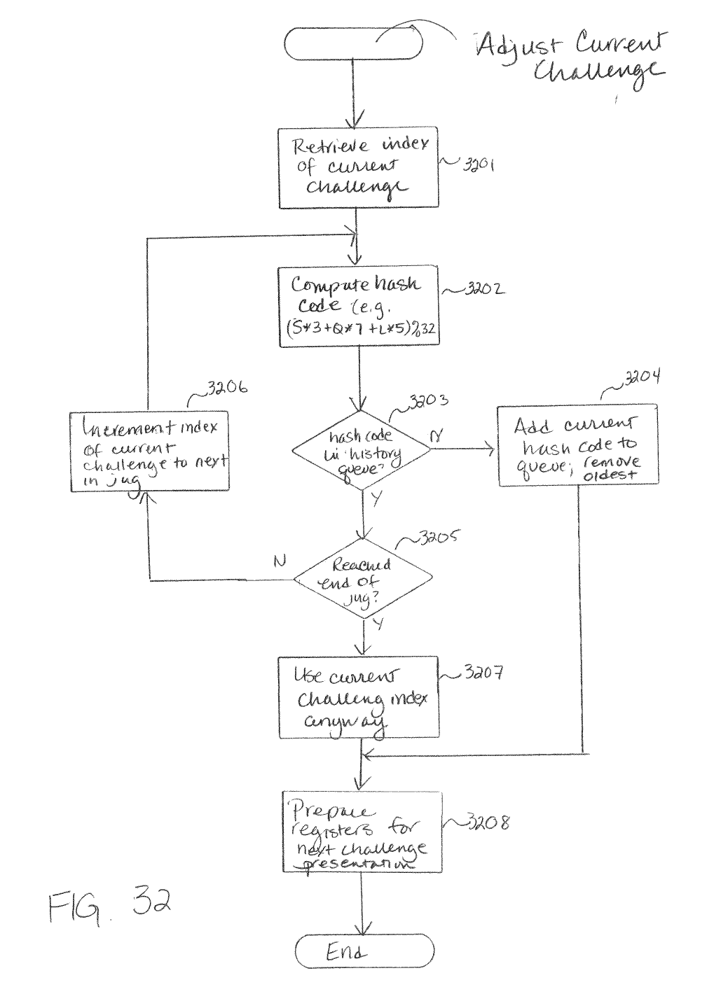

FIG. 31 is an example flow diagram of a series of steps executed by a DVD game for automatically determining a next challenge. As noted earlier, these steps executed by a DVD game are treated in the figures as “routines” for ease of discussion, although they may not be implemented in their own programming environment including an execution stack. Specifically, in steps 3101 and 3102, the DVD game retrieves the current participant's board position (or score) and current skill level, respectively. In step 3103, the game selects at random one of the buckets (of jugs of challenges) associated with the retrieved board position. In step 3104, the DVD game determines the number of challenges available in each jug within the selected bucket (hence the number of challenges associated with each challenge level). In step 3105, if the jug corresponding to level 4 has at least one challenge associated with it, then the DVD game detects that a double-or-nothing enhancement is available and continues in step 3106, otherwise continues in step 3108. In step 3106, the DVD game queries the participant (e.g., via a menu) whether to present a double-or-nothing challenge, and, if so, continues in step 3107, otherwise continues in step 3108. In step 3107, the DVD game sets the double-or-nothing flag used to calculate a temporary boost in skill (and, when applicable, challenge) level and a corresponding score enhancement if the challenge is answered correctly, and then continues in step 3108. In step 3108, the DVD game selects at random a potential challenge from the number of challenges available in the jug that corresponds to the (boosted, if applicable) level of the current participant, and in step 3109 executes another series of steps to determine whether the potential challenge was recently presented and thus should be replaced by a different challenge. The set of steps for adjusted the current challenge is described with reference to FIG. 32. In step 3110, the DVD game navigates to a PGC, via one or more jump tables, associated with the current challenge. For example, one embodiment supports a dispatch mechanism with jump tables (e.g., “if” programming statements) that eventually causes navigation to jump to the correct PGC for a particular question within a particular jug. The correct PGC is typically the first video screen of the current challenge. Note that, if a “skip” option is enabled, then the current participant may skip over the current challenge (not shown).

FIG. 32 is an example flow diagram of a series of steps executed by a DVD game for adjusting a candidate challenge based upon checking a history queue for prior recent presentation. In step 3201, the DVD game retrieves an indication of the candidate challenge. In step 3202, the DVD game computes a hash value according to a hash function, such as that described with reference to Equation 1. In step 3203, the DVD game determines, by comparing the computed 5-bit hash value to the 5-bit values stored in the history queue, whether the computed hash value is present in the queue, and, if so (the challenge has been recently presented), continues in step 3205, else continues in step 3204. In step 3204, the DVD game proceeds to use the candidate challenge as the current challenge, because the computed hash value is not present in the history queue, and updates the history queue to indicate the current challenge. (For example, it adds the computed hash value to the history queue and removes the hash value that corresponds to the least recently seen challenge.) Otherwise, in step 3205, the DVD game checks to see if it has exhausted all of the challenges in that jug (they were all seen recently), and, if so, continues in step 3207 to use the candidate challenge anyway, otherwise continues in step 3206. In an alternative embodiment, the DVD game, instead of using the current challenge anyway in step 3207, loops back to step 3103 in FIG. 31 to randomly select a different bucket (and hence jug) that corresponds to the participant's board position and starts the candidate challenge process and adjustment all over again. According to this alternative embodiment, the DVD game would continue to try different buckets until a challenge is found that hasn't been recently seen or until there are no more buckets to try. In step 3206, the DVD game advances the candidate challenge to the next challenge in the selected jug (it wraps around to the first question in the jug and onward, for example using a modulo function that divides by the number of questions in the jug). The DVD game then returns to step 3202 to perform the same check on the remaining challenges in the jug until either a challenge is found whose hash value does not appear in the history queue, or until (in step 3205) the DVD game detects that it has exhausted the challenge possibilities in that jug and should present the candidate challenge anyway. In step 3208, the DVD game prepares the registers to present the current (as potentially modified) challenge, and returns to execution of the steps for navigating to the implementation of the current challenge.

The DGE uses the menu and button capabilities provided by the DVD platform to implement the various challenges described. For challenges that do not involve time-related aspects or movement-related aspects (for example those that follow a multiple choice answer model), the techniques are straightforward. Typically, a button is defined to correspond to each answer and, thus, the DVD game can detect which answer is chosen based upon which button is selected.

To implement the various challenges that involve time-related and movement-related aspects, the DGE uses several techniques, such as off-screen (non-visible) menus and time varying buttons, to assist the animation and automatic detection process. In some DVD players, these techniques are not available or not-implemented properly, hence the DGE can support flags to disallow certain types of questions (e.g., in the currently unused bits of registers GPRM 14). For example, for black holes, a separate menu with a single button (that is highlighted) exists for each answer with a start time for that menu set to when the corresponding answer starts moving around and an end time set to shortly after the answer has disappeared into the black hole. When the participant selects an answer (by pressing, for example, the ENTER key or DVD player equivalent), the DVD game can detect which button was selected and hence whether the “consumed” answer was the correct one or not. Some DVD players cannot successfully implement multiple button highlight definitions that change over time, thus, in these cases, the DVD game preferably disables black hole challenges. Circling cursors (where the cursor moves instead of the answers) are implemented similarly and thus suffer from similar compatibility issues on some DVD players.

For side scrollers, the DGE uses a technique where a menu with buttons that correspond to the possible answers isn't displayed until the answers are all made visible. Instead, the challenge has a menu with a “do-nothing” button definition until the answers are visible. Thus, the buttons aren't available at the start of the video. The buttons then remain visible (and active) until the end of the video segment. Selecting a single button ends the video and the DVD game is able to automatically detect which button was selected, hence whether the answer was correct or incorrect. Some DVD players expect menus with only one set of button definitions at the start of a video, thus, in such cases, the DGE preferably disables side scroller challenges.

For time-related aspects of challenges, the DGE uses several techniques. For example, some DVD players properly implement a timer (in a register) that can be incorporated into the instructions for a particular challenge implementation. In other situations, time is approximated based upon the presentation of the video—the video executes at a particular number of frames per second, and this metric can be then used to approximate how many seconds have passed since the beginning of the presentation of the video.

One skilled in the art will recognize that variations and alternatives to these techniques can also be used, such as those that employ multi-angle viewing and other features offered by the DVD platform. In addition, as the DVD platform evolves, new techniques will be made available and thus incorporated into the DGE to implement various existing and new challenges.

All of the above U.S. patents, U.S. patent application publications, U.S. patent applications, foreign patents, foreign patent applications and non-patent publications referred to in this specification and/or listed in the Application Data Sheet, including but not limited to U.S. patent application Ser. No. 11/147,407, entitled “DVD GAME ARCHITECTURE,” filed Jun. 6, 2005; U.S. Provisional Patent Application No. 60/486,672, entitled “METHOD AND SYSTEM FOR AUTOMATIC HANDICAPPING IN ELECTRONIC GAMING ENVIRONMENTS,” filed Jul. 11, 2003; U.S. Provisional Application No. 60/577,446, entitled “DVD GAME ARCHITECTURE,” filed Jun. 4, 2004; and U.S. patent application Ser. No. 10/889,985, entitled “METHOD AND SYSTEM FOR DYNAMICALLY LEVELING GAME PLAY IN ELECTRONIC GAMING ENVIRONMENTS,” filed Jul. 12, 2004 are incorporated herein by reference, in their entirety.

From the foregoing it will be appreciated that, although specific embodiments of the invention have been described herein for purposes of illustration, various modifications may be made without deviating from the spirit and scope of the invention. For example, one skilled in the art will recognize that the methods and systems for creating, managing, and operating DVD games discussed herein are applicable to other uses than for entertainment. For example, the DGE can be used to create, manage, and operate applications for other learning and testing environments. In addition, one skilled in the art will recognize the methods and techniques described herein are applicable to new DVD-like platforms, for example, next generation DVD players and their associated media, which may provide less limitations on, for example, the memory and instructions available to embodiments described herein.

1. A DVD medium containing instructions that, when executed, control a processor in a DVD player to perform an interactive electronic game with a participant, the game being presented on a display device associated with the DVD player, by:
determining a skill level associated with the participant;
determining a game challenge from a stored plurality of challenge segments based upon the determined skill level;
presenting the determined game challenge to the participant;
receiving an indication of a response of the participant to the presented challenge and determining a corresponding result;
automatically updating a position associated with the participant on an electronic game board stored in the DVD player to reflect the determined result; and
automatically presenting a current state of the updated game board on the display device without use of a separate physical game board.

2. The DVD medium of claim 1 wherein each position on the electronic game board reflects a score associated with a participant.

3. The DVD medium of claim 1 wherein the automatically presenting a current state of the updated game board presents an animation that represents movement of the participant relative to the board.

4. The DVD medium of claim 1 wherein the stored plurality of challenge segments comprise video segments and audio tracks and the determined game challenge has an associated video segment and an associated audio track.

5. The DVD medium of claim 4 wherein a plurality of audio tracks are associated with a same video segment and one of the plurality of audio tracks is selected for presenting the determined game challenge.

6. The DVD medium of claim 1 wherein the determined skill level is determined by receiving from the participant an indication of at least one of an age or experience metric and automatically determining an appropriate skill level from the metric.

7. The DVD medium of claim 1, the stored plurality of challenge segments including at least one game challenge that is a time-limited movement-related challenge, and wherein the movement-related challenge requires participant timing and coordination skills beyond simple selection of a single answer from multiple choices to respond correctly to the movement-related challenge.

8. The DVD medium of claim 1, the stored plurality of challenge segments including at least one game challenge that is a time-limited movement-related challenge, the movement-related challenge having a plurality of answers that correspond to menu selections that vary over a duration the challenge is presented to the participant.

9. The DVD medium of claim 1, the stored plurality of challenge segments including at least one game challenge that is a time-limited movement-related challenge, and wherein the movement-related challenge is a challenge in which a moving cursor is presented or a challenge in which a moving response is presented.

10. The DVD medium of claim 9 wherein a plurality of answers seem to disappear and a successful response to the challenge includes selecting an answer before the answer disappears.

11. The DVD medium of claim 1 wherein the presented game challenge comprises at least one of a multiple choice challenge, a time limited challenge, a movement-related challenge, a true/false challenge, a categorization challenge, a visual puzzle, or an open response challenge.

12. The DVD medium of claim 1 wherein the presented game challenge presents at least one of an anagram, a circling cursor challenge, a side scroller challenge, a wormhole challenge, a black hole challenge, a fate card, or a factoid.

13. The DVD medium of claim 1 further comprising instructions that, when executed, control a processor in a DVD player to perform an interactive, electronic game by:
automatically adjusting the skill level associated with the participant based upon the determined result corresponding to the response of the participant to the presented challenge; and
determining a next game challenge for the participant from the stored plurality of challenge segments based upon the automatically adjusted skill level, thereby automatically adjusting game difficulty for the participant based upon game performance.

14. The DVD medium of claim 13 wherein the automatically adjusting the skill level is performed for a plurality of participants playing the game to cause game play to be more evenly matched between the skills of each of the participants.

15. The DVD medium of claim 1, further comprising instructions that, when executed, control a processor in a DVD player to perform an interactive, electronic game by:
automatically determining a next game challenge for the participant from the stored plurality of challenge segments as a function of the skill level associated with the participant and the game board position associated with the participant.

16. A method in a digital video playing device for operating an interactive, electronic game with a participant, the game being stored on a DVD medium and presented on a display device associated with the digital video playing device, comprising:
determining a skill level associated with the participant;
determining a game challenge from a stored plurality of challenge segments based upon the determined skill level;
presenting the determined game challenge to the participant;
receiving an indication of a response of the participant to the presented challenge and determining a corresponding result;
automatically updating a position associated with the participant on an electronic game board stored in the digital video playing device to reflect the determined result; and
automatically presenting a current state of the updated game board on the display device without use of a separate physical game board.

17. The method of claim 16, the game operating with a plurality of participants, the participant being one of the plurality of participants, and further comprising:
automatically leveling game play between the plurality of game participants by automatically and dynamically adjusting determined skill level associated with each participant as the game progresses based upon game performance of each participant.

18. The method of claim 16 wherein the automatically presenting a current state of the updated game board further comprises:
automatically presenting an animation that represents movement of the participant relative to the electronic game board.

19. The method of claim 16, the stored plurality of challenge segments including at least one game challenge that is a time-limited movement-related challenge, and wherein the movement-related challenge comprises a challenge in which a moving cursor is presented or a challenge in which a moving response is presented.

20. The method of claim 19 wherein a plurality of answers seem to disappear and a successful response to the challenge includes selection of an answer before the answer disappears.

21. The method of claim 16, further comprising:
automatically determining a next game challenge for the participant from the stored plurality of challenge segments as a function of the skill level associated with the participant and the game board position associated with the participant.

22. An electronic game board implemented using a digital video playing device having an associated storage medium with stored instructions, video segments, and audio tracks, comprising:
a plurality of sequences of game board position-related video segments stored on the media; each sequence illustrating a plurality of board position animations associated with scores of a game participant from a beginning score to an ending score, one sequence of position animations stored for each of a plurality of game participants; and
a plurality of stored instructions that are structured to,
automatically track a current score value associated with each participant;
determine a next participant from the plurality of participants; and
automatically present a position animation from the stored sequences of game board position-related video segments that corresponds to the current score value associated with the determined next participant.

23. The electronic game board of claim 22 wherein the game board presents a position animation for one participant at a time in a context of a representation of the entire game board.

24. The electronic game board of claim 22 wherein the board appears to rotate to present the position animation associated with the determined next participant.

25. The electronic game board of claim 22 wherein the board appears to have positions that correspond to a path from a start position to an ending position, each position associate with a score value.

26. The electronic game board of claim 22 wherein the board appears to be arranged in a spoke configuration, wherein each spoke corresponds to a path of a separate participant.

27. The electronic game board of claim 22 wherein each sequence of animations is presented in a different color.

28. The electronic game board of claim 22 wherein the digital video playing device is a DVD player and the storage medium is a DVD.

29. A DVD game operated using a DVD player and stored on a DVD medium containing instructions that, when executed, control the DVD player by:
determining one of a plurality of challenges to present to a game participant based upon a skill level associated with the participant, wherein each challenge permits multiple outcomes that are based upon a time period associated with responding to the challenge and the time period corresponds to at least one of before a cursor reaches a designated location or before an answer reaches a designated location;
presenting the determined one of the challenges having multiple outcomes;
automatically detecting a response by the participant indicative of one of the multiple outcomes; and
adjusting a score associated with the participant that is based upon the one of the multiple outcomes.

30. The DVD game of claim 29 wherein selection between the multiple outcomes is based upon at least one of physical skill or knowledge.
